(19) United States
(12) Patent Application Publication
(10) Pub. No.: US 2020/0342396 A1
(43) Pub. Date: Oct. 29, 2020

(54) MULTIPLE PARTICIPANT TRANSACTION MANAGEMENT WITH HIERARCHICAL DOWNSTREAM MODIFICATION PERMISSIONING

(71) Applicant: itrackFreight, LLC, Kildeer, IL (US)

(72) Inventor: Gregory J. Dye, Kildeer, IL (US)

(21) Appl. No.: 16/397,309

(22) Filed: Apr. 29, 2019

(51) Int. Cl. G06Q 10/08; G06Q 20/40

(52) U.S. Cl. CPC G06Q 10/0835; G06Q 20/405; G06Q 20/401

(57) ABSTRACT

The disclosed embodiments relate to transaction management systems such as a third party logistics system for managing freight shipment transactions among multiple participants, e.g. initiated by a shipper and executed by a combination of a broker, carrier and/or driver. The disclosed embodiments further related to a third party logistics system having hierarchical downstream modification permissioning whereby, in at least one embodiment, the ability for a downstream participant to make modifications to a given transaction, including further authorizing modification by a downstream participant, is controlled by the direct upstream participant.

### BACKGROUND

In the freight transportation industry shippers have cargo which they need to have shipped, brokers optionally arrange shipments with carriers on behalf of shippers, carriers provide the transportation services to move the cargo between the pickup and destination locations and arrange for drivers to execute the shipment, and receivers in turn receive the cargo sent by the shipper.

There are estimates of over 15 million trucks in the US, and from 500,000 to over 1 million trucking companies operating in the US, with 90% of the companies having less than 20 trucks (“independents” or an “independent carrier”). Currently, shippers (e.g. manufacturers), freight shipment brokers (also referred to herein as brokers) and freight carriers (also referred to herein as carriers) conduct business transactions in a direct business to business model. For example, a shipper that uses an independent carrier first locates a carrier from thousands of options by sorting through the various services offered by each carrier, and applying each carrier's stated rules to determine which carrier(s) offer a service with which to deliver a particular load according to the shipper's requirements. Additionally, the shipper must contact the carrier to further clarify unstated rules. If the shipper determines that more than one carrier offers a service to deliver a particular shipment according to the shipper's requirements, then the particular shipper might additionally be concerned with selecting a carrier and service that provide shipping services at the optimal price.

Although applications currently used in the industry such as, but not limited to, transportation management systems (TMS systems) and Load Boards have provided some automated services to the shipping industry, there is a greater need to centralize and optimize matching and negotiating services between shippers, brokers, carriers and drivers, to create more efficiency in the market as such current applications limit the degree to which shippers can initiate and direct their shipments.

Freight posting services (also called freight matching services or load boards) are used by those with freight requiring transport and those with freight transport equipment for hire to coordinate and match freight to equipment.

The term shipper/broker may also be referred herein as a shipper or broker system or a shipper or broker's Transportation Management System (TMS). In one embodiment, the TMS may comprise a software and/or hardware application designed to manage and optimize inbound and/or outbound transportation operations. The TMS may integrate and/or otherwise communicate with an enterprise resource planning (ERP) system, Order Management System (OMS), or Warehouse Management System (WMS). The ERP (or OMS/WMS) application passes inbound and/or outbound orders to the TMS which may then determine the optimized transportation cost and routing

Transportation management systems manage four key processes of transportation management: (1) Planning and decision making—TMS will define the most efficient transport schemes according to given parameters, which have a lower or higher importance according to the user policy: transport cost, shorter lead-time, fewer stops possible to ensure quality, flows regrouping coefficient, etc.; (2) Transportation Execution—TMS will allow for the execution of the transportation plan such as carrier rate acceptance, carrier dispatching, Electronic data interchange (EDI), etc.; (3) Transport follow-up—the TMS may enable administrative operation regarding transportation. For example, the TMS may enable the traceability of items by event (shipping from A, arrival at B, customs clearance, etc.), editing of reception, custom clearance, provide invoicing and booking documents, and send transport alerts (delay, accident, non-forecast stops . . . ); and (4) Measurement—the TMS may comprise a transport logistics key performance indicator (KPI)

The term “carrier” or “freight carrier” is used herein to refer to a trucking company that provides freight shipment services while the term “shipper”, or “customer,” is used herein to refer to a company that engages a carrier to transport a load of freight. The term “broker” or “freight broker” is used herein to refer to an entity that may represent and act on behalf of one or more carriers and/or shippers. The phrase “Third Party Logistics,” “3PL or “TPL” is often used in the freight industry in the place of “broker.” Carrier may further refer to an entity ultimately responsible for a freight transport order. In still further embodiments, as used herein, freight carrier means an entity that coordinates and monitors freight, freight transport equipment, operators, billing, insurance, and other aspects of a freight transport order. A variety of entities are optionally freight carriers including, by way of non-limiting examples, regional, national, and international carriers, brokers, individuals, and the like. In some embodiments, a freight carrier owns freight transport equipment and employs full-time and/or part-time operators. In other embodiments, a freight carrier owns freight transport equipment and hires temporary and/or contract operators. In yet other embodiments, a freight carrier leases and/or temporarily contracts freight transport equipment and hires temporary and/or contract operators. In yet other embodiments, a freight carrier does not own freight transport equipment or hire operators. In further embodiments, a freight carrier is a broker of freight transport orders.

The traditional transaction process may begin with a shipper's shipping manager being prompted by a shipper's Traffic Management System (“TMS”) or software based order management system that an item or items require shipping. The information regarding a shipment is then either automatically forwarded to a broker or a pre-selected group of carriers using Electronic Data Interchange (“EDI”), or the shipping manager notifies brokers or carriers to bid for the shipment using the telephone or some other communication method. Thereafter, the first round of carriers notified will inform the shipper whether they can accept all or a portion of the load offered. To the extent a shipper determines that it needs to locate additional carrier capacity, the shipper continues to put the shipment out to bid using one of the methods described above until it has obtained sufficient carrier capacity for the shipment.

Generally speaking, shippers and carriers that employ EDI technology may incur substantial costs in connection with its use. In addition to the fixed costs incurred in connection with acquiring the necessary hardware and software to implement an EDI system, there are ongoing costs associated with an EDI system's use. Shippers and carriers must subscribe to a value-added network (a “VAN”) in order to transmit data to the opposite party. VANs typically charge a combination of a flat fee and a use charge for transmission of data. Moreover, EDI systems are not typically architecturally flexible relative to newer technologies, and reconfiguring an EDI system is resource intensive and time consuming.

In today's market, the actual rate charged for the shipment is determined in a number of ways. Often a shipper and carrier will negotiate and agree on the price to be charged for handling a given shipment. In many cases, rates are negotiated based on a discount from published tariffs, which are updated infrequently and do not necessarily reflect current market conditions such as fuel prices, capacity or demand. This rate is usually documented in a trip contract that is prepared by either a shipper or carrier. In cases where a shipper and carrier have a pre-existing contract in place, the terms of the pre-existing contract may govern the shipping transaction. However, many traditional contracts between shippers and carriers have extremely complex rate schedules, which often create uncertainty regarding the proper rate to apply, and which often result in billing errors.

In the event a shipper is unable to locate sufficient capacity using its own resources, it will often contact a broker to obtain the needed capacity. Traditional freight brokers will locate capacity for the shipper, but they stand between the shipper and the carrier to do so. Generally speaking, shippers employing freight brokers have little input regarding the carrier who will handle their shipments.

Moreover, brokers typically charge large commissions ranging from 11% to 13% of a gross freight bill. Brokers are typically paid by either billing the shipper for their fee, or by billing the shipper for a pre-arranged transportation charge and keeping the difference between the amount of the transportation charge billed to the shipper and the carrier's charge to the broker for transporting the freight.

Once a shipment has been assigned to a carrier or carriers, the shipper will prepare the appropriate bills of lading and wait for the carrier or carriers to arrive and pick up the shipment. Occasionally, a carrier that has committed to a shipment will be unable to handle the shipment itself. In such cases, carriers often turn to brokers to locate a carrier to cover a shipment or broker the shipment themselves. The transaction structure for these transactions is substantially similar to the structure described above with respect to a broker acting on behalf of an ordinary shipper.

Provided that a carrier is found for the load, the carrier or carriers, e.g. the drivers that they engage or employ, then arrive and pick up the shipment and deliver it to the assigned destination(s). A shipper's ability to track the progress of its shipment during delivery is dependent upon the shipment tracking capability of a given carrier. Shipment tracking capability varies from real time tracking of precise shipment location using satellite technology, to less precise manual systems that require drivers to periodically “phone in” their position. Having the receiving party sign the bill of lading pertaining to a given shipment typically proves freight delivery.

The signed bill of lading is then forwarded to the carrier's billing department so that a freight bill can be generated. Usually, freight bills are prepared manually, one at a time, due to the complex contractual terms that are often applicable to such bills. In addition to determining the proper rate to apply to a shipment, if applicable, other surcharges (such as charges for wait times, extra stops, etc.) are added to the bill. The personnel preparing the freight bills are also often subject to production quotas. Thus, the time pressure associated with bill preparation increases the likelihood that errors will be introduced into the billing process (including fundamental errors such as sending a freight bill to the wrong party). Once the freight bill is prepared it is forwarded to the “bill to” party indicated on the appropriate bill of lading. Sometimes, freight bills are forwarded using an EDI; otherwise they are forwarded through traditional channels of commerce.

Once the “bill to” party receives the freight bill, it must be reviewed by the “bill to” party's personnel to determine the accuracy of the bill. Bills are also checked to confirm that the “bill to” party is the proper recipient of the bill and that contract terms such as rates and surcharges have been properly applied. Once the “bill to” party's personnel have completed their review of the bill, the bill is approved for payment and payment is made. The “bill to” personnel reviewing the freight bills, are also often subject to production quotas. Again, the time pressure created by these quotas increases the likelihood that the “bill to” party wrongly pays charges appearing on the freight bill.

Third party logistics providers offer a range of services from providing assistance in locating carrier capacity to managing a complete outsource solution to a shipper's logistical needs. Third party logistics providers are compensated in a variety of ways depending on the arrangement between the shipper and the third party logistics provider. Frequently occurring compensation arrangements include a fixed brokerage commission per shipment, a monthly administration charge, a pre-arranged rate matrix for shipper's freight charges, or some combination thereof.

Yet another advantage is that the carriers' too can look to a single point of contact with regard to the status of outstanding fulfillment offers provided to multiple shippers. Moreover, searching may be made more efficient as a result of the availability of qualitative partner rating information regarding shipper performance. Such detailed historical information archived by the system can be provided to carriers and shippers alike. This information provides data pertaining to the timeliness of deliveries and payment for deliveries, accuracy of reported shipment weights, billing accuracy, percentage of goods damaged during delivery, number of claims made by shippers for damaged goods, carrier maintenance schedules, and other measurable criteria to the system participants so that both shippers and carriers can make informed decisions as to what shipments carriers will provide fulfillment offers for, and which carriers shippers should consider to transport their loads. Price does not have to be the sole factor in selecting business partners. Rather, the system facilitates selection based on price and quality mix. In addition, problems associated with limited visibility in the market are largely overcome due to the system's ability to overcome limitations imposed by geography.

The following terms may be used herein:

Bill of Lading—A document issued by a carrier (trucking company) which serves as a receipt for the goods to be delivered to a designated person or to his order. The bill of lading describes the conditions under which the carrier accepts the goods and details that nature and quantity of the goods, name of vessel (if shipped by sea), identifying marks and numbers, destination, etc. The person sending the goods is the “shipper” or “consignor,” the company or agent transporting the goods is the “carrier”, and the person for whom the goods are destined is the “consignee”. Bills of lading may be negotiable or non-negotiable. If negotiable, i.e., payable to the shipper's order and properly endorsed, title to the goods passes upon delivery of the bill of lading.

Break Bulk—To separate a composite load into individual shipments and route to different destinations.

Broker (or Freight Broker)—is a company or individual that arranges for transportation of cargo belonging to others, utilizing for-hire carriers to provide the actual transportation. However, the Broker does not assume responsibility for the cargo and usually does not take possession of the cargo. Freight brokers put customers, loads, trucks, and drivers together. When a trucking company has a customer whose load has to go now, they will call a broker if they don't have a truck available. Brokers do the legwork it takes to find the trucks fast. They make the phone calls, contacts, and arrangements on behalf of the trucking company and the driver. Brokers charge a fee for this service, and the fee is often based on how critical it is to move the load. They are in a position to save the trucking company owner a lot of time, but using a broker can add to the cost of the load. Many companies establish relationships with brokers in order to get the best possible rates when they are in crisis mode and have to move a valuable load.

Cargo Weight—Combined weight of all loads, gear and supplies on a vehicle.

Certificate of Insurance—A document containing certain terms of a full-length insurance policy. A one-page document, it is evidence that there is insurance coverage for a shipment. Beneficiaries of open cargo or blanket insurance policies are authorized to issue their own certificates of insurance.

Cityliner—Truck used in the city for pickup and delivery.

CMV—Commercial Motor Vehicle

Common Carrier—Freight transportation company which serves the general public. May be regular route service (over designated highways on a regular basis) or irregular route (between various points on an unscheduled basis).

COFC (Container On Flat Car)—Method of moving shipping containers which involves transporting them on railroad flat cars.

Consignee—The receiver. The company taking in freight. The place you deliver your load/goods.

Consignor—Shipper of goods.

Dead-Heading—Operating a truck without cargo.

Detention Time—A charge the motor carrier assesses when a shipper or receiver holds a truck or trailer beyond the free time the carrier allows for loading or unloading.

EDI (Electronic Data Interchange)—The business-to-business interconnection of computers for the rapid exchange of a wide variety of documents, from bills of lading to build tickets at auto plants.

FOB Pricing—A term of sale defining who is to incur transportation charges for the shipment, who is to control the shipment movement, or where title to the goods passes to the buyer; it originally meant “free on board”

FOB Origin—Title passes at origin, and buyer has total responsibility over the goods while in shipment. Customer takes ownership (title and control) of the goods at the origin (when the carrier signs for goods) and is responsible for transportation of the goods beyond this point. The customer files claims (if any).

FOB Destination—Title of the goods passes at destination, and seller has total responsibility until shipment is delivered. Ownership (title and control) remains with seller until goods are delivered. It is expected that the supplier will make all of the transportation arrangements. This policy recognizes that the supplier may be in a position to handle transportation more economically than the customer or that the customer does not possess the desire or expertise to make such arrangements. The Seller files claims (if any).

If the terms agreed on are FOB Origin or Destination Freight Prepaid—The seller pays and bears the freight charges. If the terms agreed on are FOB Origin or Destination Freight Prepaid and Charged Back—The seller pays the freight charges but charges them back to the buyer in the invoice. If the terms agreed on are FOB Origin or Destination Freight Collect—The buyer pays and bears the freight charges. If the terms agreed on are FOB Origin or Destination Freight Collect and Allowed—The buyer pays the freight charges, but the seller bears the charges in the invoice.

Freight Forwarder—A person that dispatches shipments via common carriers and books or otherwise arranges space for those shipments on behalf of shippers and processes the documentation or performs related activities incident to those shipments.

Free Time—The period goods will be held before storage charges are applied.

Fuel surcharges—An adjustment based on a rounded average of the national U.S. on-highway average prices for a gallon of diesel fuel. (See appendix #4, 5)

GVW (Gross Vehicle Weight)—Total weight of a vehicle and everything aboard, including its load.

Hazmat—Hazardous materials, as classified by the U.S. Environmental Protection Agency (EPA). Transport of hazardous materials is strictly regulated by the U.S. Department of Transportation.

Hot Load—emergency shipment of goods needed in a hurry.

ICC—Interstate Commerce Commission.

Intrastate—Carrier that just provides services within a state. Does not go to other states.

Intermodal—When goods is undertaken by one or more successive modes of transportation (i.e. truck to train or rail to water).

Interstate—Carrier that provides services from state to state or within a certain geographic region.

Lumper (Lumping)—The act of assisting a motor carrier owner-operator in the loading and unloading of property; quite commonly used in the food industry. Often there is a fee placed on the driver for this assistance.

Line Haul—movement of freight between cities and terminals. Line haul does not include pickup and delivery service.

LTL Carrier—Trucking company which consolidates less-than-truckload cargo for multiple destinations on one vehicle. (see further explanation below)

Less-than-Truckload (LTL)—Shipment that would not, by itself, fill the truck to capacity by weight or volume. Carriers LTL rates are generally higher than TL rates. A quantity of freight less than that required for the application of a truckload (TL) rate; usually less than 10,000 pounds. TL shipments are generally anything over 10,000 lbs. and LTL shipments are generally less than 10,000 lbs. However, each company may vary in how much weight is considered TL or LTL. The breakpoint b/w TL and LTL is the level at which a discount is given for a volume order meeting the minimal weight for a TL shipment. (For example 10,000 lbs. is a common breakpoint at which you will be charged for a full truckload).

Milk Run—Is assumed that the number of shipments, deliveries, and movements to certain location(s) are equal and on a fairly constant basis.

Packing List—a document that more thoroughly identifies the goods to be delivered than a bill of lading.

P & D—Pick-up and Delivery.

Pallet Size—40×48 in. (standard size).

Payload—Weight of freight being hauled.

Peddle Run—Truck route with frequent delivery stops.

Per hundred weight (CWT)—A unit of weight measurement created by U.S. merchants since the late 1800s. A hundred weight is equal to exactly 100 pounds. Usually, this measurement is used in futures contracts that require the weight of the underlying to be specified.

Private Carrier—Business which operates trucks primarily for transporting its own products and raw materials.

Pup Trailer—Short semi-trailer, usually between 26 and 32 feet long with a single axle.

Reefer Truck (Refrigerated Vehicle)—A Cargo unit which has a controlled temperature reefer unit on the trailer to keep specialized products at a constant temperature. Food items are common products to be shipped on a reefer truck.

Shipping Weight—“Dry” weight of a truck including all standard equipment, but excluding fuel and coolant.

Team (Driver Team)—Team of two drivers who alternate driving and resting. •Single Driver—Person driving by himself/herself.

TEU (Twenty Equivalent Unit)—Standardized unit for measuring container capacity on ships, railcars, etc.

TL Carrier—Trucking company which dedicates trailers to a single shipper's cargo.

TOFC (Trailer On Flatcar)—Method of moving cargo which involves transporting semi-trailers on railroad flat cars.

Truckload (TL)—Shipment that fills a trailer to its maximum capacity, either by weight or cube. Carriers give a rate reduction for shipping a TL size shipment.

Trailer Size—53 ft., 48 ft., 45 ft.×102 in. (standard sizes).

Van (Dry Van)—Standard trailer or truck with all sides enclosed.

Third-party logistics (“3PL”) is the outsourced movement of goods along a diverse or an entire company's supply chain. Third-party logistics are activities carried out by an external company on behalf of a shipper and consisting of at least the provision of and management of multiple logistics services. These activities are offered in an integrated way, not on a stand-alone basis. The co-operation between the shipper and the external company is an intended continuous relationship.

### BRIEF DESCRIPTION OF THE DRAWINGS

FIG. 1 depicts block diagram of a logistics management system according to one embodiment.

FIG. 2 shows an illustrative embodiment of a general computer system for use with the system of FIGS. 1-7.

FIG. 3 depicts a flow chart showing the operation of the system of FIG. 1 according to one embodiment.

FIGS. 4A-4DQ depict exemplary user interface displays for use with the embodiments of FIGS. 1-3

### DETAILED DESCRIPTION

The disclosed embodiments relate to transaction management systems such as a third party logistics system for managing freight shipment transactions among multiple participants, e.g. initiated by a shipper and executed by a combination of a broker, carrier and/or driver. The disclosed embodiments further related to a third party logistics system having hierarchical downstream modification permissioning whereby, in at least one embodiment, the ability for a downstream participant to make modifications to a given transaction, including further authorizing modification by a downstream participant, is controlled by the direct upstream participant.

In current logistics implementations, numerous parties play different roles in completing a given transaction, i.e. in the conveying/moving of freight from an origin to a destination. The transaction itself is characterized by a workflow or process comprising a multiple and/or sequential tasks or stages by which the transaction is completed, a completion of one process or stage automatically leading to a subsequent process or stage. For example, the transaction, via interaction with the disclosed system, e.g. via a graphic user interface provided there by, is initiated by shipper who then selects/assigns a broker (or carrier). In one embodiment, the shipper and carrier may be the same entity, i.e. a “shipper-carrier” where the shipper operates their own trucks and a broker is not needed. The selection/assignment of a particular broker automatically alerts or otherwise notifies the selected/assigned broker or otherwise initiates the next stage of the processing of the transaction therewith. The selected/assigned broker then, via independent interaction with the system, evaluates and accepts the transaction and then selects/assigns a carrier. The selection/assignment of a particular carrier automatically alerts or otherwise notifies the selected/assigned carrier or otherwise initiates the next stage of the processing of the transaction therewith. The selected/assigned carrier then, via independent interaction with the system, evaluates and accepts the transaction and then selects/assigns a driver to effect the transaction. The selection/assignment of a particular driver automatically alerts or otherwise notifies the selected/assigned driver or otherwise initiates the next stage of the processing of the transaction therewith. The selected/assigned driver then, via independent interaction with the system, evaluates and accepts the transaction and then effects the transaction, e.g. makes the delivery thereby completing the processing of the transaction. During the process of effecting delivery, various updates to the transaction, e.g. current status, delays, etc., are provided to the other participants via notifications communicated via the system, e.g. via the graphic user interface provided thereby, email, text messages, automated voice messages, etc. Such notifications may be automatically generated as the driver makes updates to the transaction via their interaction with system, such as via a graphic user interface of an app that executes on their smart phone or other personal/wireless device. Other notifications may be generated manually, such as via messaging service provided by the system. Accordingly, the disclosed system manages, or otherwise assists the parties with managing, the workflow of completing a given transaction from initiation to completion of delivery.

These parties may include the shipper, the broker, the carrier and the driver. In some cases a broker may not be used, the broker and carrier may be the same party, or the shipper and carrier may be the same party, e.g. a shipper-carrier. The parties form a hierarchy of control over a transaction with the shipper, e.g. the party typically initially arranging and paying for the transaction and necessitating its completion, being at the top of the control hierarchy. The broker being the next party in the hierarchy, followed by the carrier and then the driver who actually effects the delivery. It will be appreciated that the shipper may actually be the intended recipient of the shipment, such as where a buyer of goods arranges for the shipment of those goods from the seller or manufacturer. Furthermore, the destination of a shipment may be an intermediate destination, such as a warehouse or other intermediate storage facility, and not the final destination. A given transaction may cover the delivery only to an intermediate location or may cover the delivery all the way to the final destination. In some cases, there may be multiple destinations, such as where a shipment is broken down into smaller subsets thereof to be delivered to different locations.

The given combination of parties may vary transaction by transaction as shippers seek lower cost alternatives, specialized services for particular transactions, available capacity, etc. Furthermore, each transaction may be characterized by numerous parameters, characteristics, requirements, issues etc. particular to the type of load to be transported, the mode by which the goods need to be transported, the timing of the transport, real time/environmental issues, such as traffic delays, mechanical issues, congestion at the delivery point, personnel issues, etc. With so many parties involved and so many variables at play in a given transaction, each party may need or want flexibility to alter parameters of the transaction, in real time or otherwise subsequent to the initiation of the transaction. For example, based on mechanical issues, available capacity and/or congestion at the delivery location, a carrier and/or driver may wish to alter the mode of transport and/or delivery date. However, other parties may not want such alterations to be made. For example, while a driver or carrier may wish to alter a delivery date due to a mechanical issue, the shipper may require that the delivery occur by the date when the transaction was initiated. In traditional logistics management, it may be difficult to control and/or monitor what each party is doing and alterations to the transaction may occur without the knowledge of the other parties, at least until it is too late to prevent such an alteration. Where a party seeking an alteration first seeks permission, the cumbersome nature of contacting the appropriate party and obtaining such permission may further impact, e.g. delay, the transaction. Documenting such approved modifications may prove difficult and subsequent disputes may occur. Nevertheless, the parties may realize that granting flexibility to one or more other parties to alter parameters of the transaction, in particular where a trust relationship exists, may improve efficiency, reduce costs, and improve reliability.

This disclosed embodiments relate to a logistics management system for managing the transportation and delivery of freight shipped/initiated by a shipper from an origin to a destination using a combination of a carrier (which may be the shipper), optional broker and driver. The disclosed embodiments include a permissioning system which utilizes a hierarchical permission data structure to store data indicative of downstream permission/authorization, or revocation thereof, to modify transactional parameters for each transaction and for each party thereto. The permissioning system enables a transaction initiator to grant permission to modify the transaction to a downstream party, e.g. the next proximate downstream party or a party further downstream, and may further include the permission/authorization to further permission/authorize a subsequent downstream party to modify the transaction and/or further authorize a subsequent downstream party to do so, e.g. each party in the transaction may inherit the permissions granted to the proximate upstream party. In one embodiment, as each downstream party is added to a transaction, an instance of a permission data record is created/and or updated in the permission system whereby the permissions/authorizations given by the upstream party are inherited. In one embodiment, a permissioning/authorizing user interface is provided which displays the current permission status of a party, e.g. whether they are currently enabled to modify the transaction and/or whether they are currently able to grant permission to a downstream party to modify the transaction and/or further grant modification permission to subsequent downstream parties. In one embodiment, when a party that is granted permission to modify a transaction actually makes a modification, the system automatically electronically notifies all of the other parties of the modification. In one embodiment, where a party has not been granted permission to modify a transaction, the permissioning system, via the user interface may enable the party to electronically request such permission from an upstream party enabled to grant such a request, and permit an upstream party to receive, review and approve or disapprove of such requests. In one embodiment, the permissioning system may automatically determine which upstream party is authorized to grant modification permission to the requesting downstream party and automatically route the request thereto.

The disclosed data structure enables the system, for given participant, to quickly determine whether that participant has permission to make modifications to a given transaction, enables transaction specific permissioning whereby a participant may be able to modify a particular transaction but not others, and ensures that all participants in a given transaction are aware of modifications made by any one participant thereto.

Herein, the phrase “coupled with” is defined to mean directly connected to or indirectly connected through one or more intermediate components. Such intermediate components may include both hardware and software based components. Further, to clarify the use in the pending claims and to hereby provide notice to the public, the phrases “at least one of <A>, <B>, . . . and <N>” or “at least one of <A>, <B>, <N>, or combinations thereof” are defined by the Applicant in the broadest sense, superseding any other implied definitions here before or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

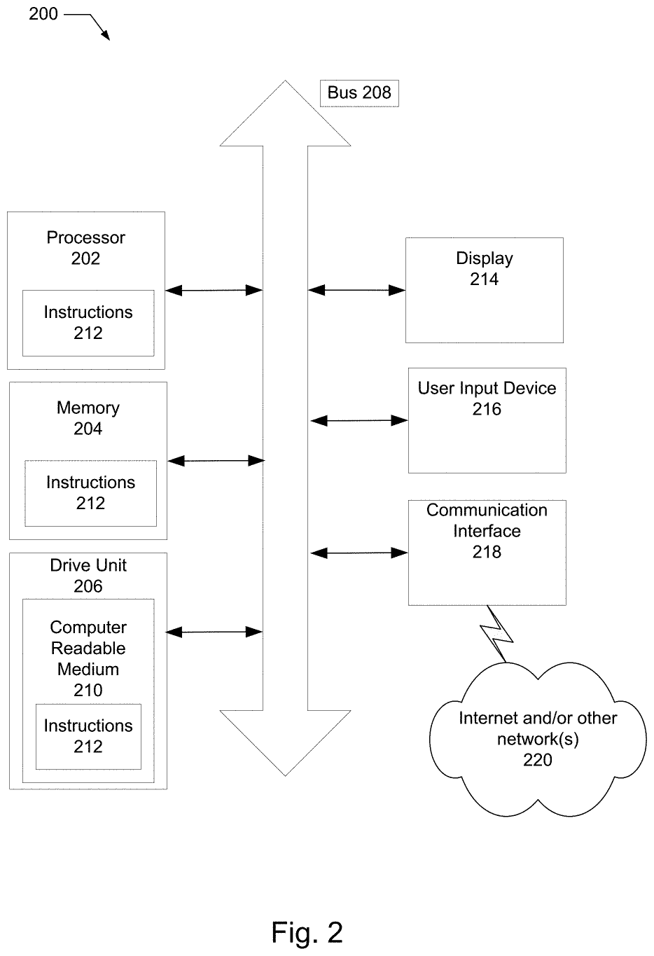

Referring to FIG. 2, an illustrative embodiment of a general computer system 200 is shown. The computer system 200 can include a set of instructions that can be executed to cause the computer system 200 to perform any one or more of the methods or computer based functions disclosed herein. The computer system 200 may operate as a standalone device or may be connected, e.g., using a network, to other computer systems or peripheral devices. Any of the components of the logistics/transaction management system 100 discussed below may be a computer system 200 or a component in the computer system 200. The computer system 200 may implement a logistics/transaction management system, of which the disclosed embodiments are a component thereof.

In a networked deployment, the computer system 200 may operate in the capacity of a server or as a client user computer in a client-server user network environment, as a peer computer system in a peer-to-peer (or distributed) network environment, or as a network device such as a switch, gateway or router. The computer system 200 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 200 can be implemented using electronic devices that provide voice, video or data communication. Further, while a single computer system 200 is illustrated, the term “system” shall also be taken to include any collection of systems or sub-systems that individually or jointly execute a set, or multiple sets, of instructions to perform one or more computer functions.

As illustrated in FIG. 2, the computer system 200 may include a processor 202, e.g., a central processing unit (CPU), a graphics processing unit (GPU), or both. The processor 202 may be a component in a variety of systems. For example, the processor 202 may be part of a standard personal computer or a workstation. The processor 202 may be one or more general processors, digital signal processors, application specific integrated circuits, field programmable gate arrays, servers, networks, digital circuits, analog circuits, combinations thereof, or other now known or later developed devices for analyzing and processing data. The processor 202 may implement a software program, such as code generated manually (i.e., programmed).

The computer system 200 may include a memory 204 that can communicate via a bus 208. The memory 204 may be a main memory, a static memory, or a dynamic memory. The memory 204 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 204 may be a memory component of a reconfigurable logic device, e.g. an FPGA. In one embodiment, the memory 204 includes a cache or random access memory for the processor 202. In alternative embodiments, the memory 204 is separate from the processor 202, such as a cache memory of a processor, the system memory, or other memory. The memory 204 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 204 is operable to store instructions executable by the processor 202. The functions, acts or tasks illustrated in the figures or described herein may be performed by the programmed processor 202 executing the instructions 212 stored in the memory 204. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 200 may further include a display unit 214, such as a liquid crystal display (LCD), an organic light emitting diode (OLED), a flat panel display, a solid state display, a cathode ray tube (CRT), a projector, a printer or other now known or later developed display device for outputting determined information. The display 214 may act as an interface for the user to see the functioning of the processor 202, or specifically as an interface with the software stored in the memory 204 or in the drive unit 206.

Additionally, the computer system 200 may include an input device 216 configured to allow a user to interact with any of the components of system 200. The input device 216 may be a number pad, a keyboard, or a cursor control device, such as a mouse, or a joystick, touch screen display, remote control or any other device operative to interact with the system 200.

In a particular embodiment, as depicted in FIG. 2, the computer system 200 may also include a disk or optical drive unit 206. The disk drive unit 206 may include a computer-readable medium 210 in which one or more sets of instructions 212, e.g. software, can be embedded. Further, the instructions 212 may embody one or more of the methods or logic as described herein. In a particular embodiment, the instructions 212 may reside completely, or at least partially, within the memory 204 and/or within the processor 202 during execution by the computer system 200. The memory 204 and the processor 202 also may include computer-readable media as discussed above.

The present disclosure contemplates a computer-readable medium that includes instructions 212 or receives and executes instructions 212 responsive to a propagated signal, so that a device connected to a network 220 can communicate voice, video, audio, images or any other data over the network 220. Further, the instructions 212 may be transmitted or received over the network 220 via a communication interface 218. The communication interface 218 may be a part of the processor 202 or may be a separate component. The communication interface 218 may be created in software or may be a physical connection in hardware. The communication interface 218 is configured to connect with a network 220, external media, the display 214, or any other components in system 200, or combinations thereof. The connection with the network 220 may be a physical connection, such as a wired Ethernet connection or may be established wirelessly as discussed below. Likewise, the additional connections with other components of the system 200 may be physical connections or may be established wirelessly.

The network 220 may include wired networks, wireless networks, or combinations thereof or other device to device interconnection which facilitate the exchange of data there between. The wireless network may be a cellular telephone network, an 802.11, 802.16, 802.20, or WiMax network. Further, the network 220 may be a public network, such as the Internet, a private network, such as an intranet, or combinations thereof, and may utilize a variety of networking protocols now available or later developed including, but not limited to TCP/IP based networking protocols. The network 220 may further include node-to-node interconnections between computing nodes in a multi-processor computing environment and/or processor interconnections between multiple processing cores of a multi-core processor, such as may be used in either a system-on-chip (SOC) or network-on-chip (NoC) implementation.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein. The computer readable medium can be a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and anyone or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

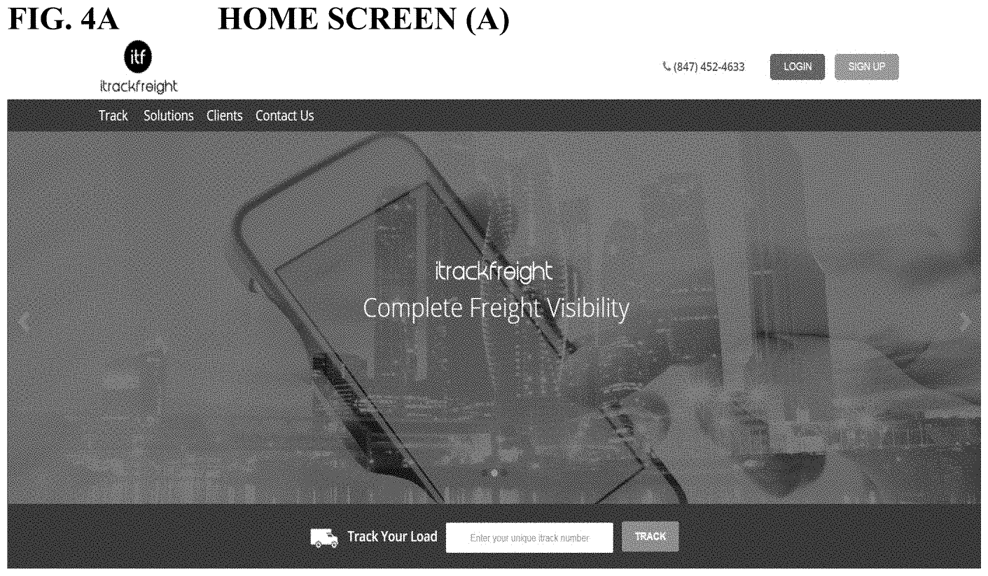

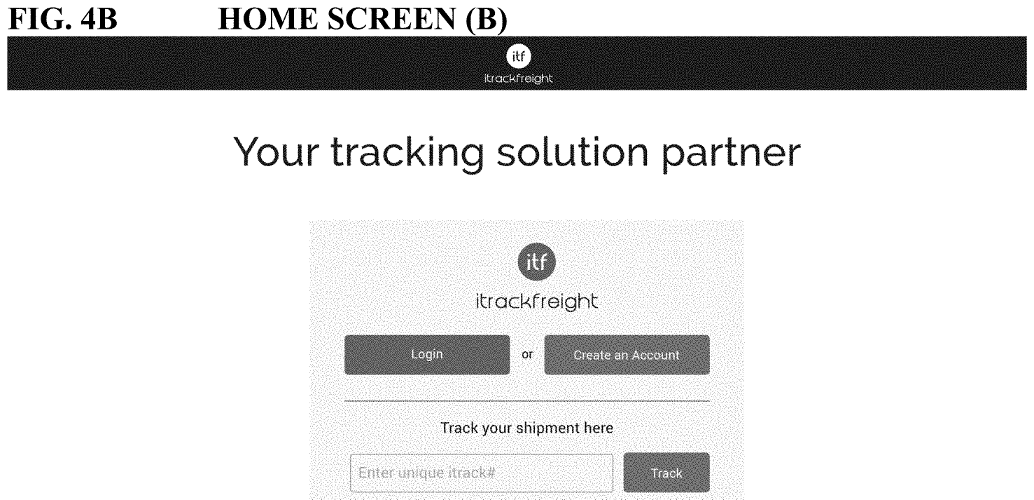

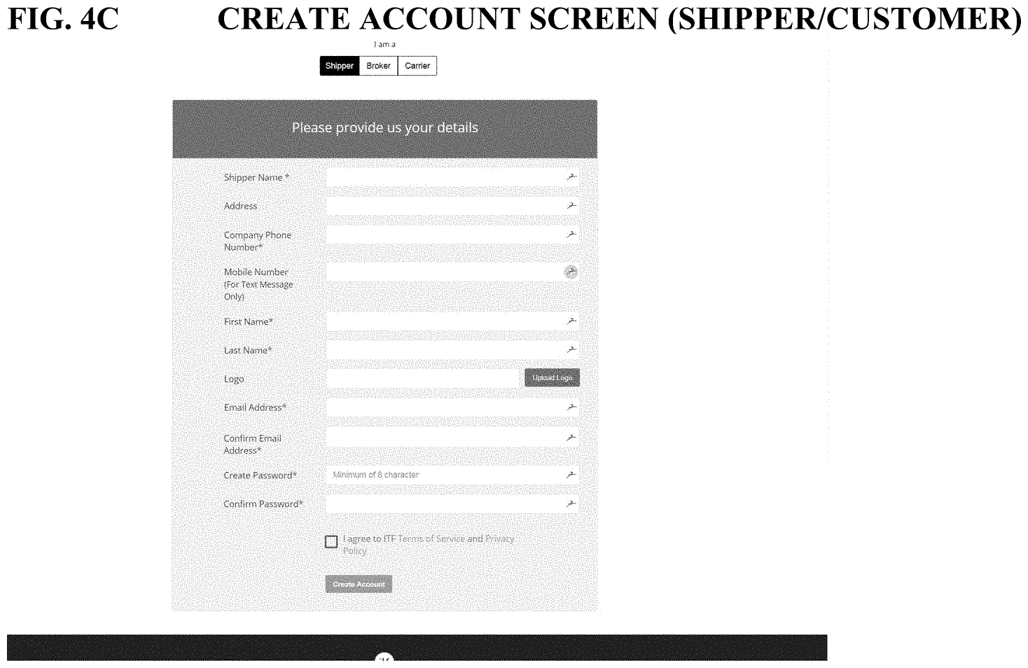

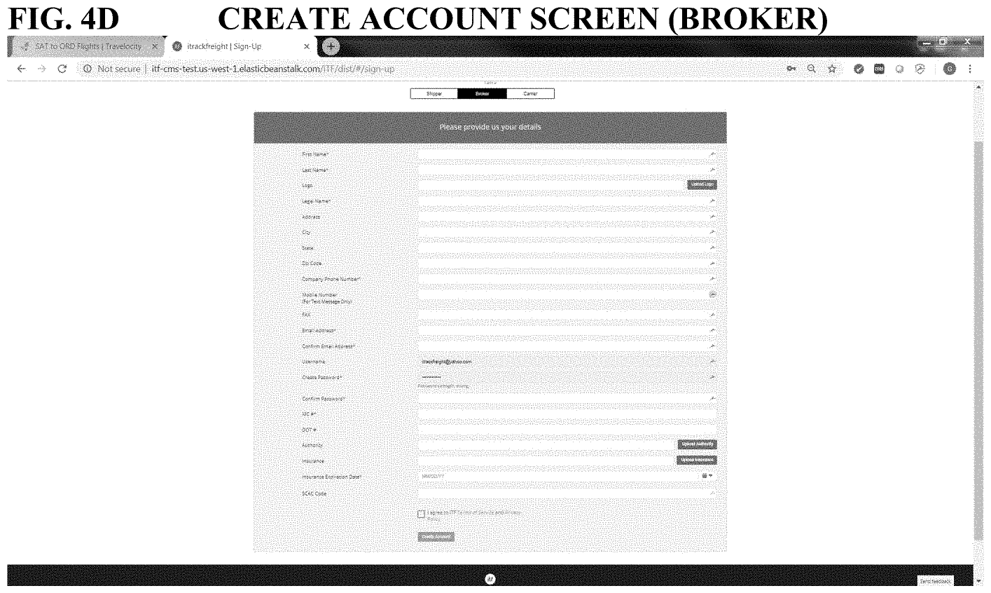

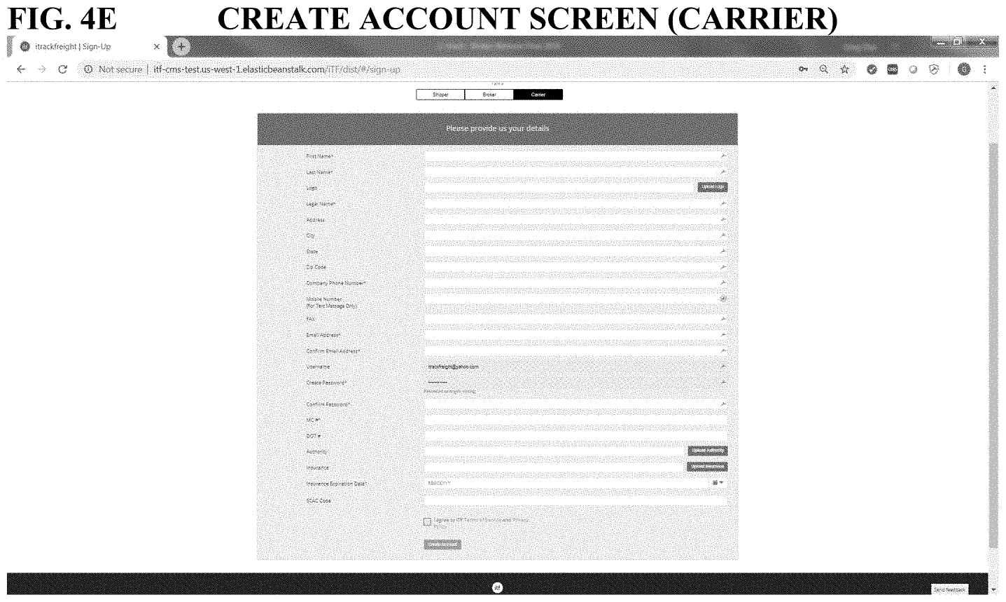

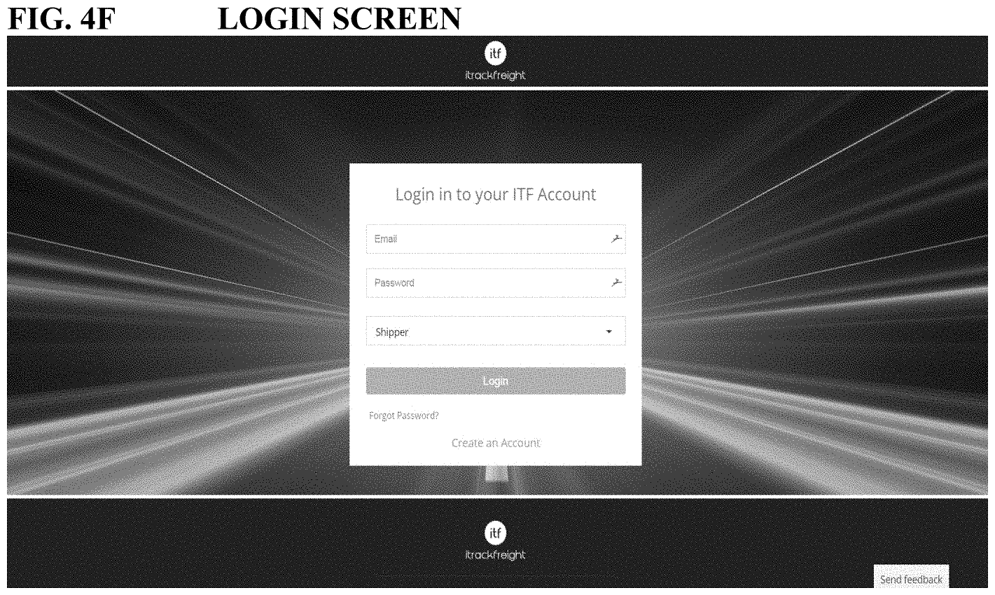

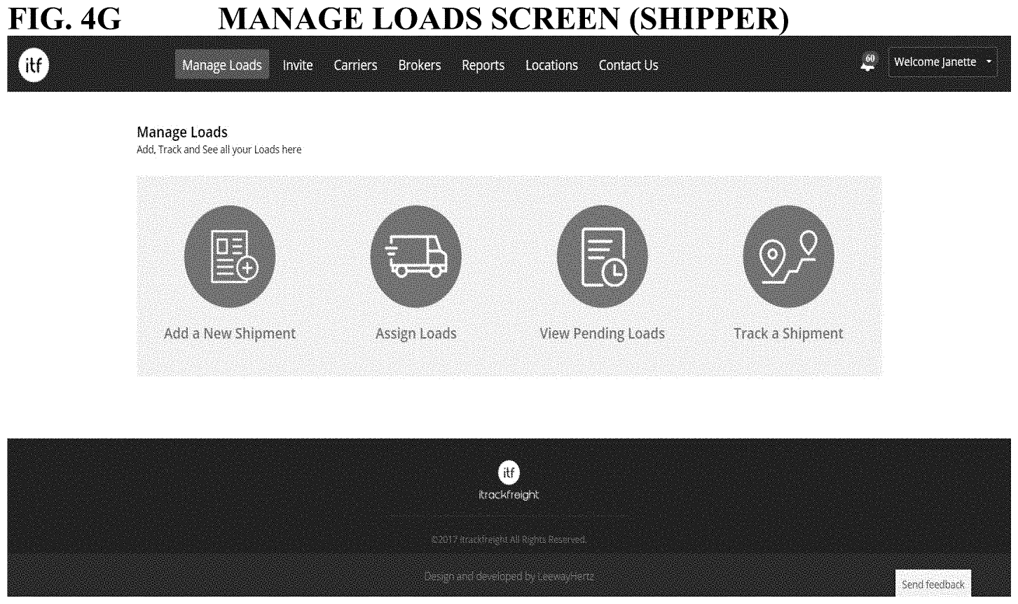

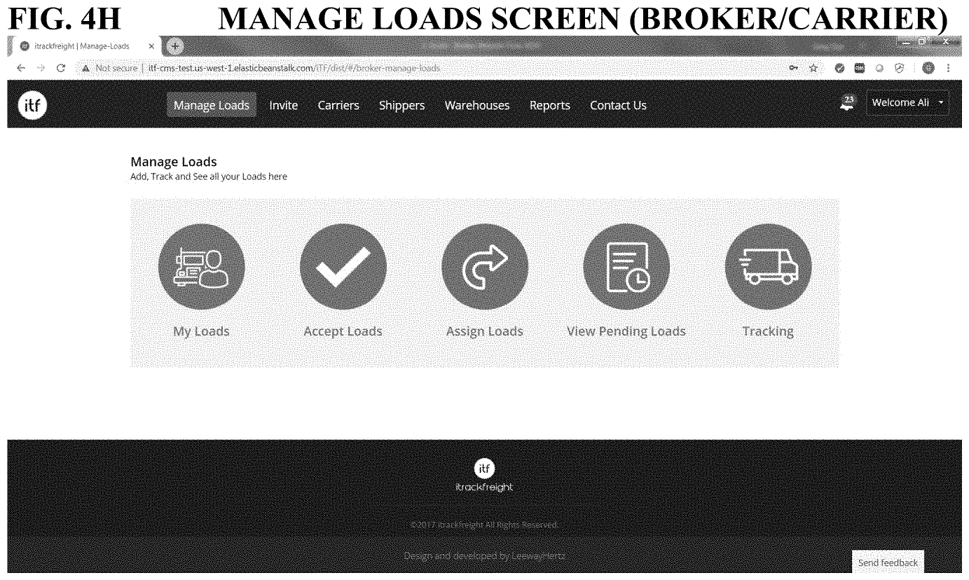

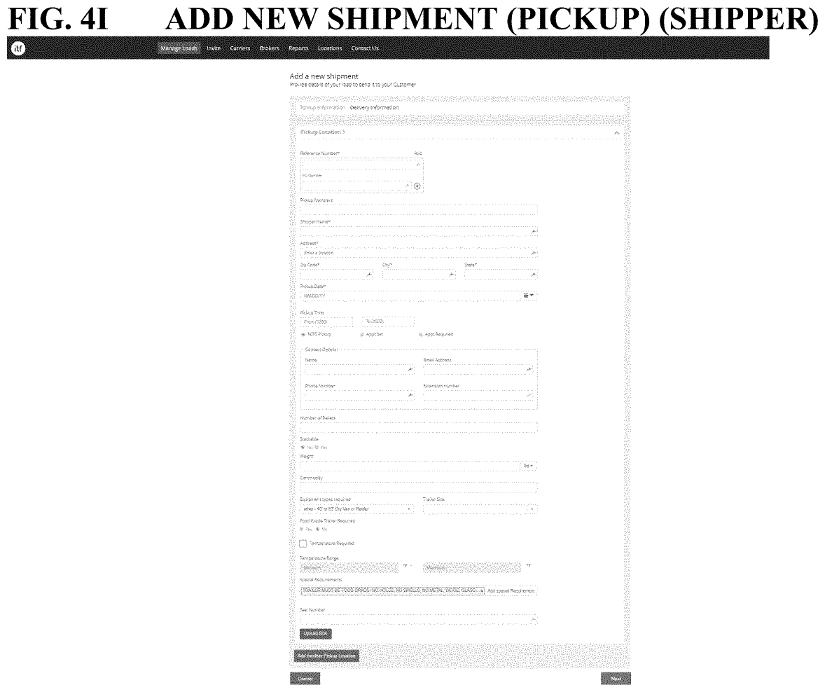

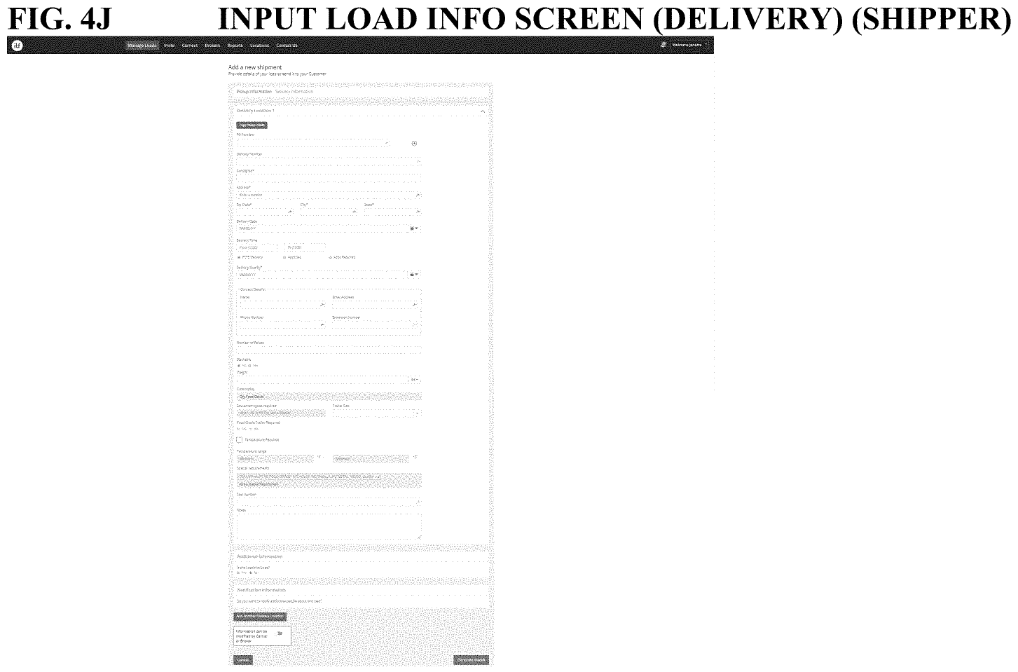

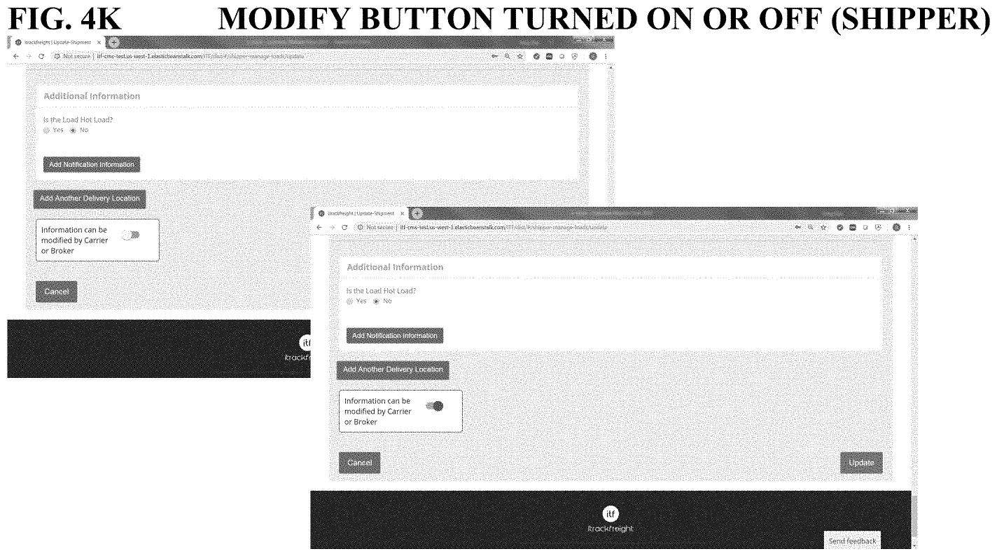

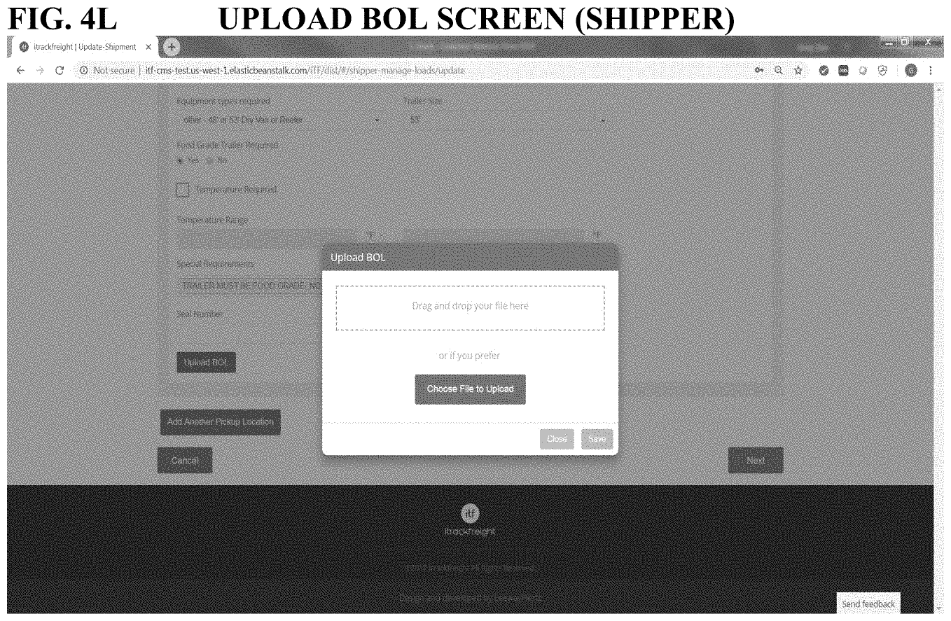

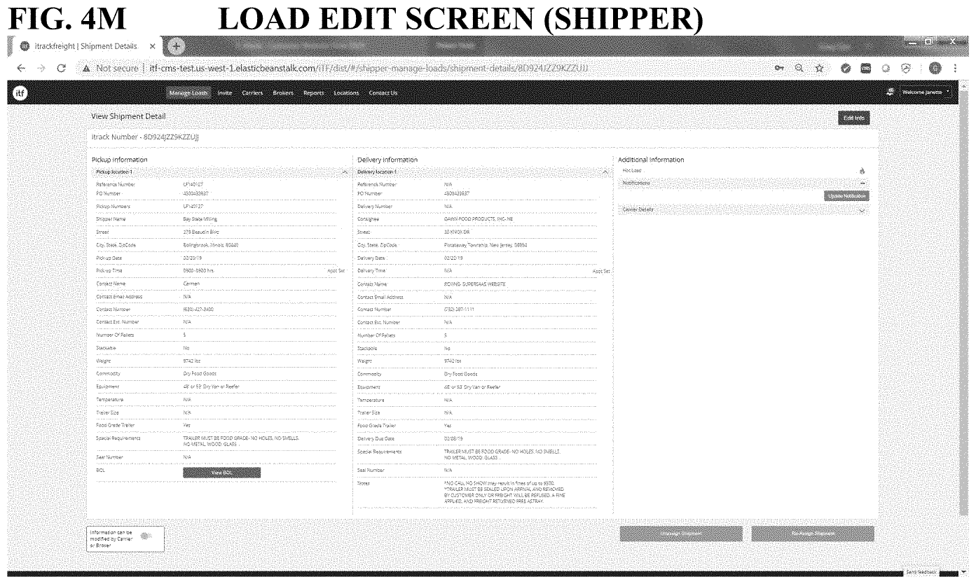

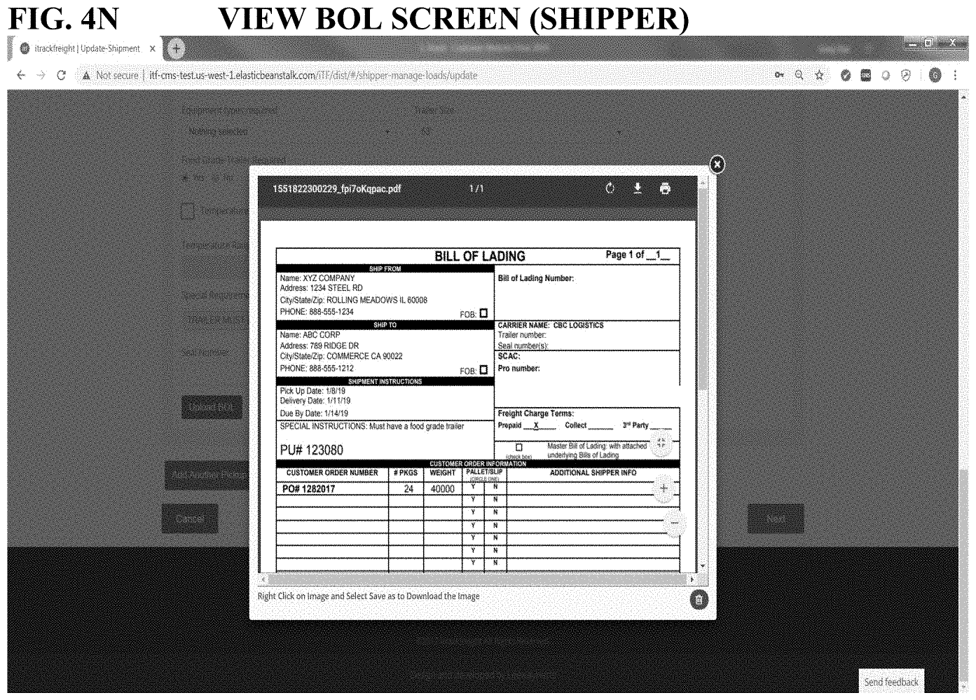

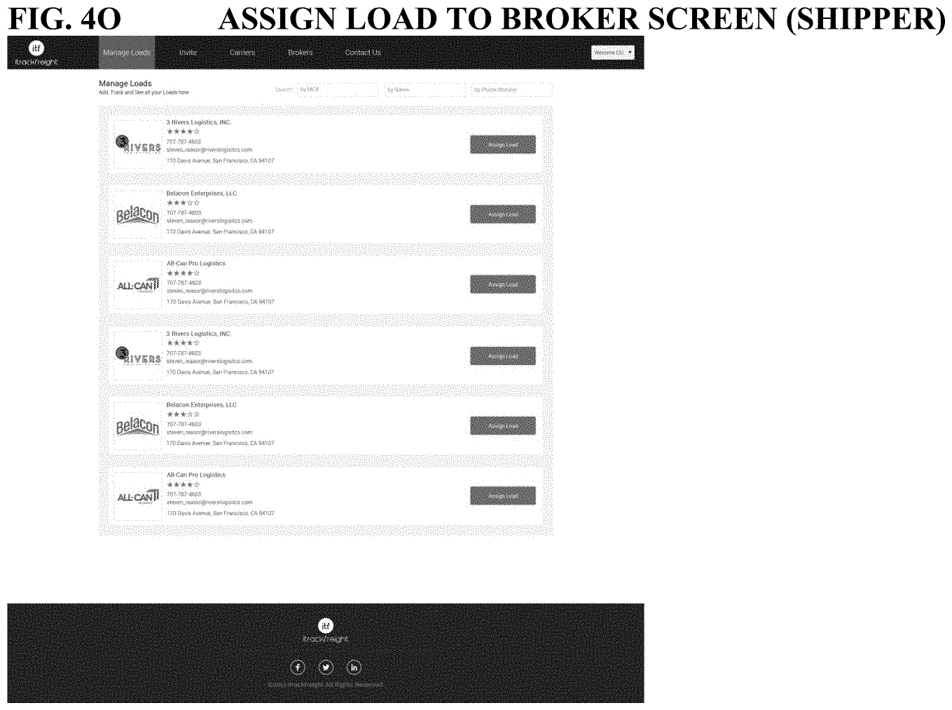

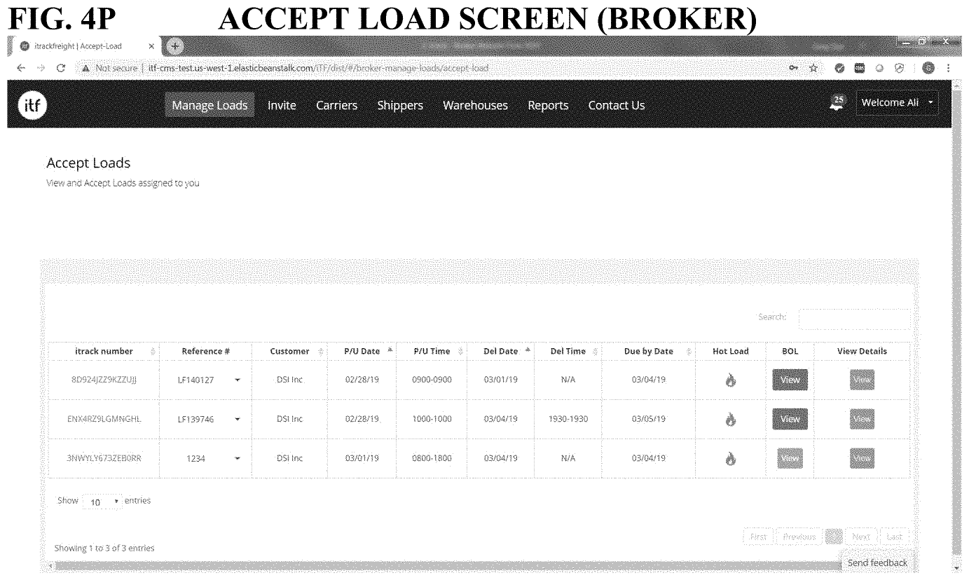

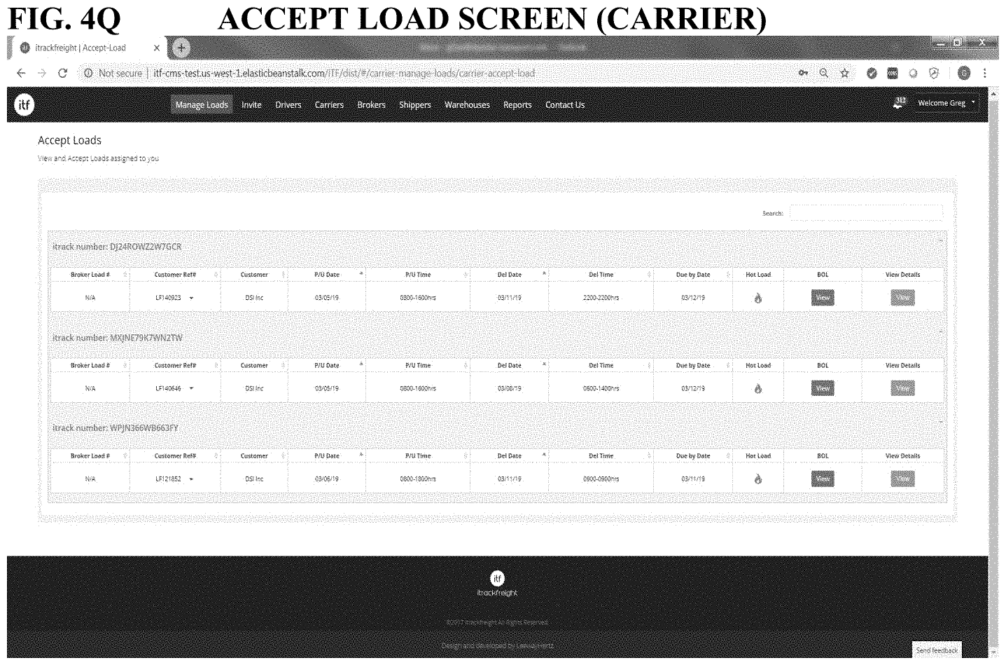

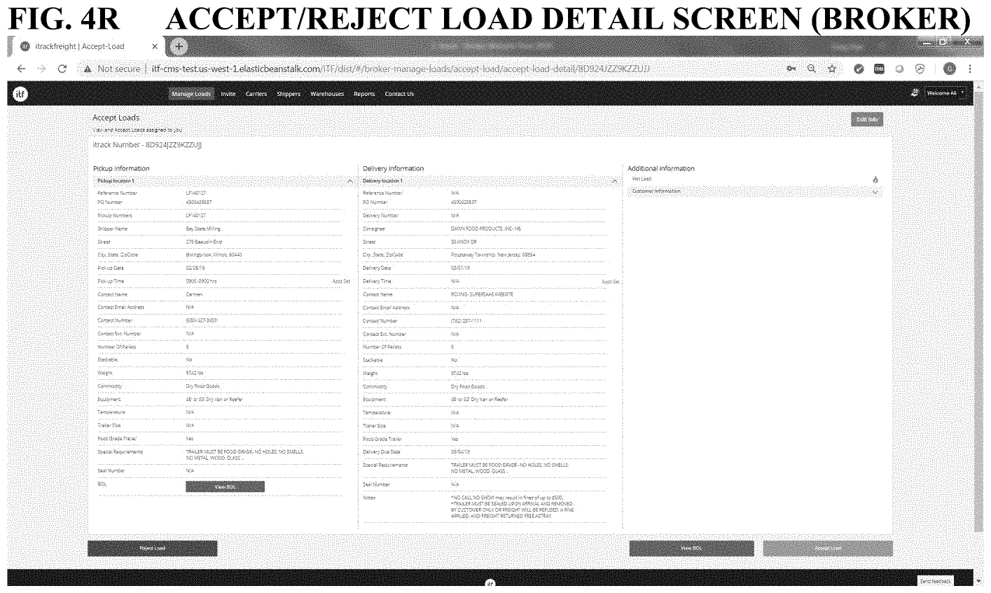

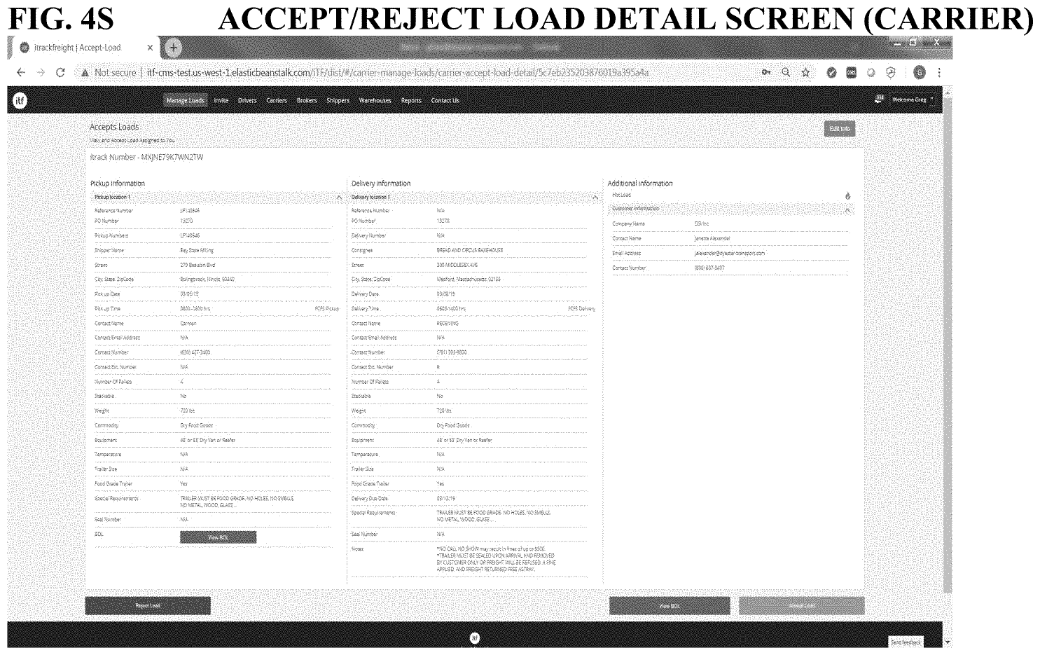

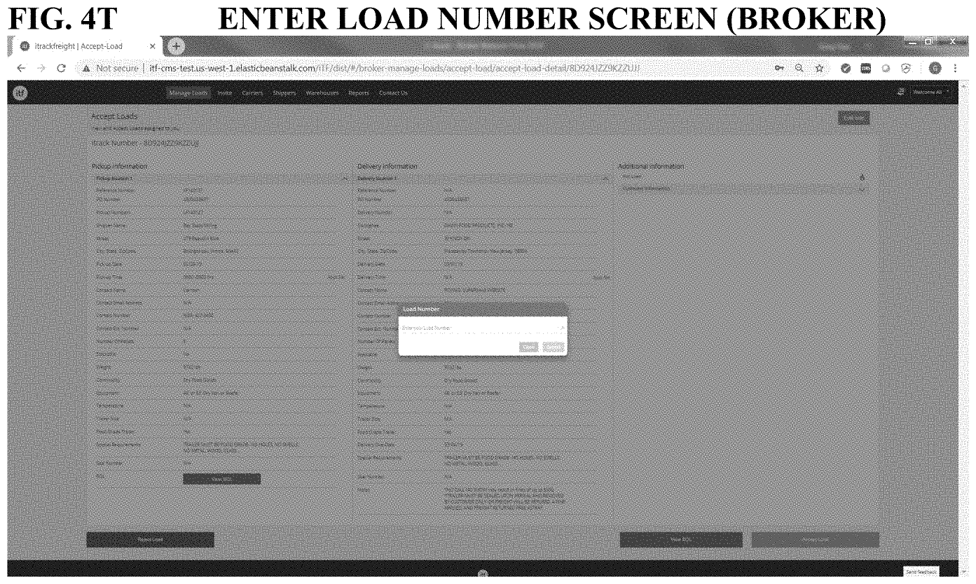

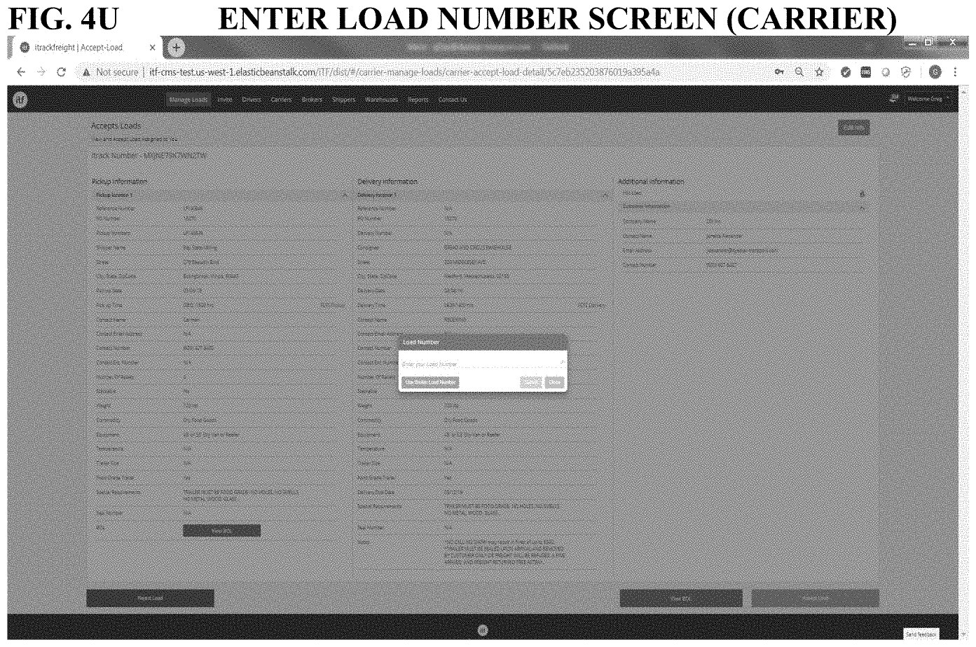

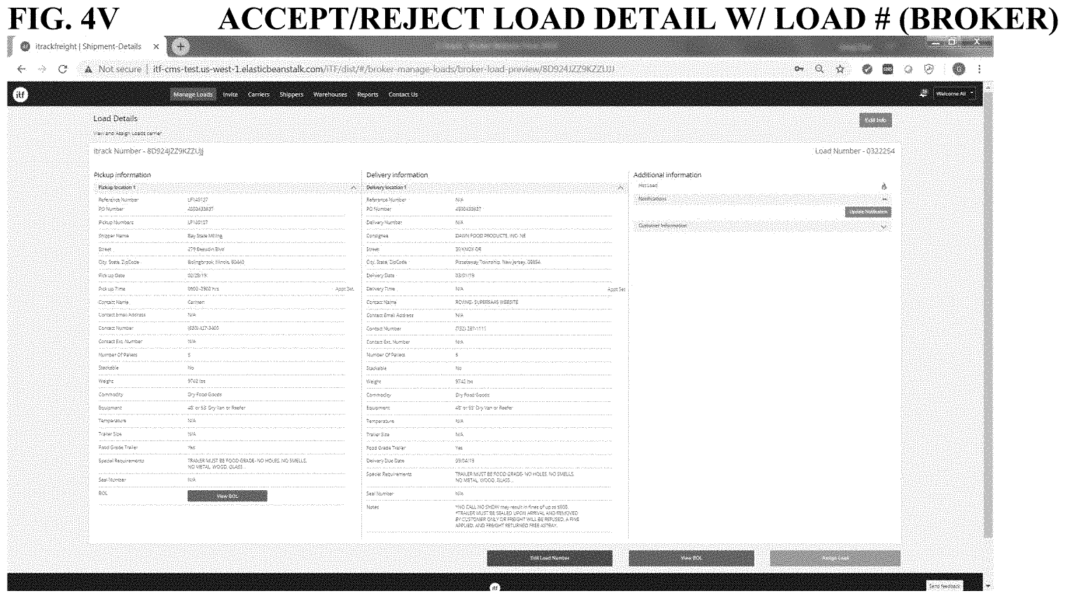

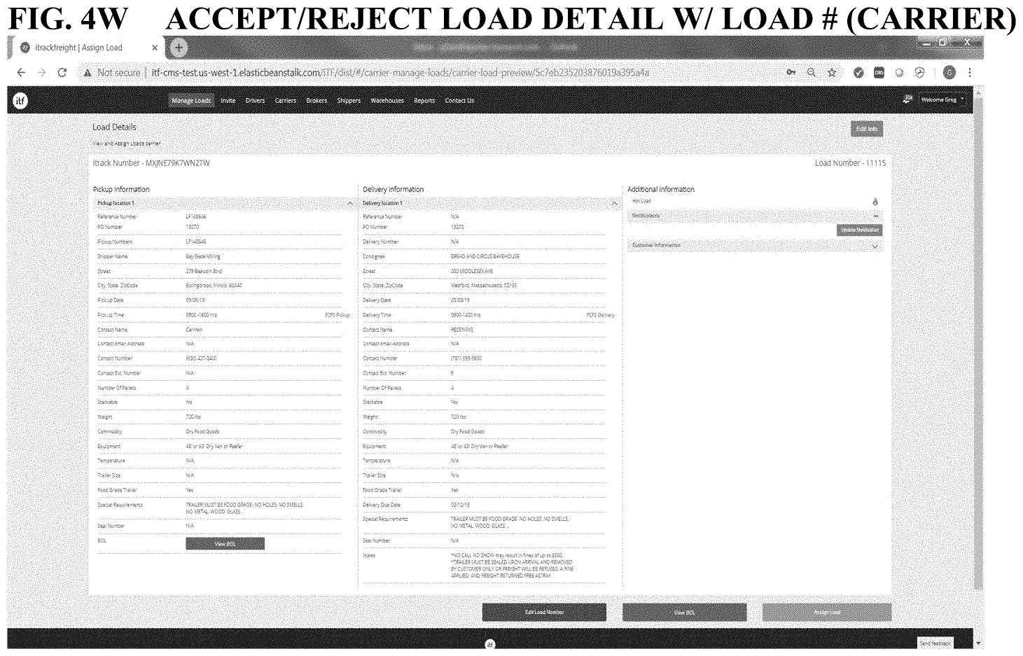

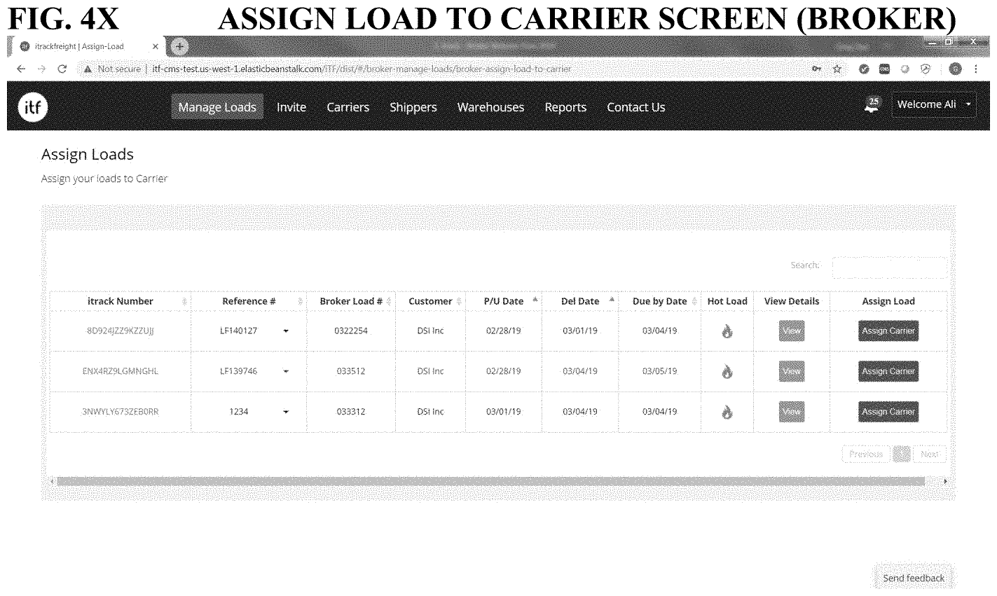

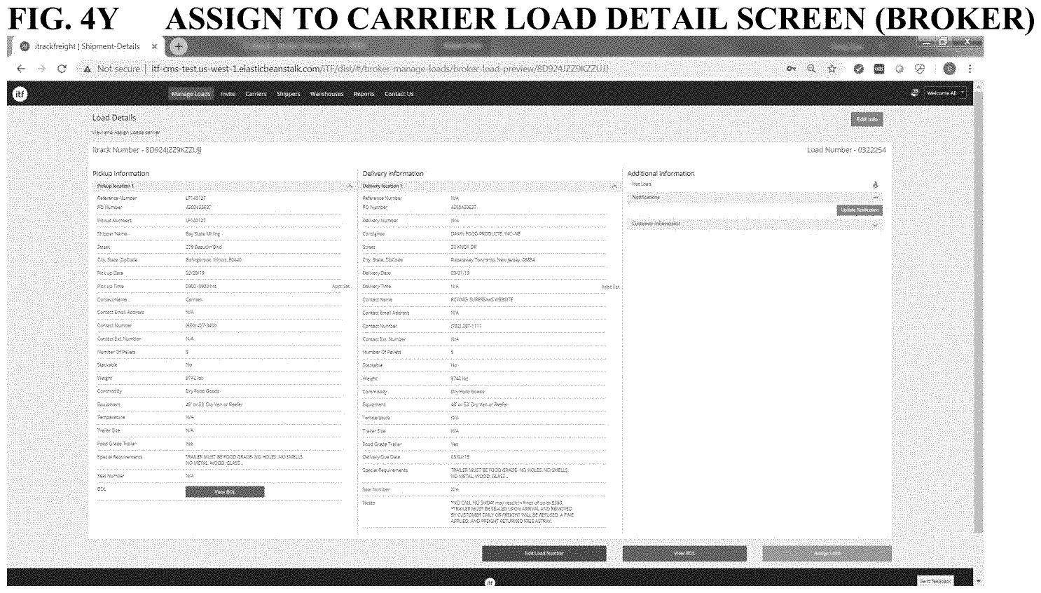

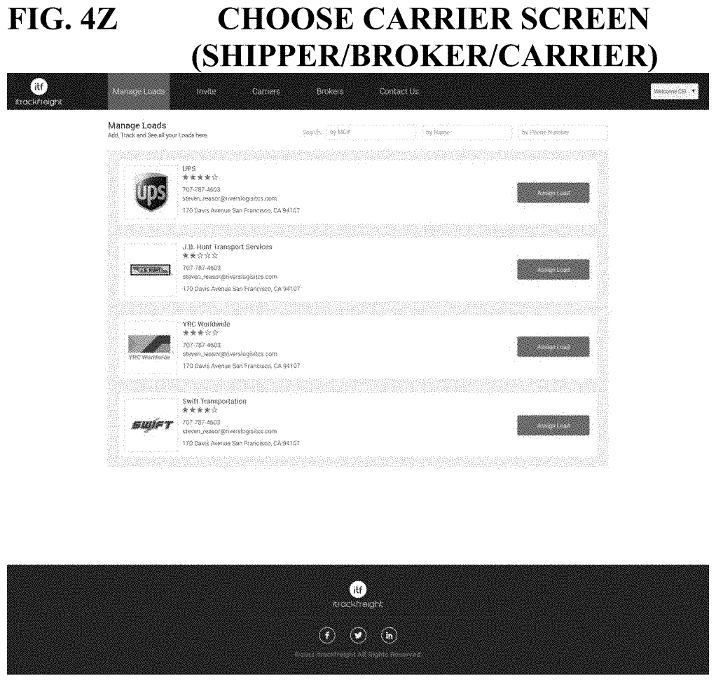

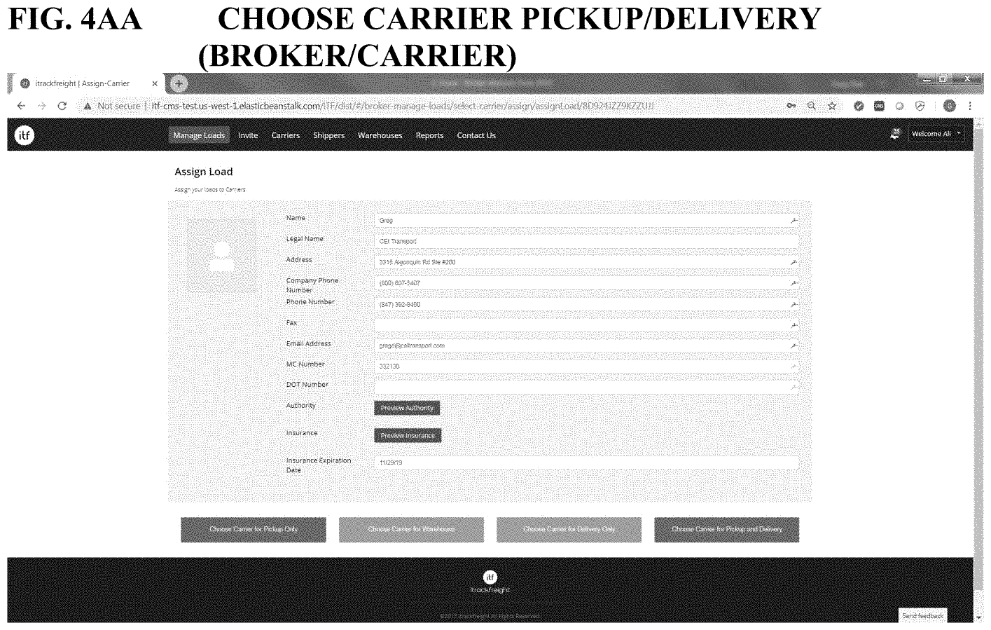

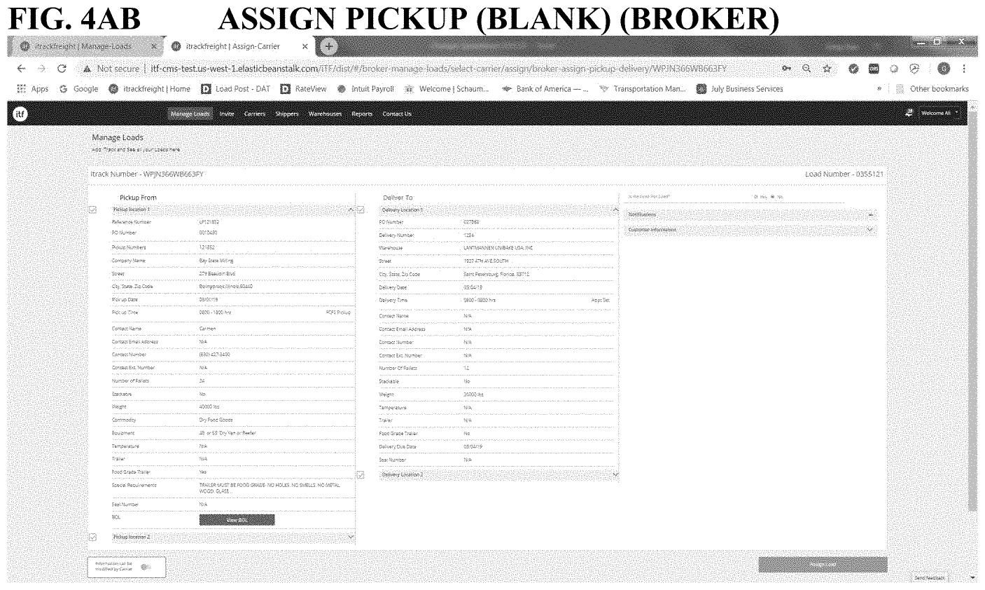

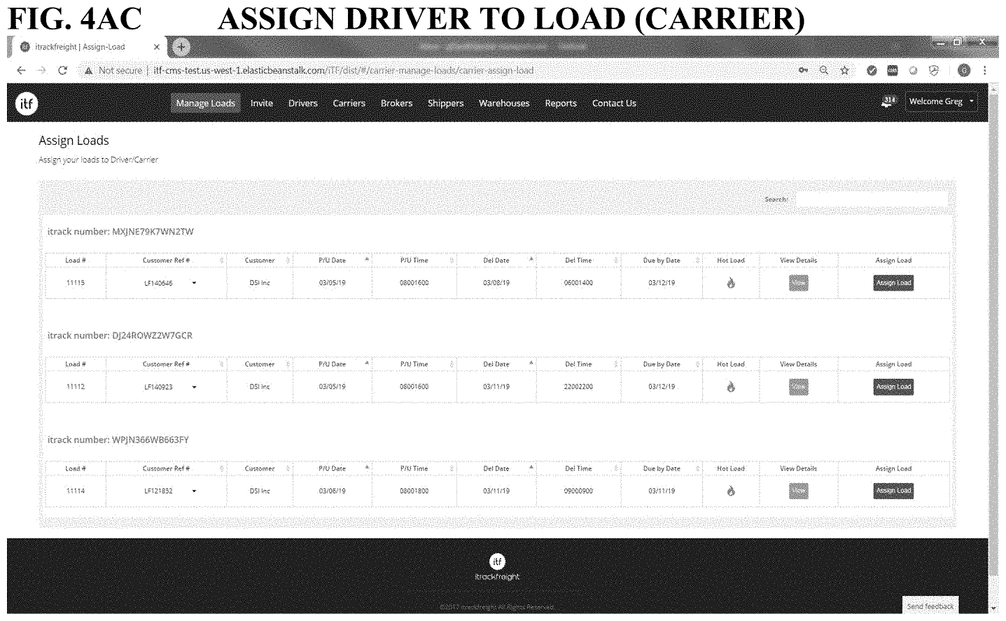

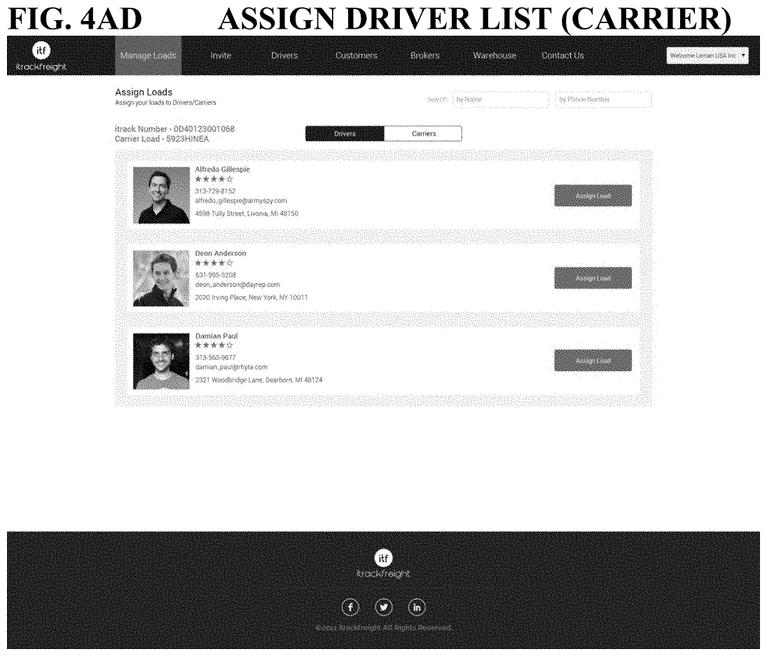

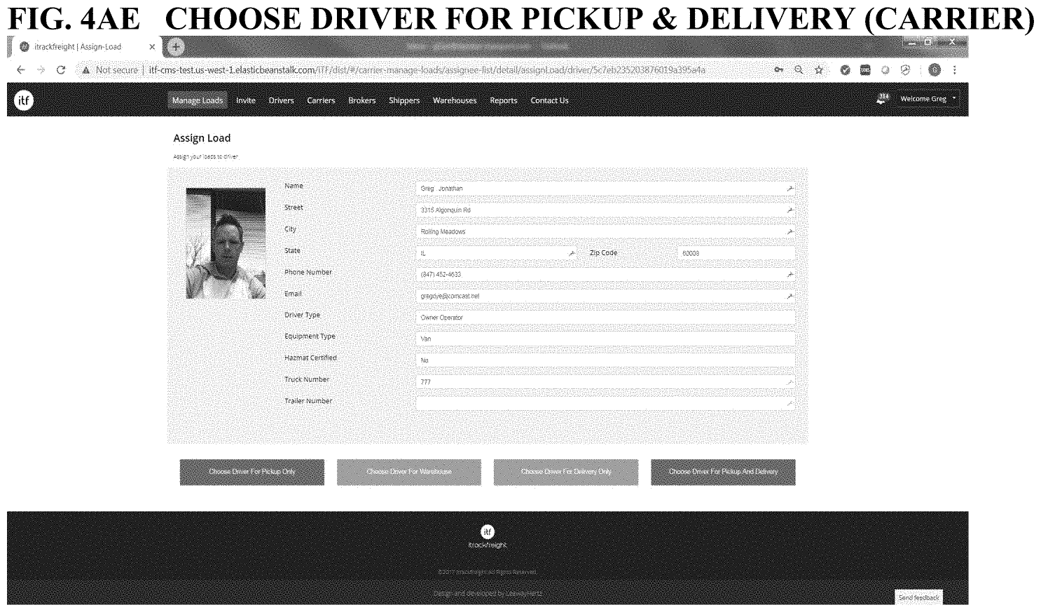

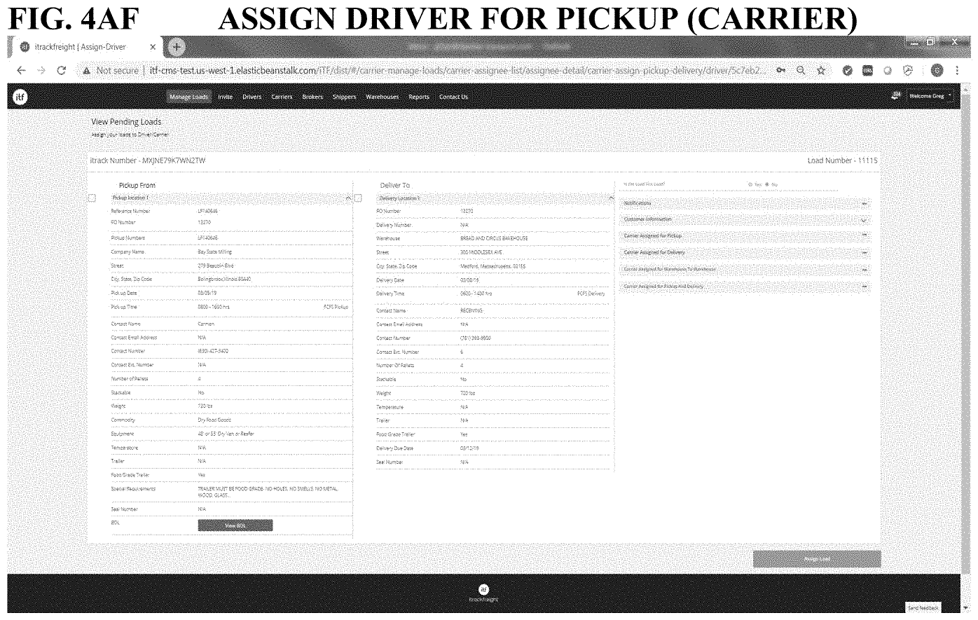

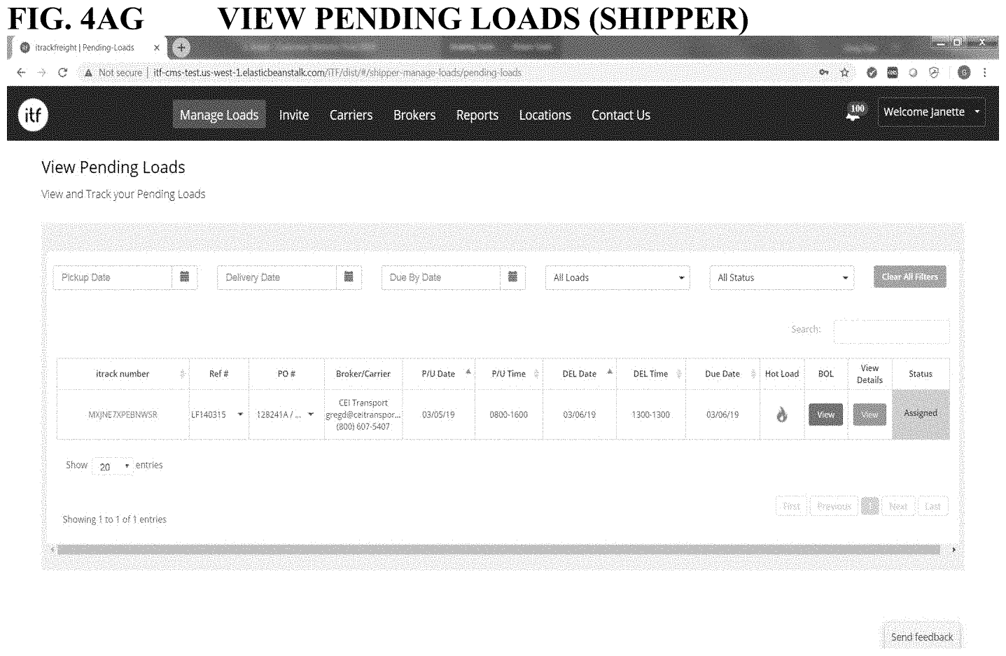

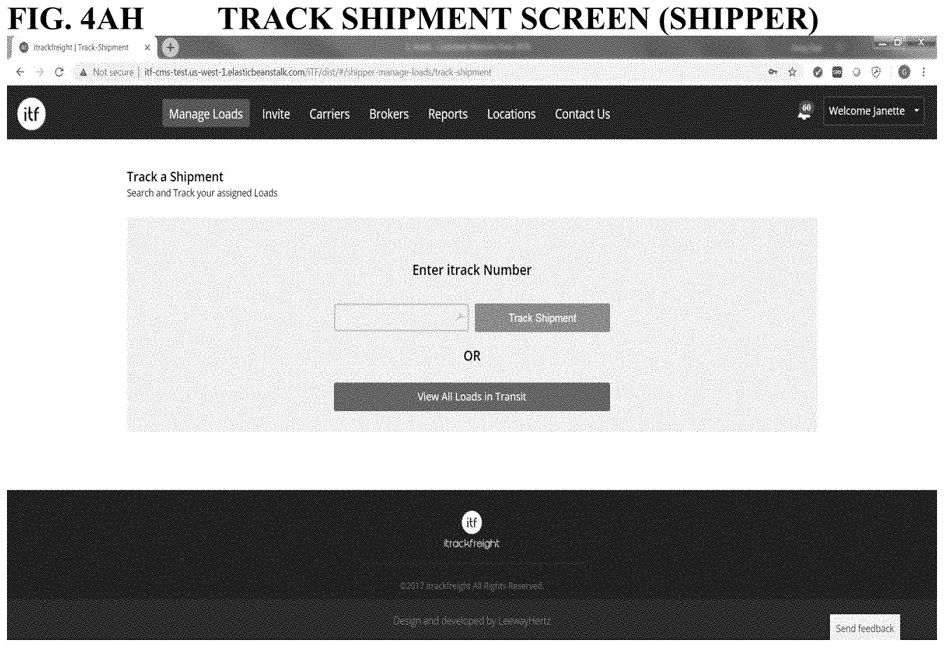

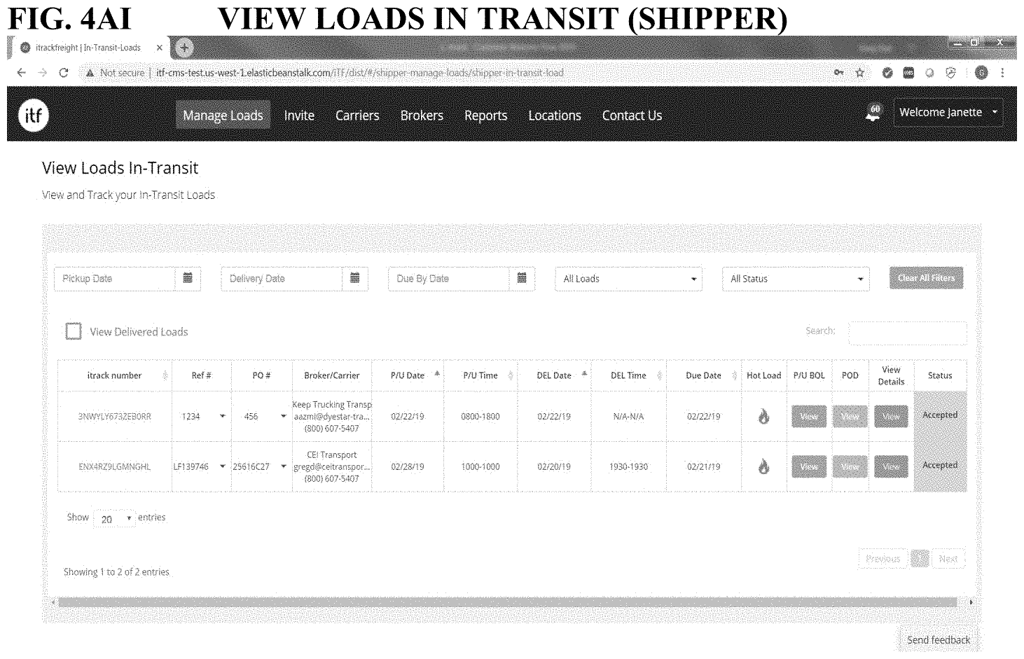

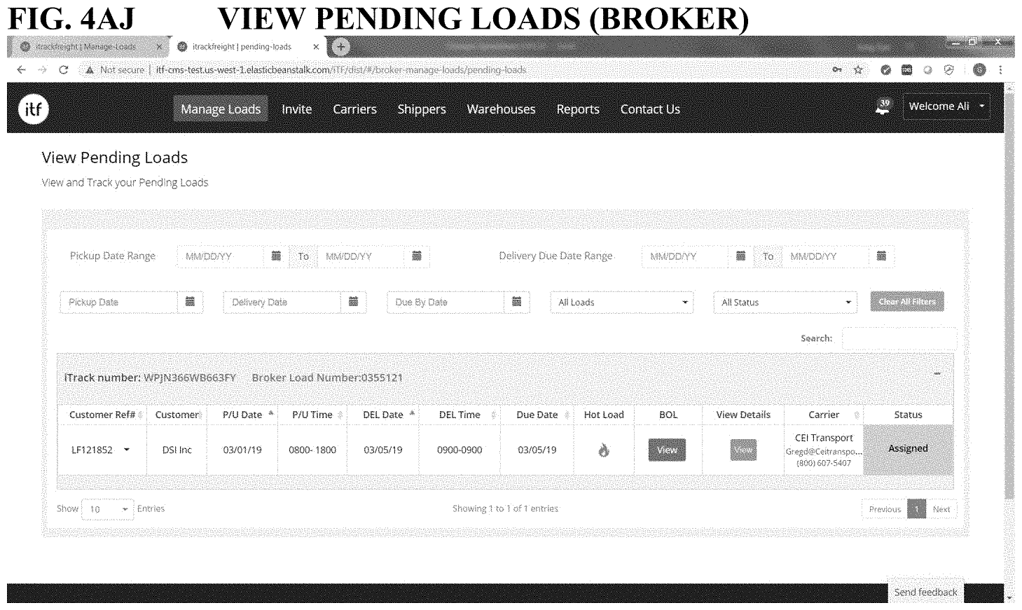

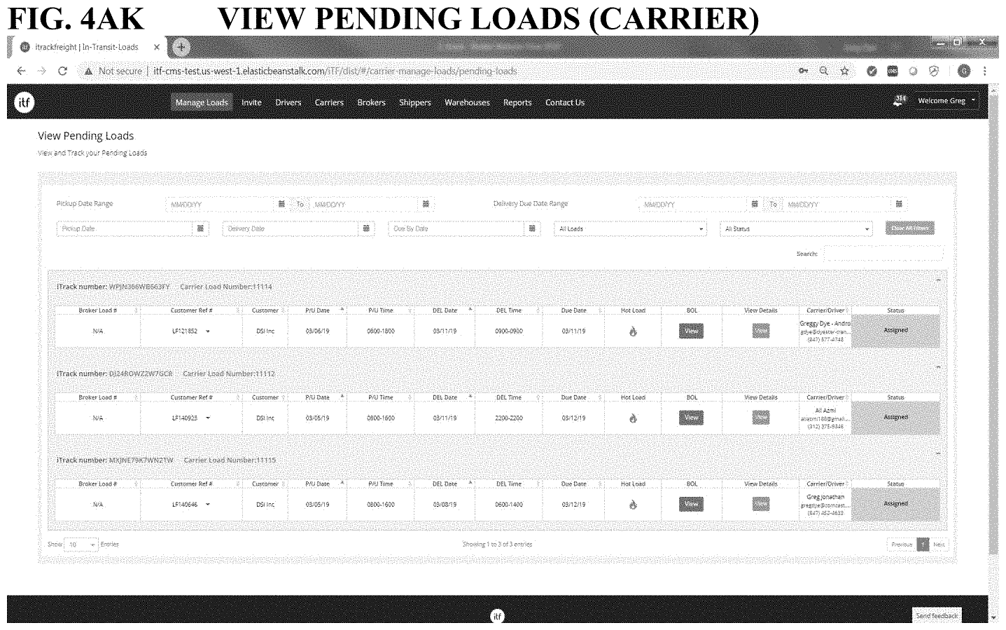

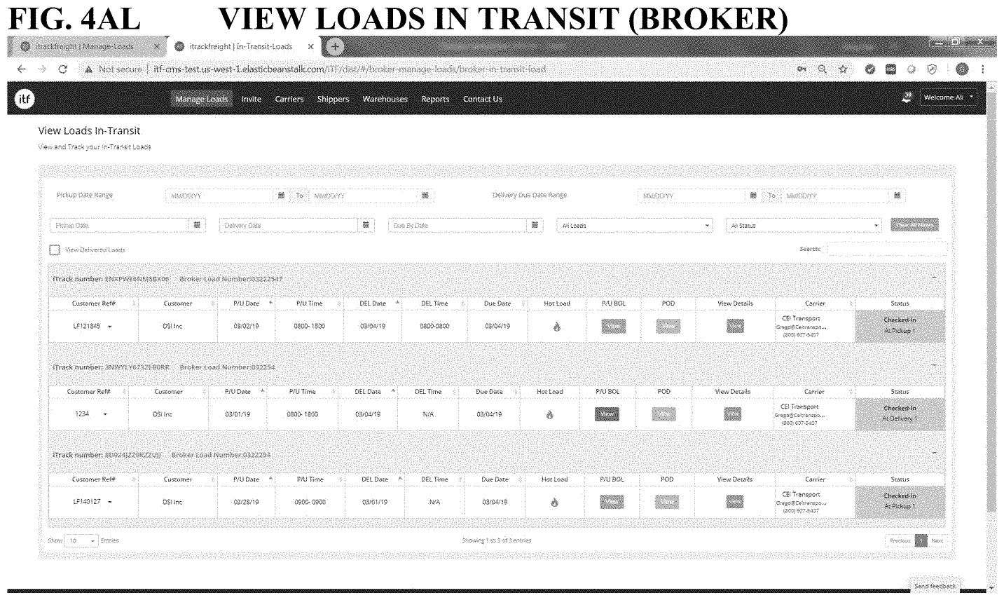

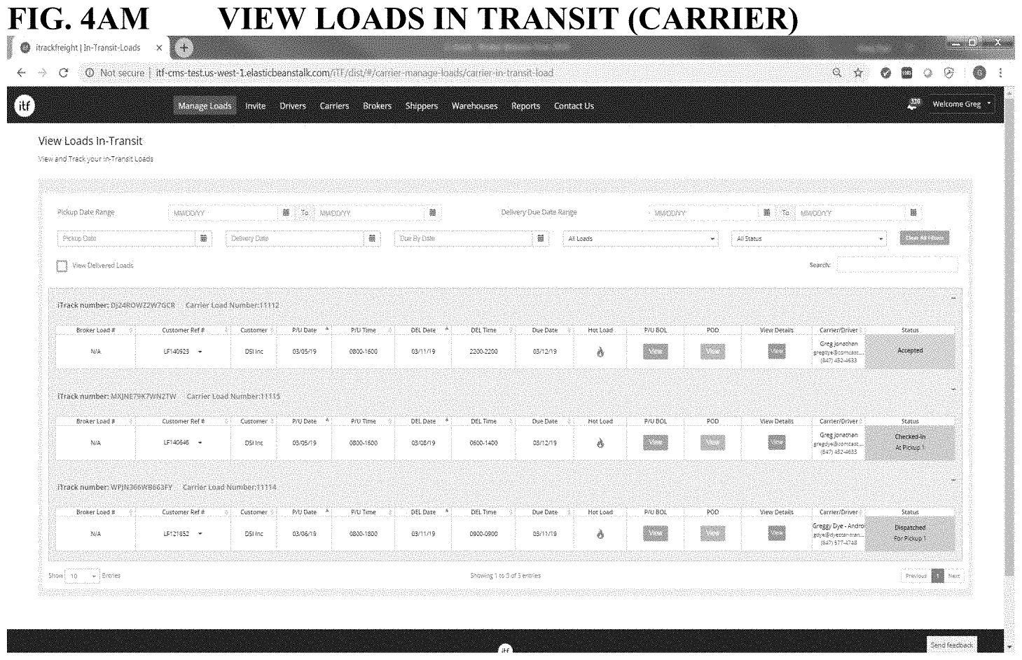

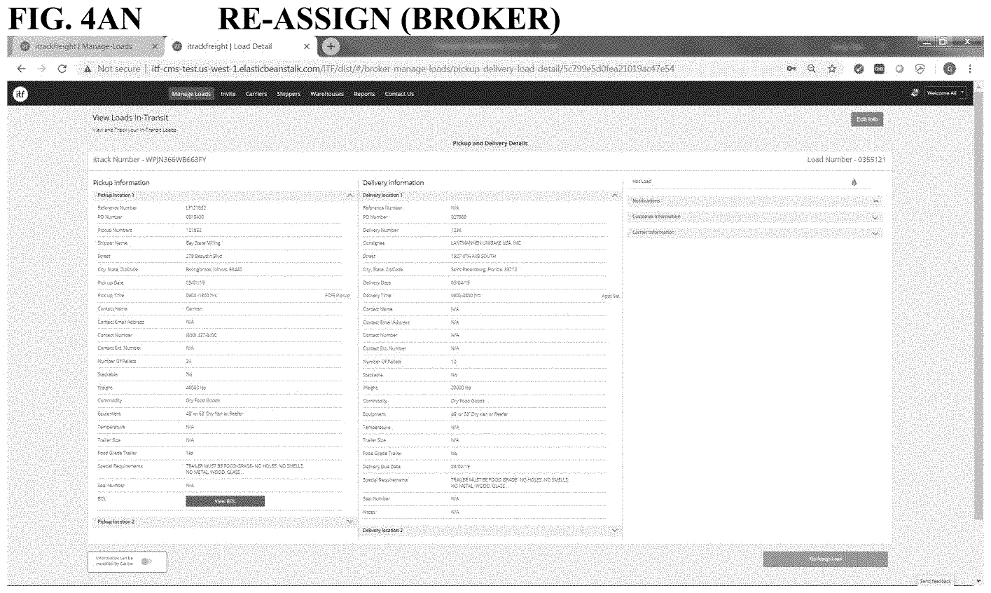

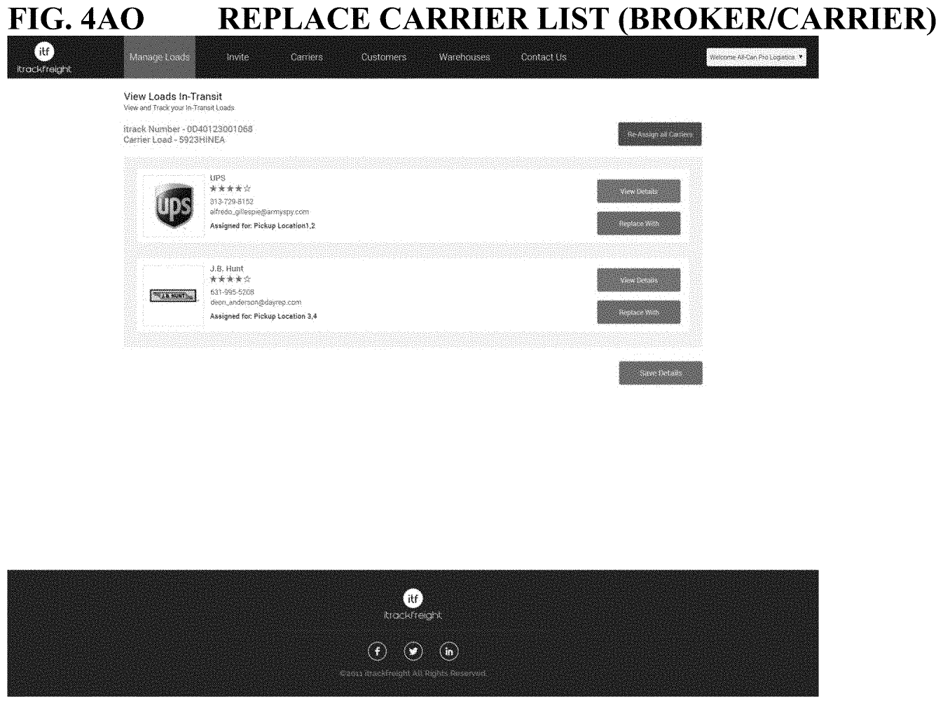

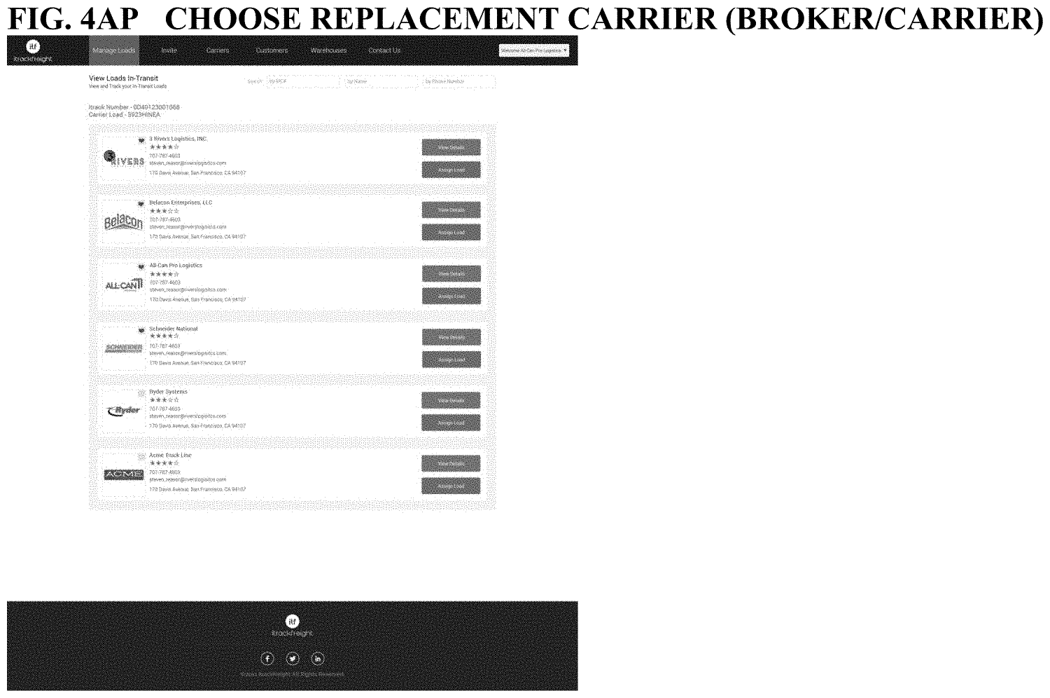

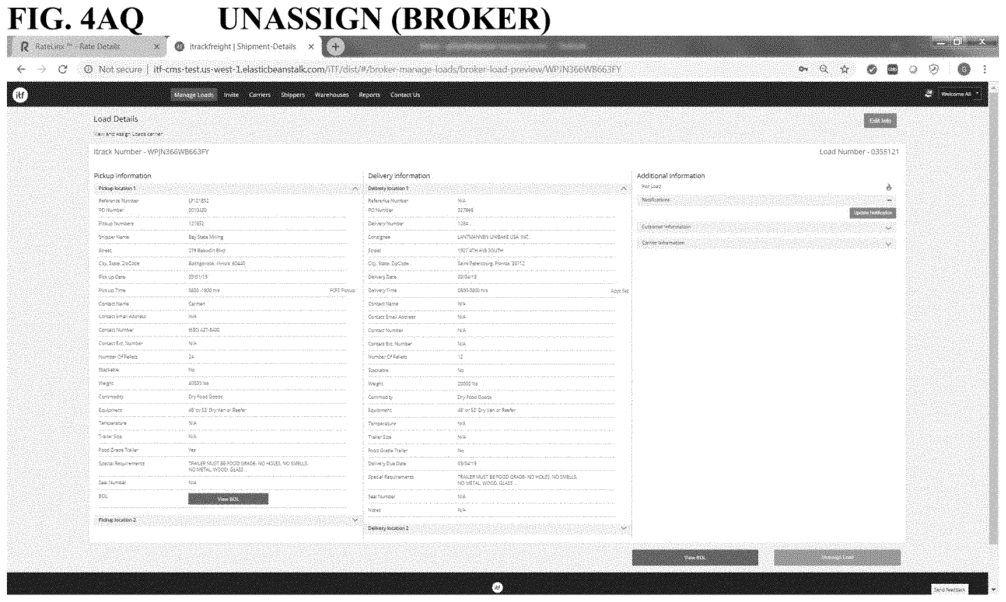

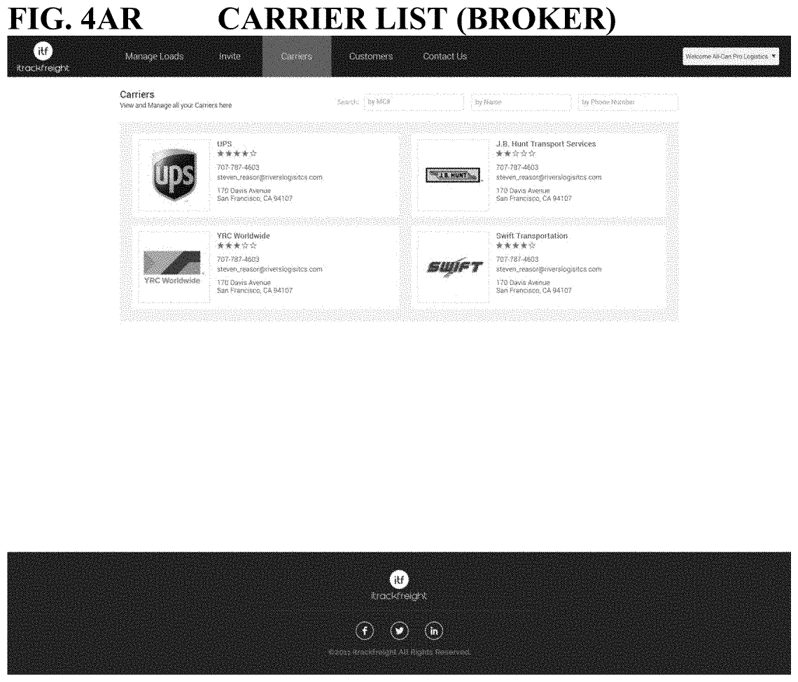

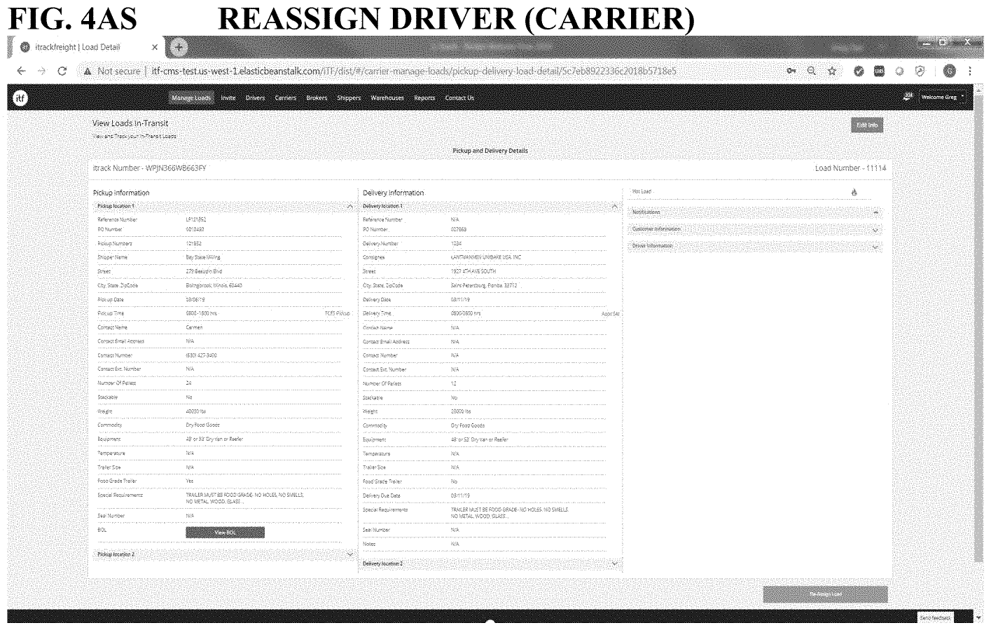

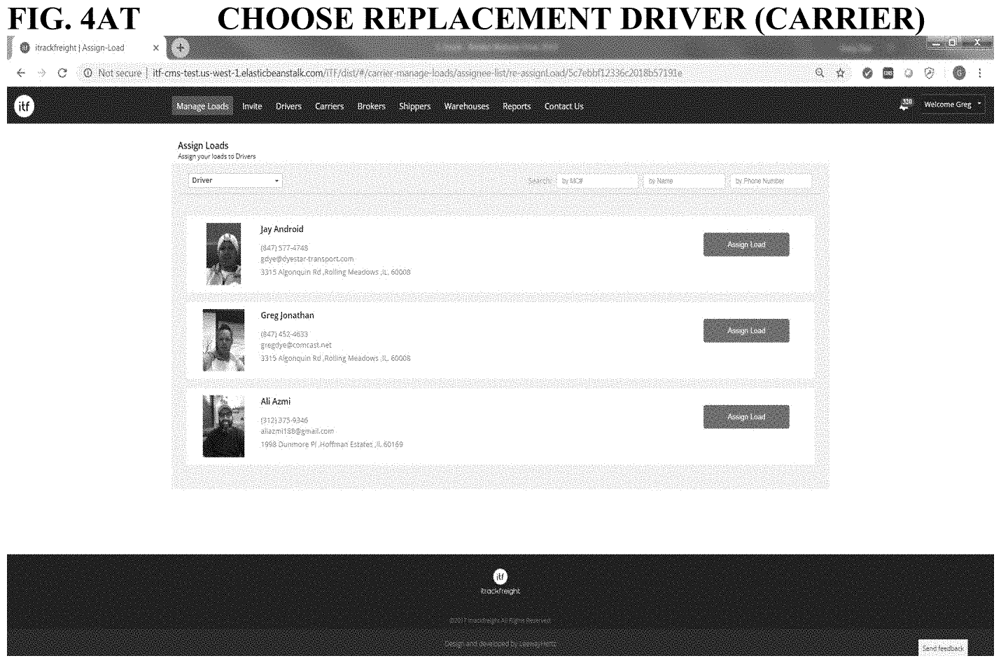

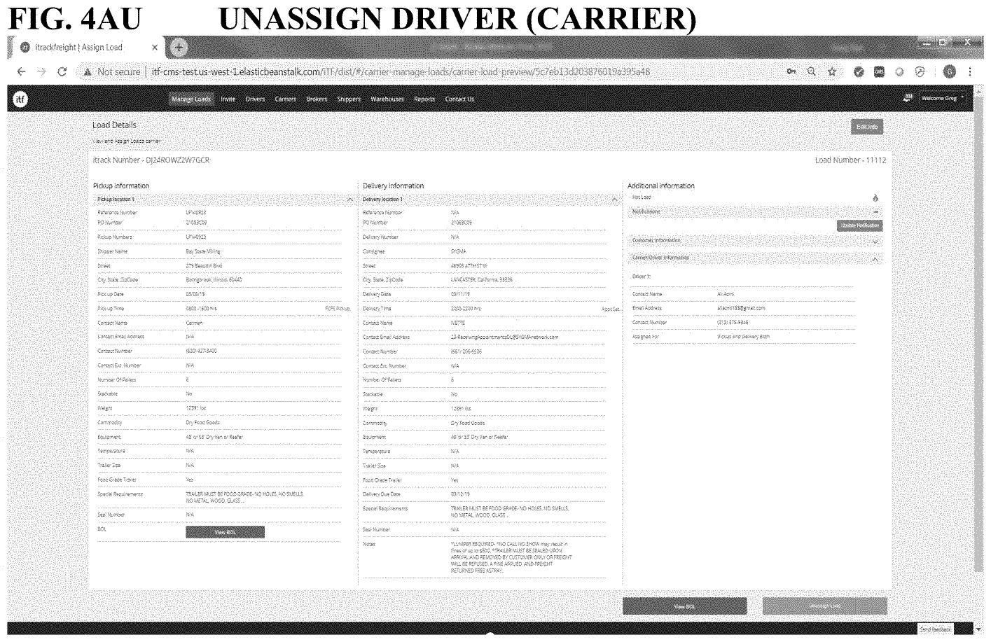

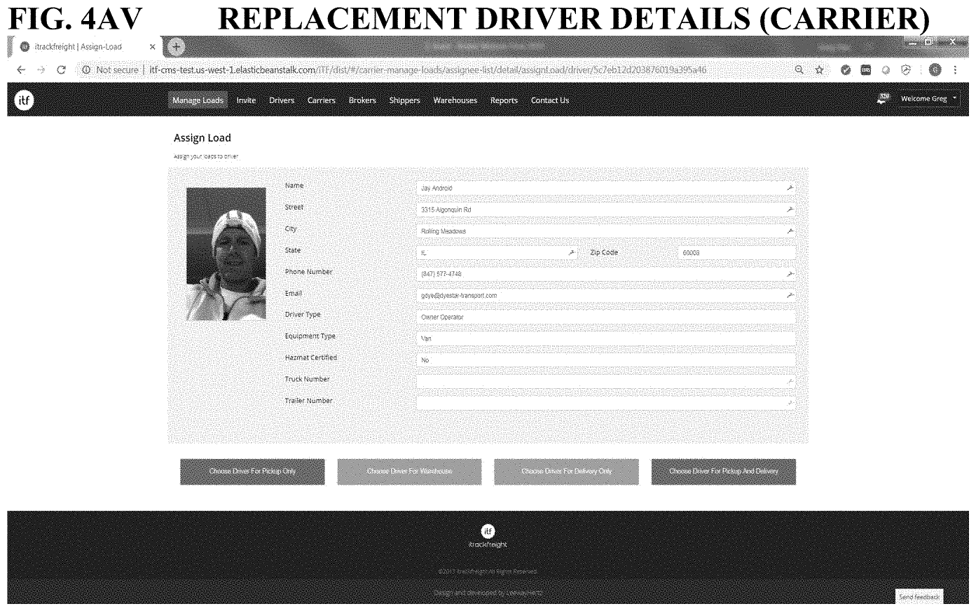

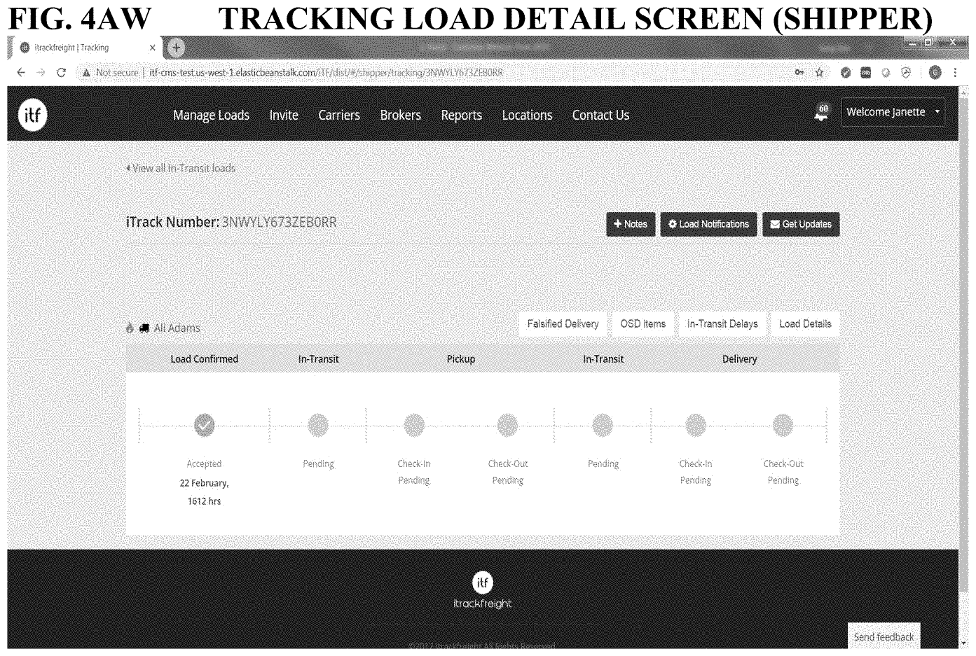

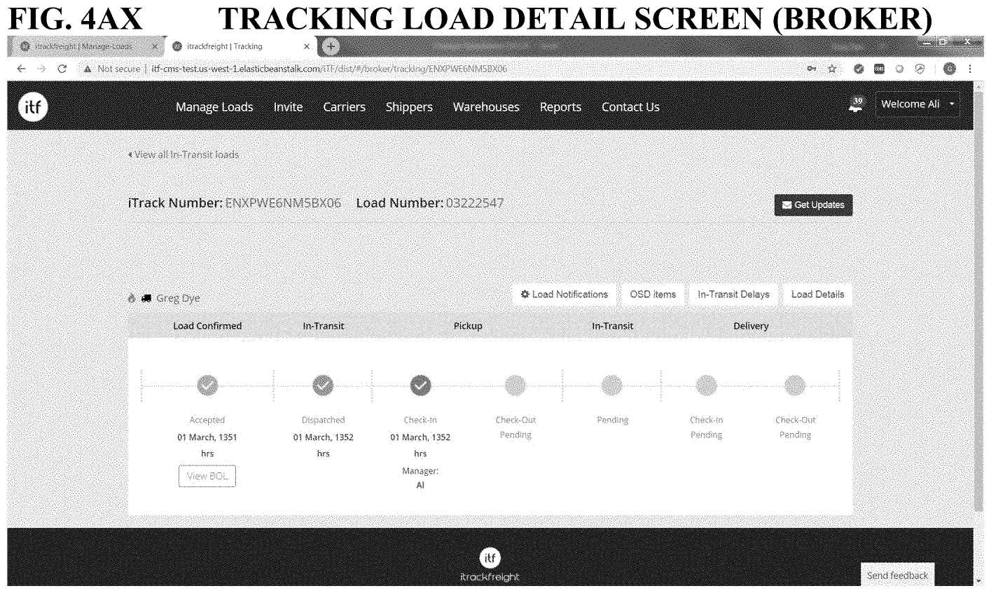

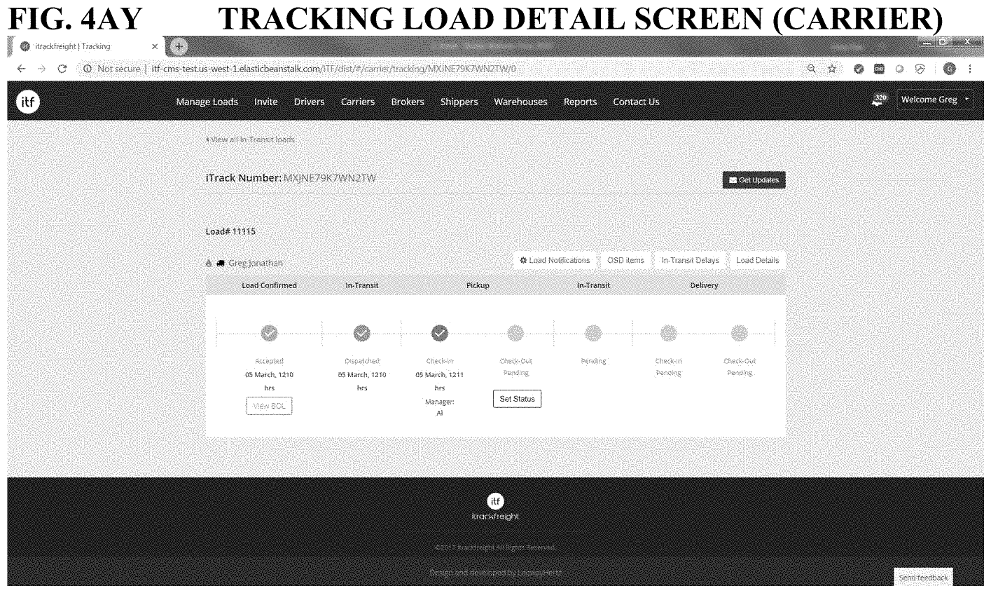

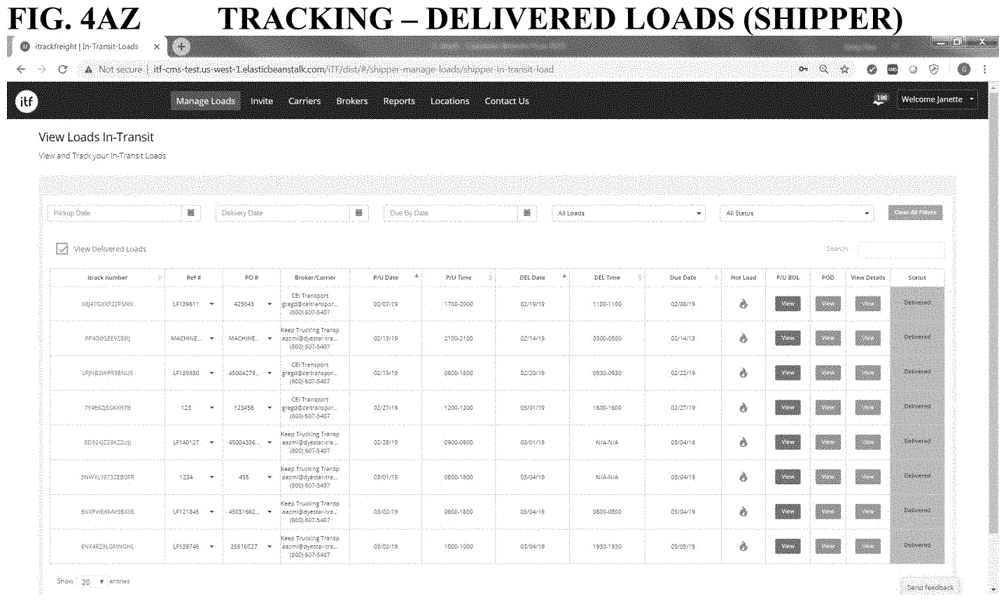

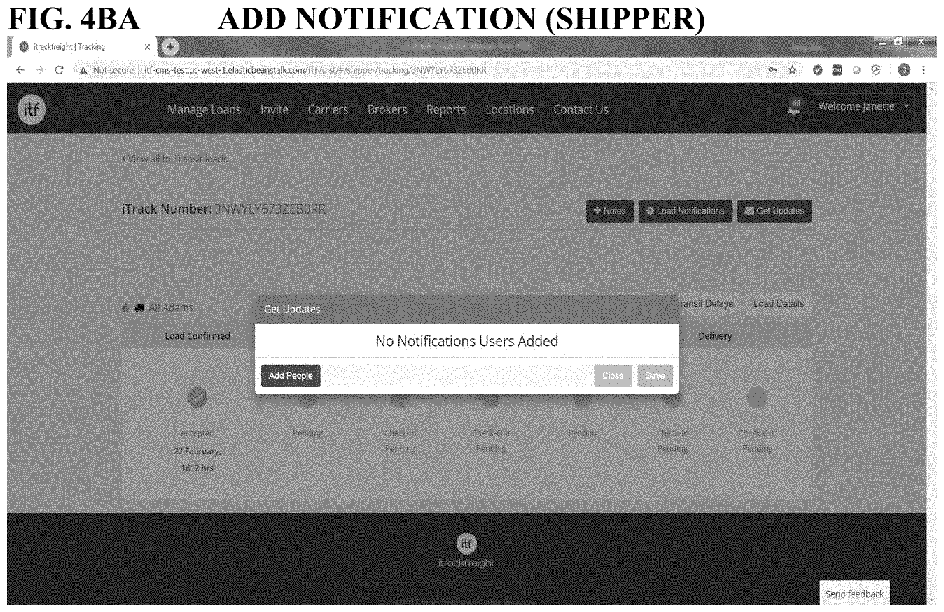

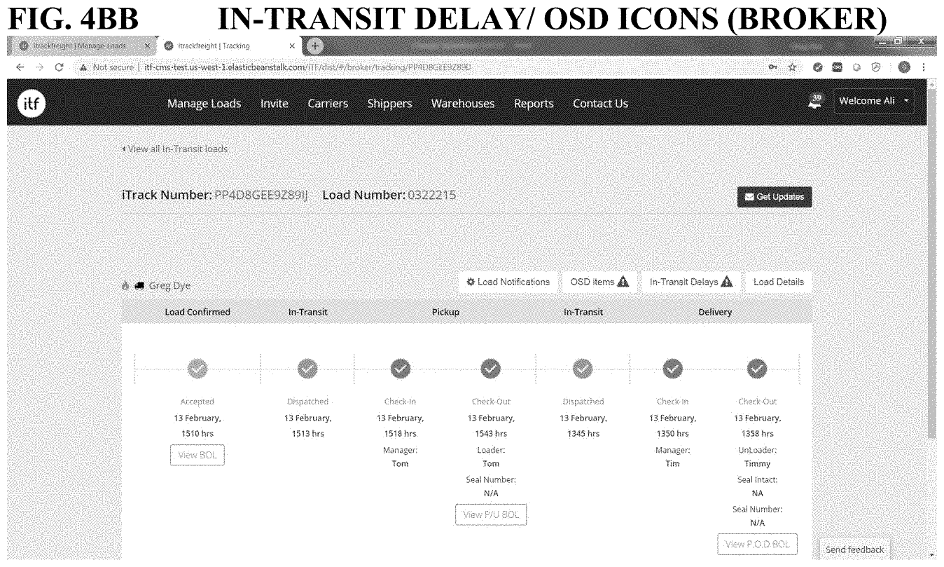

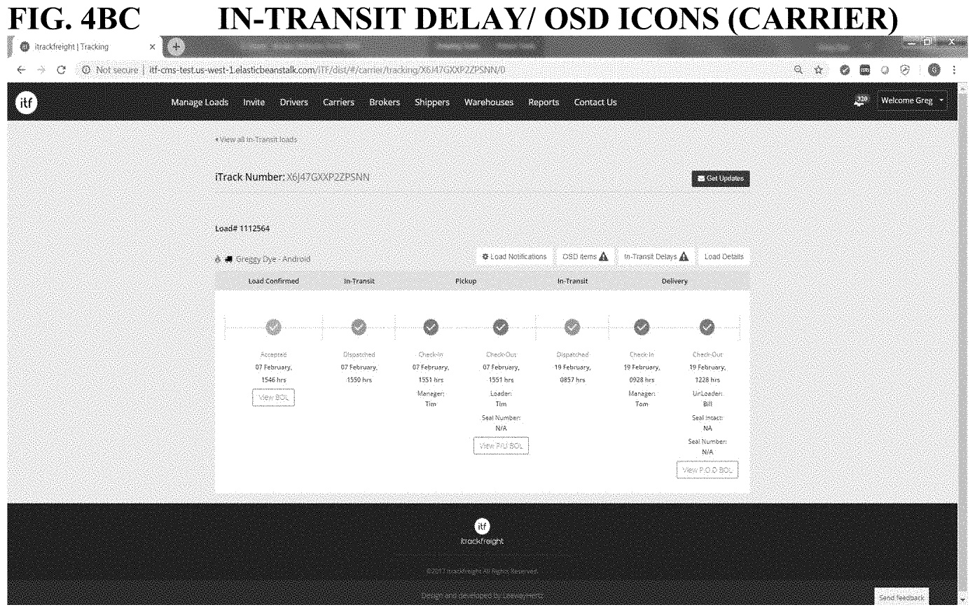

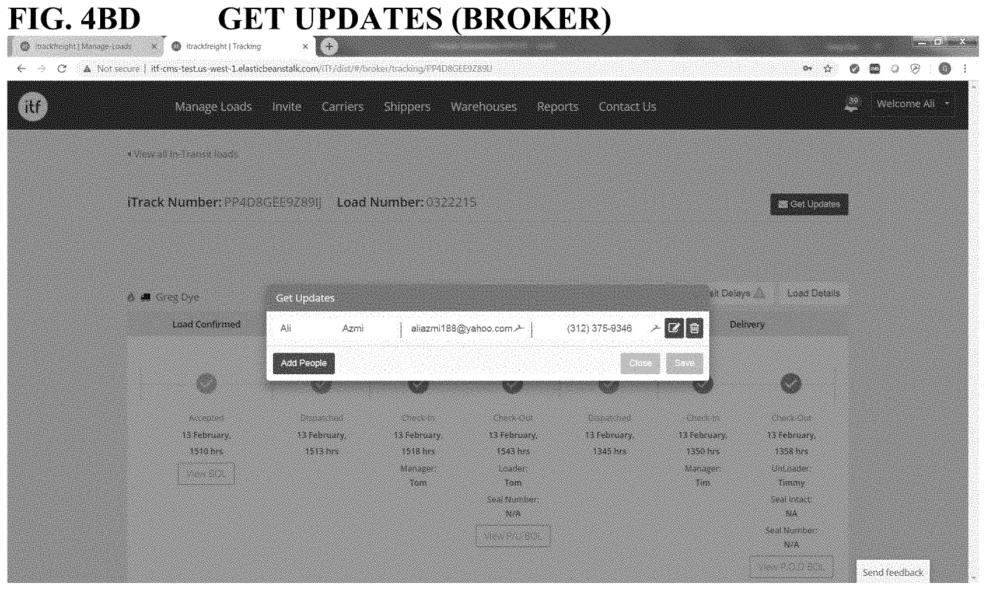

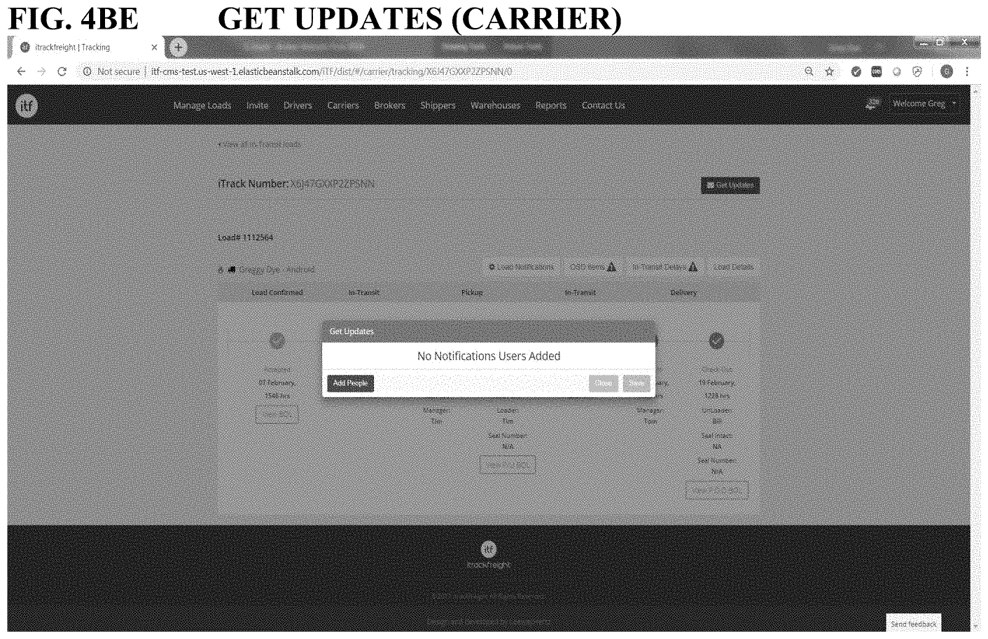

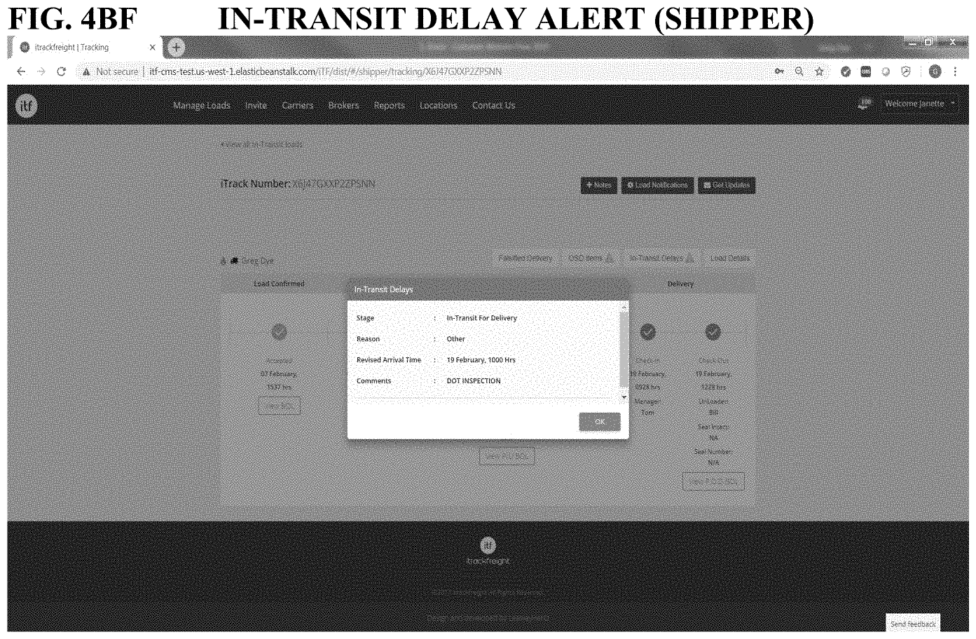

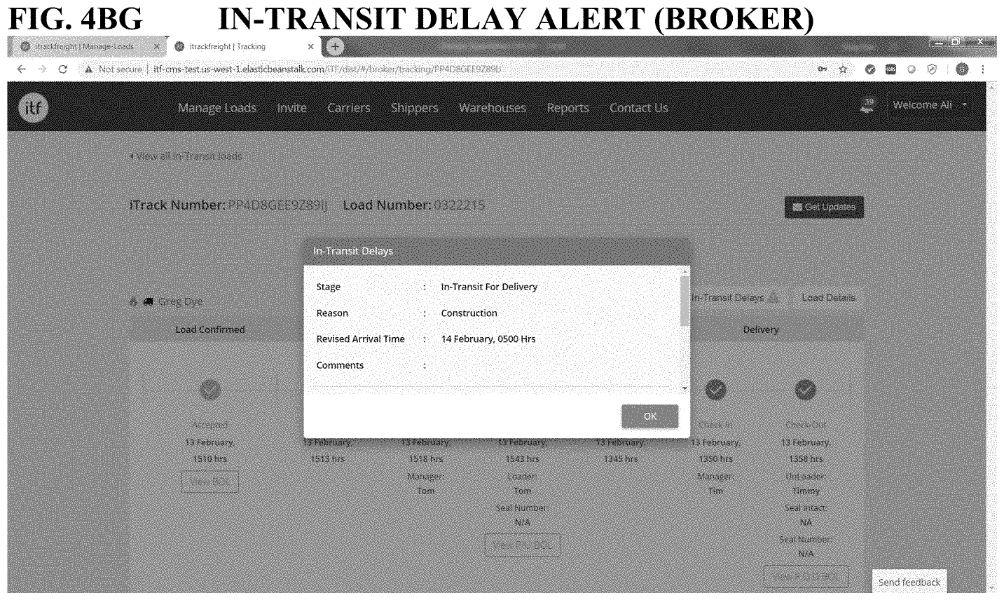

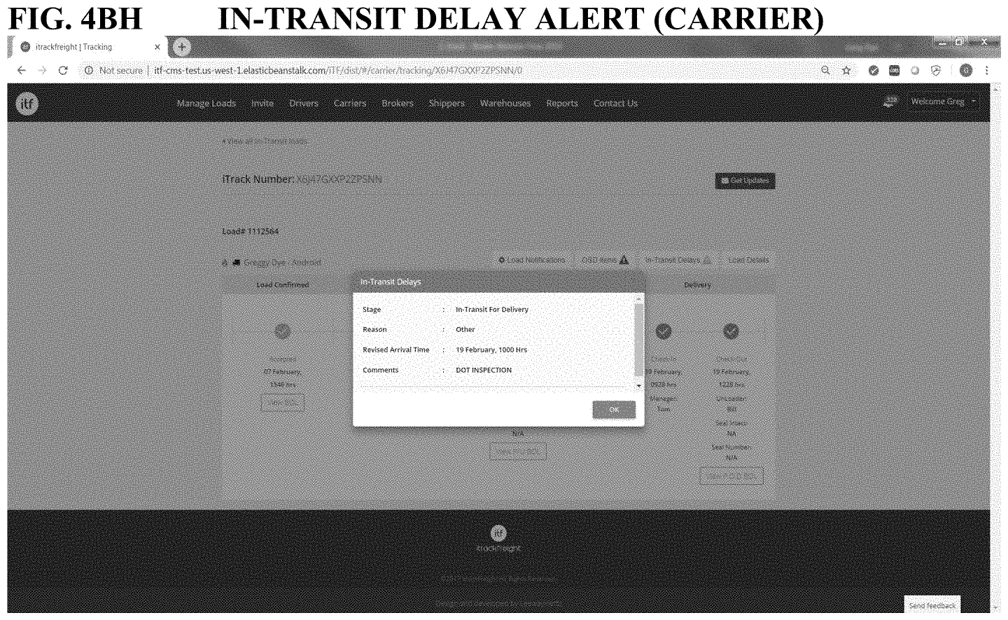

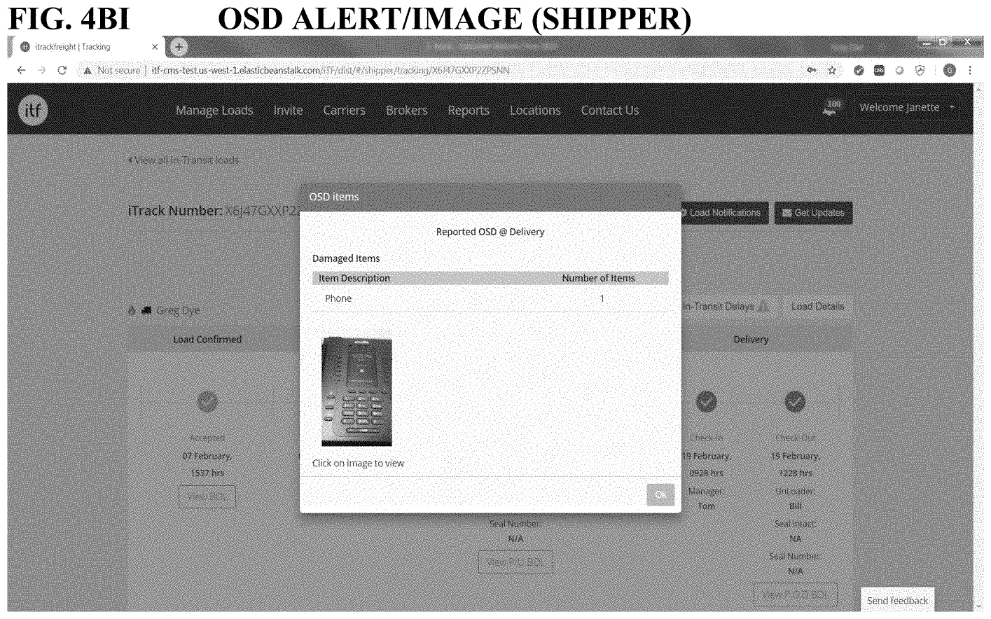

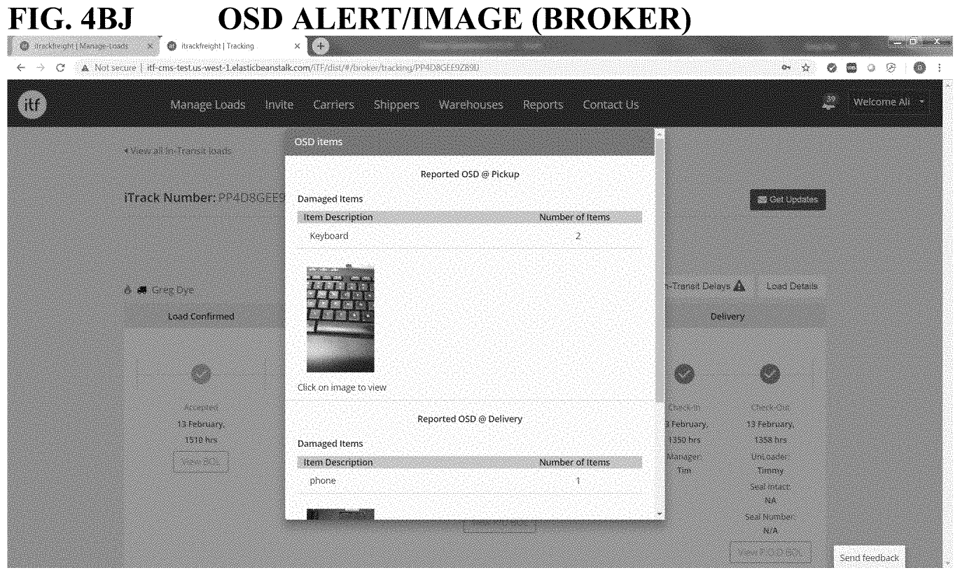

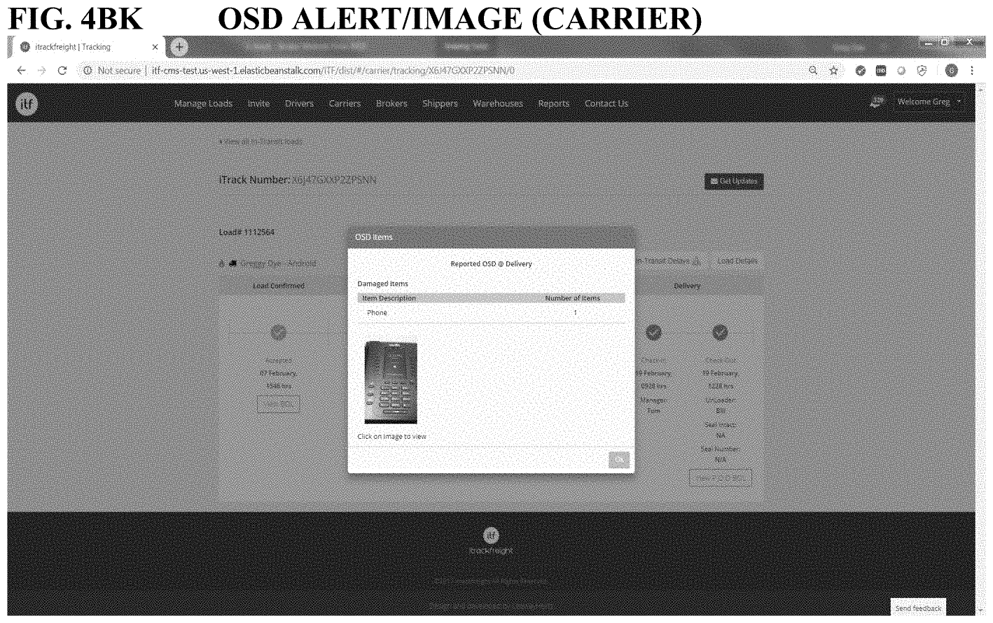

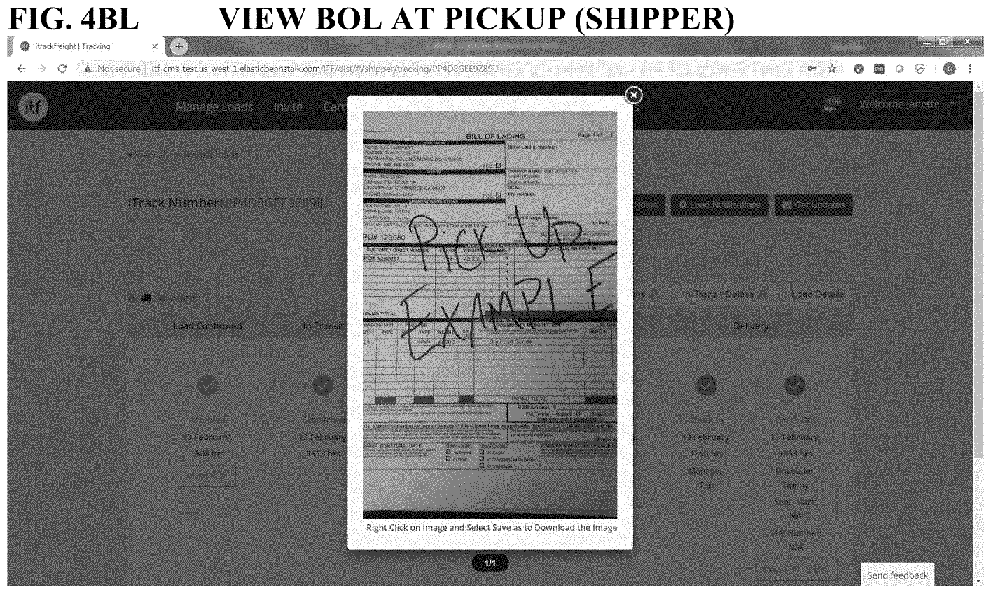

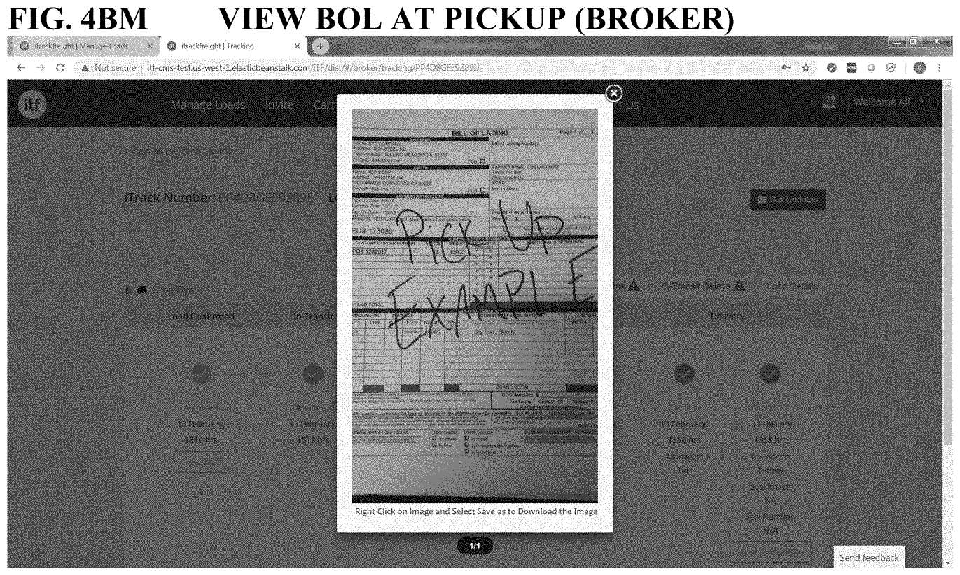

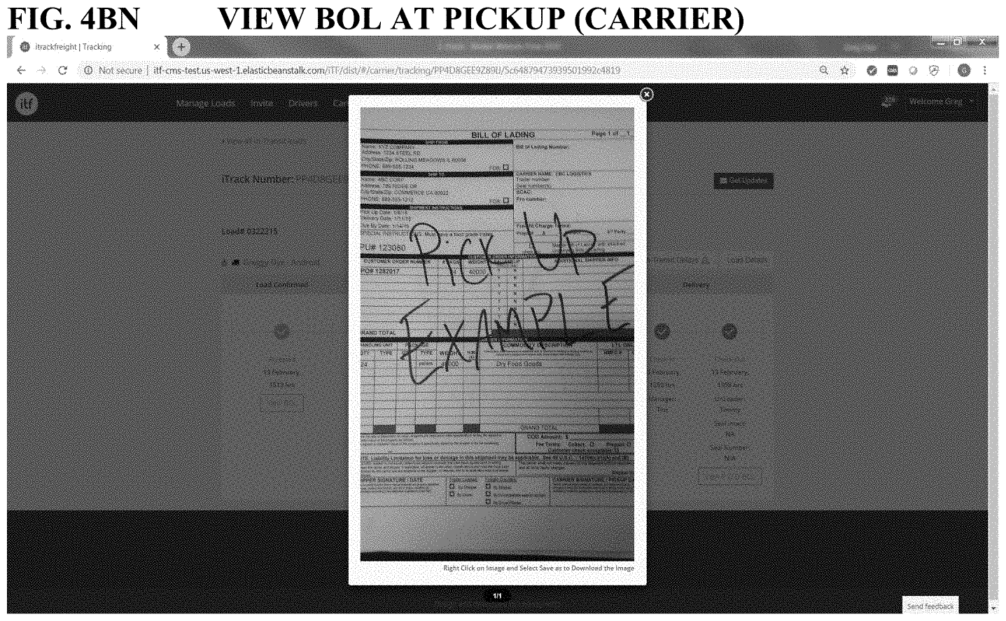

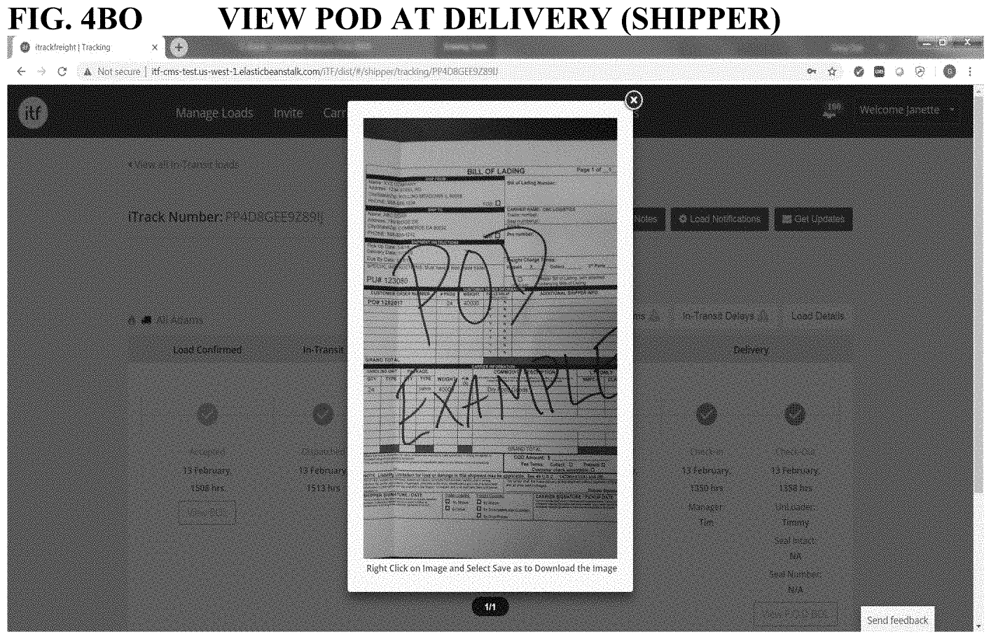

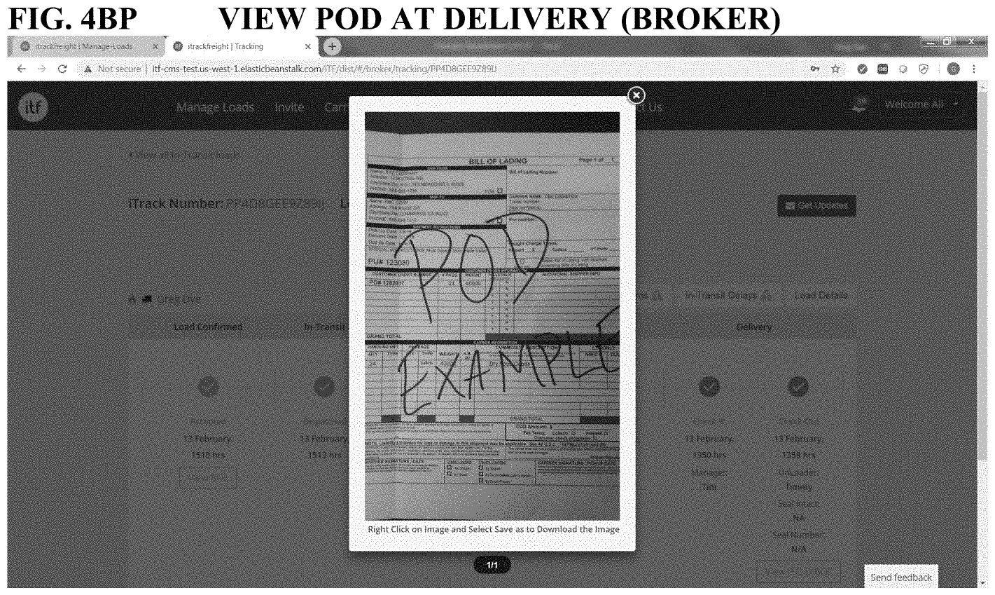

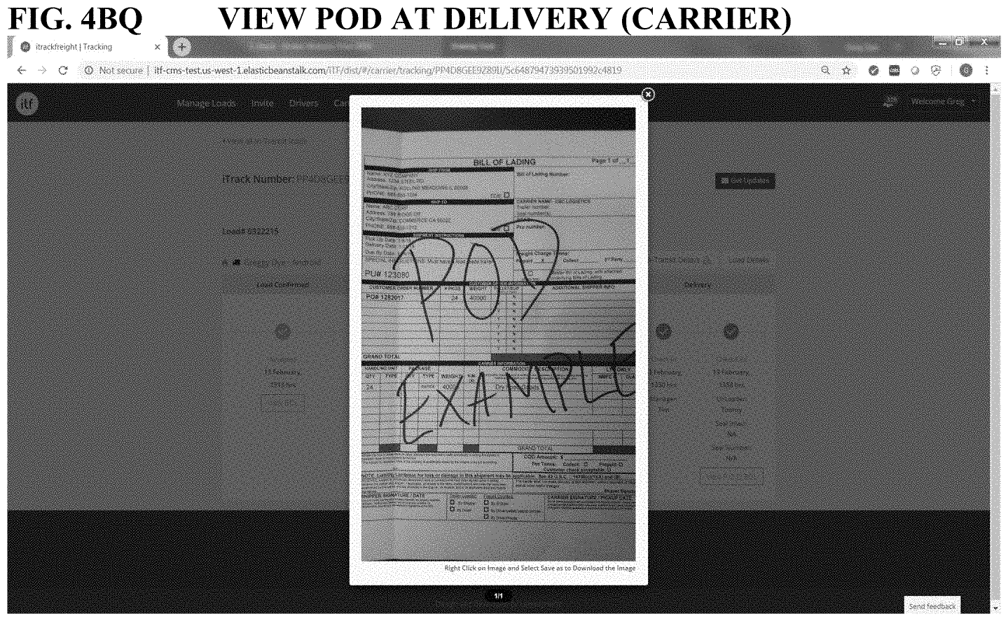

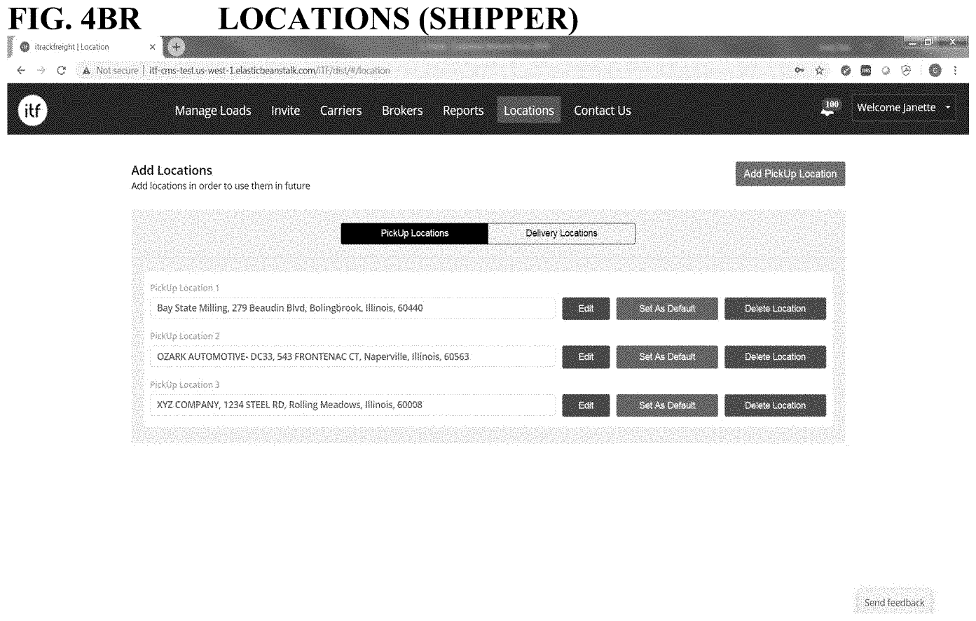

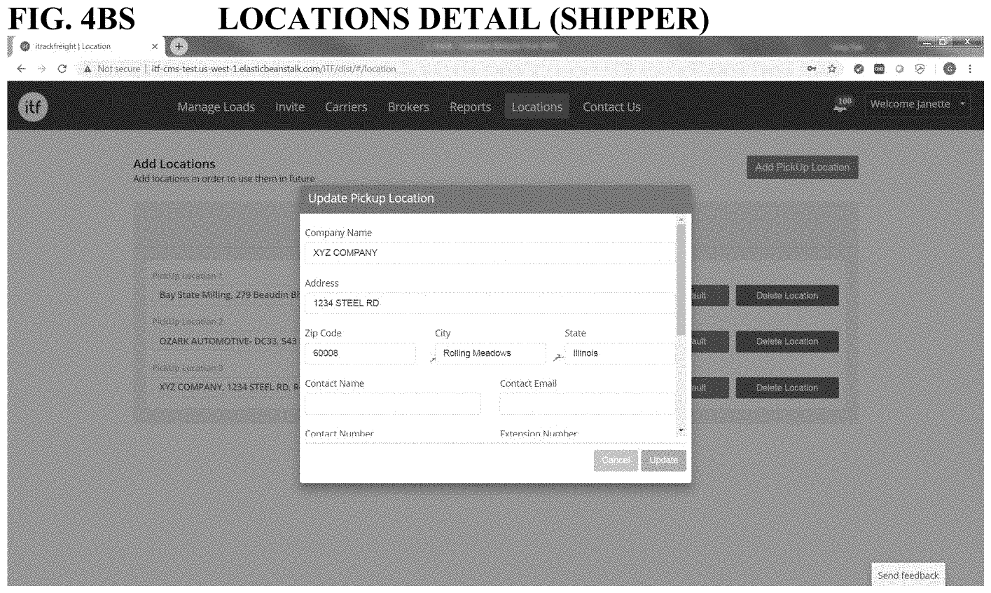

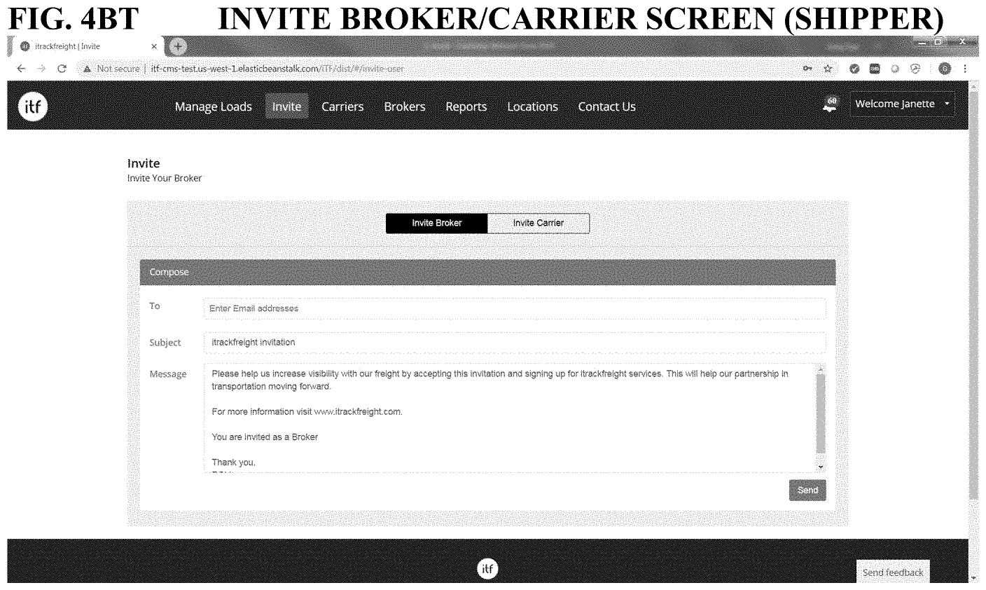

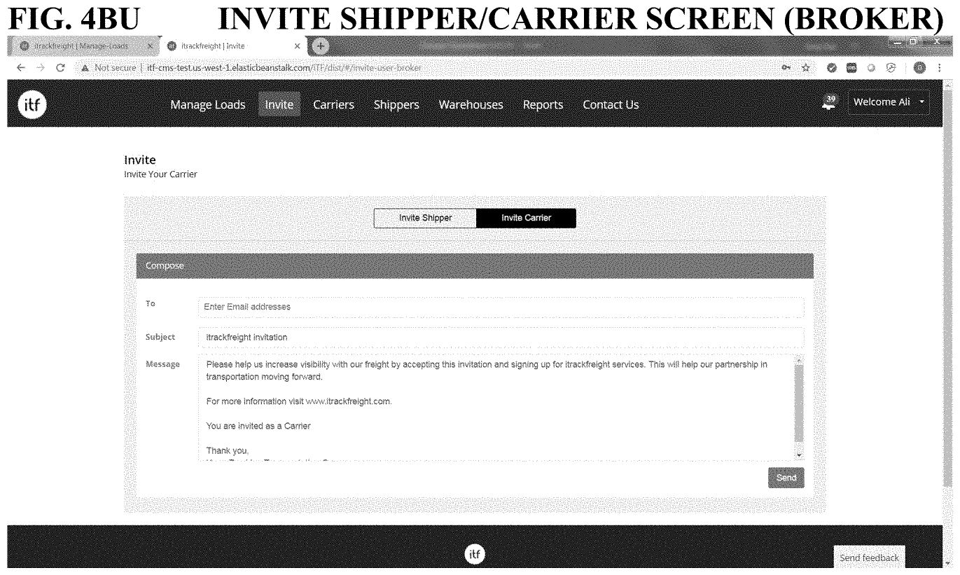

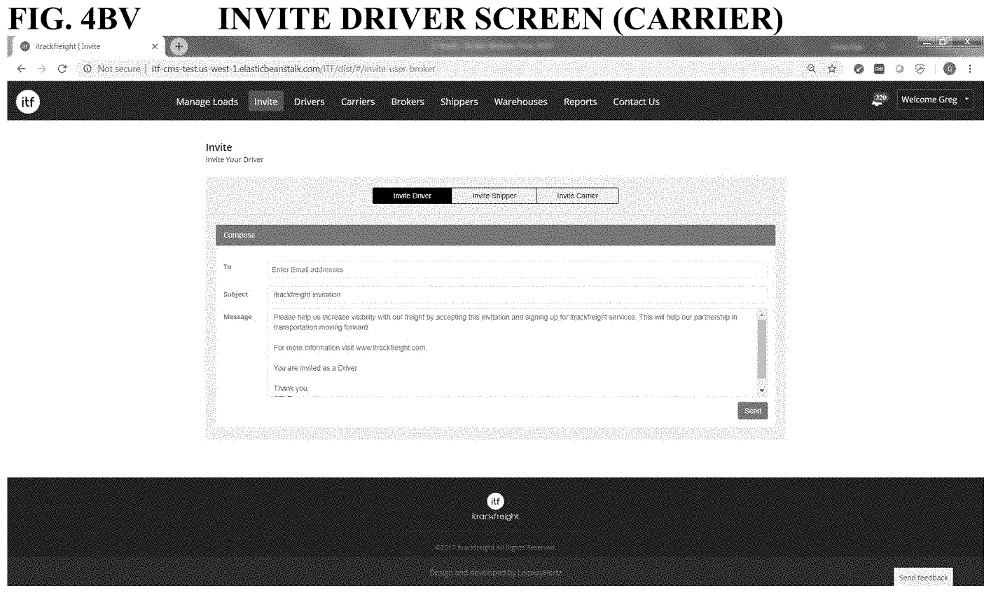

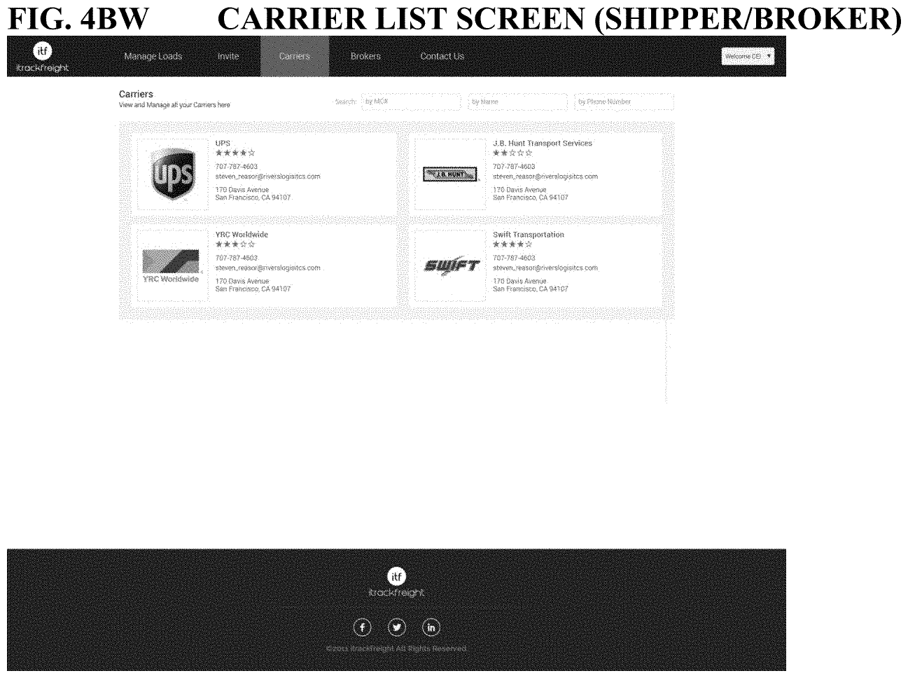

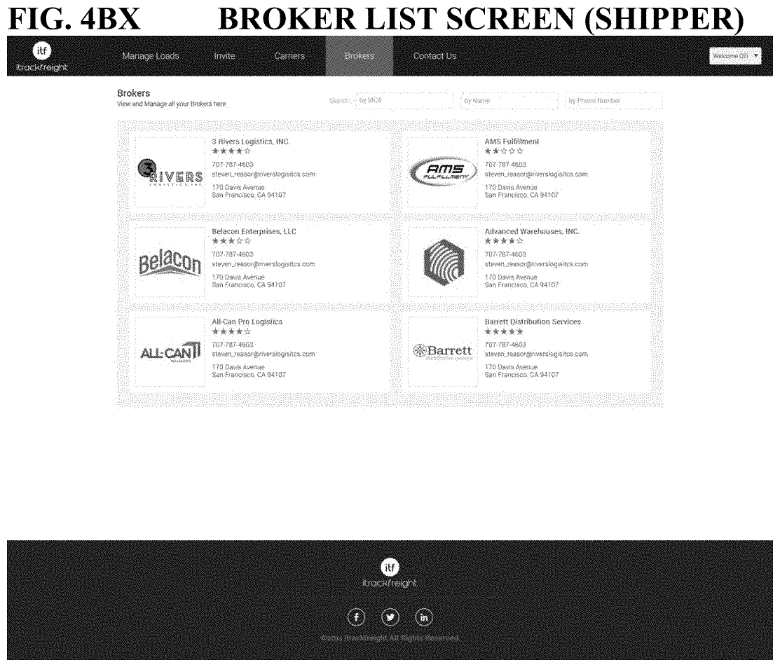

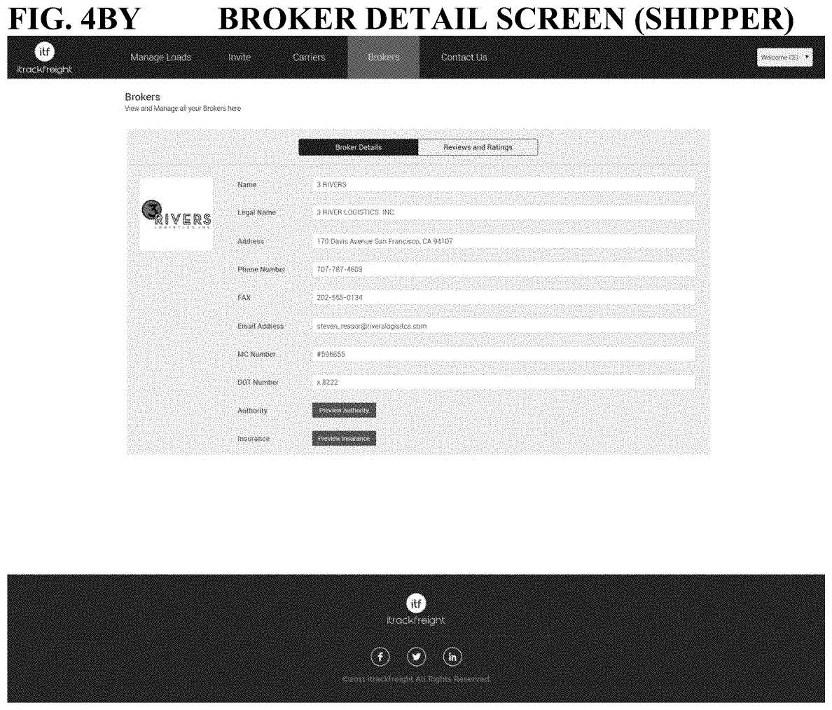

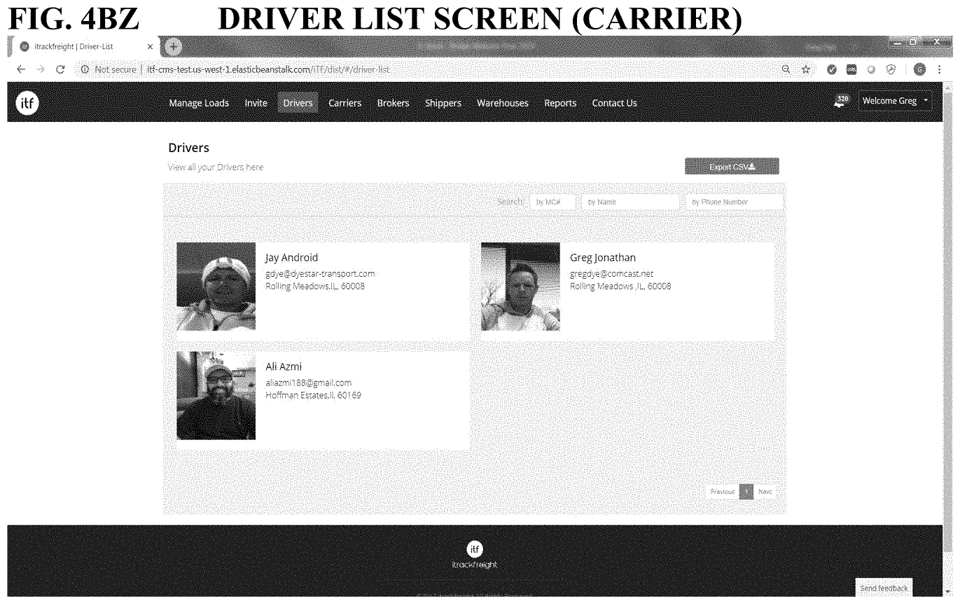

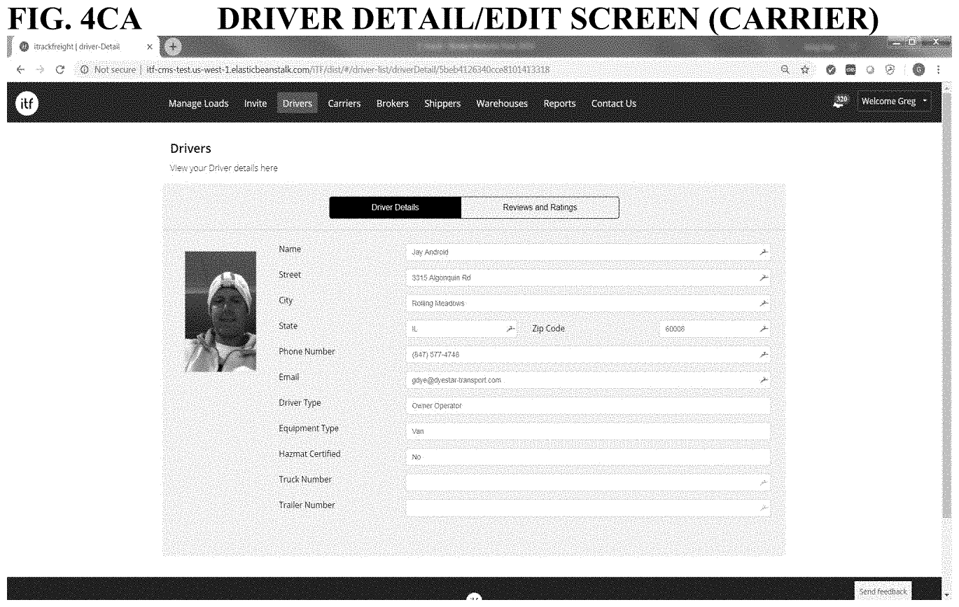

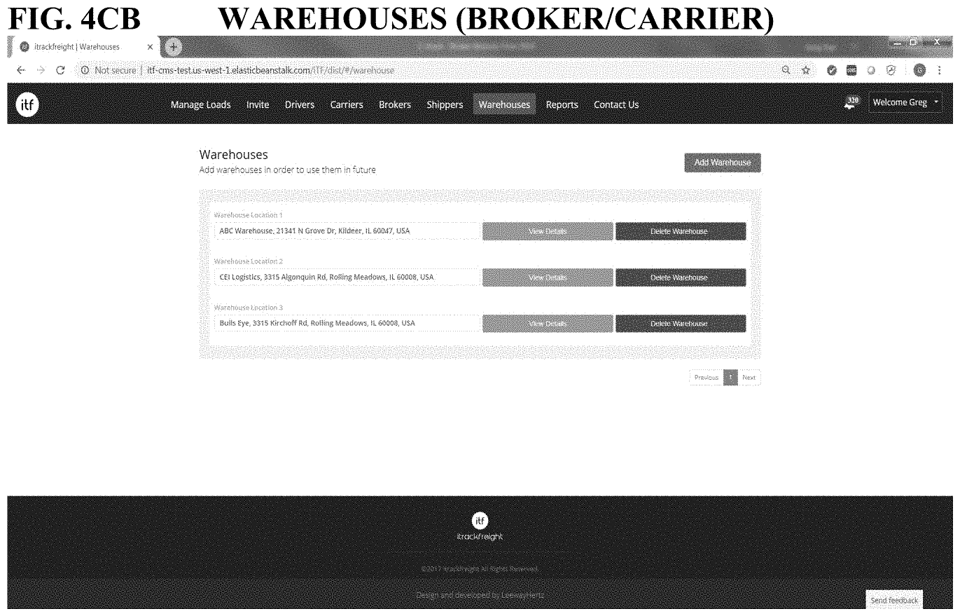

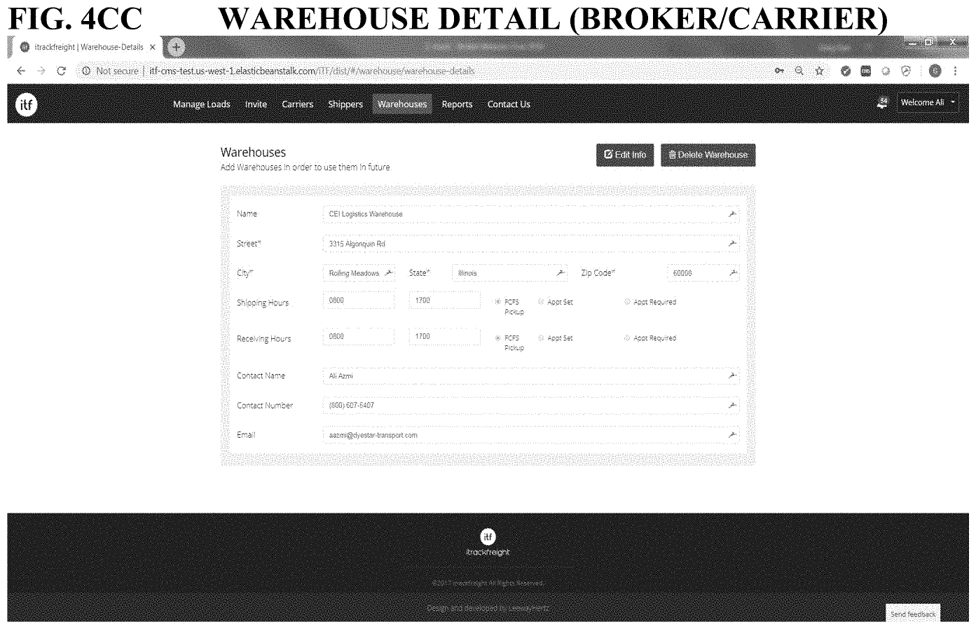

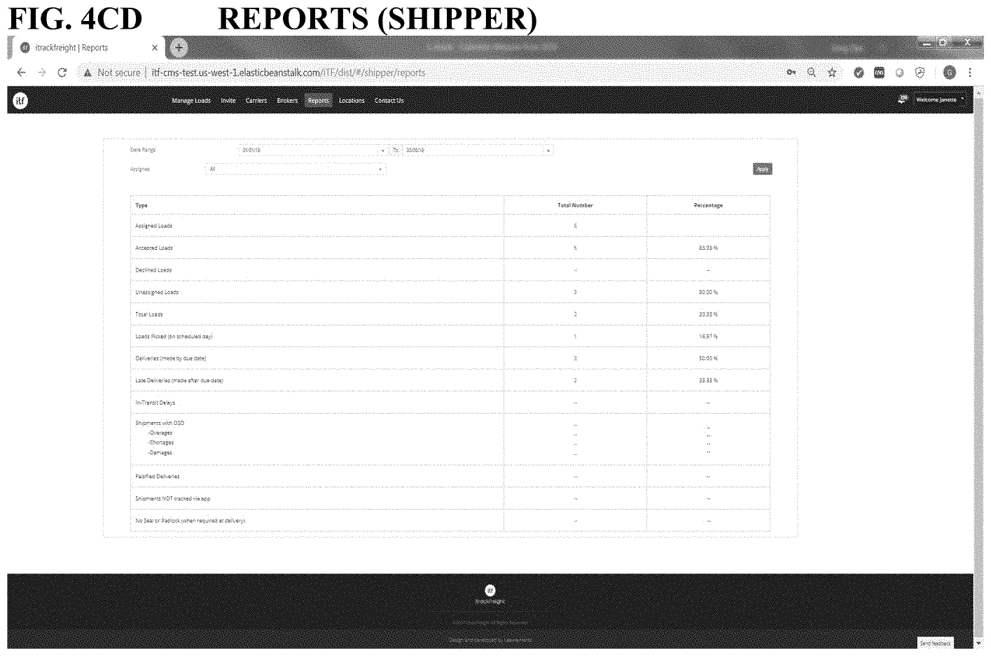

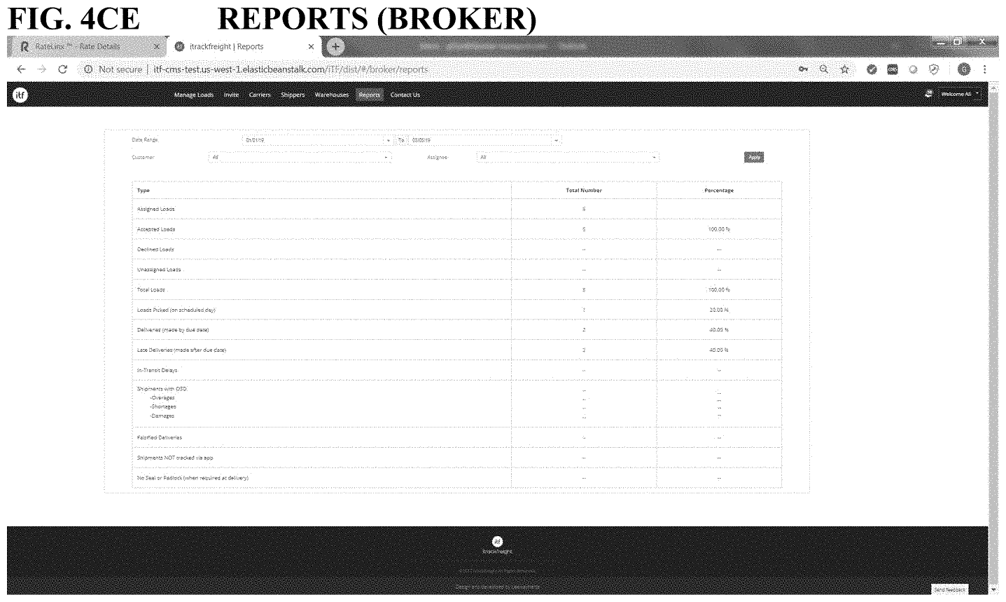

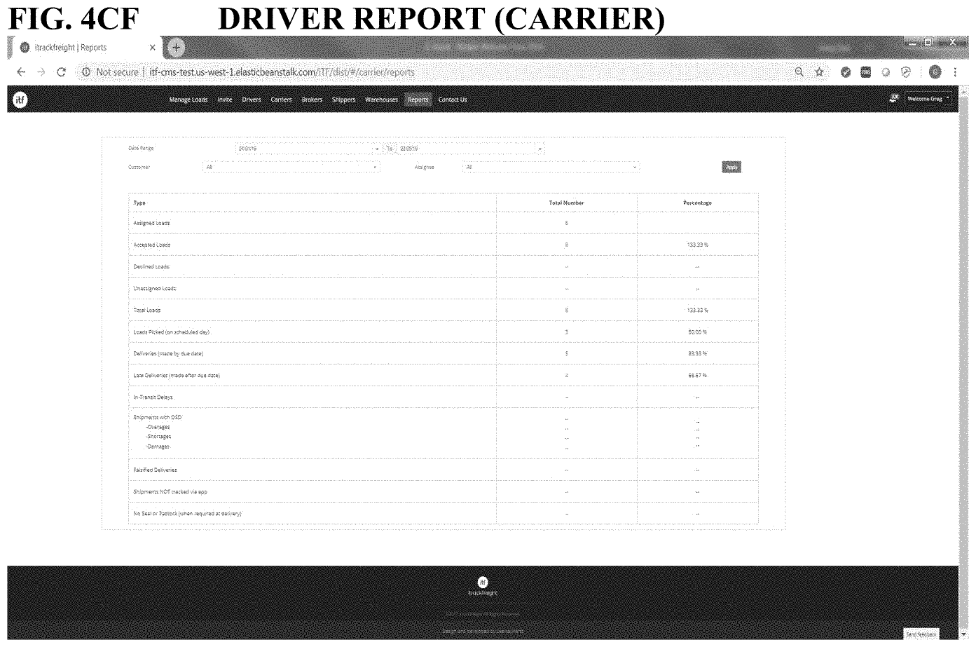

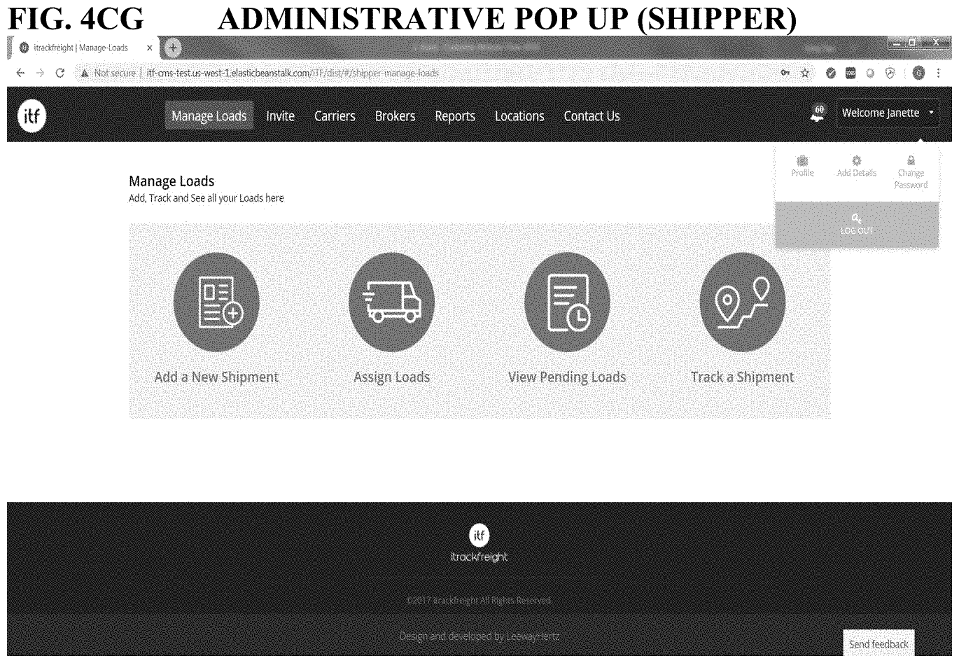

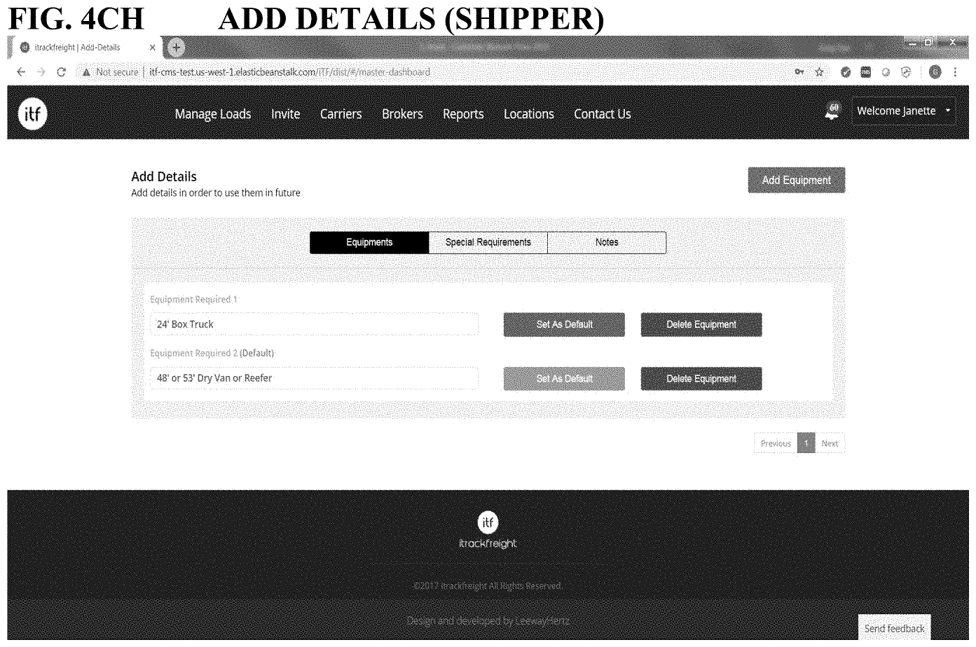

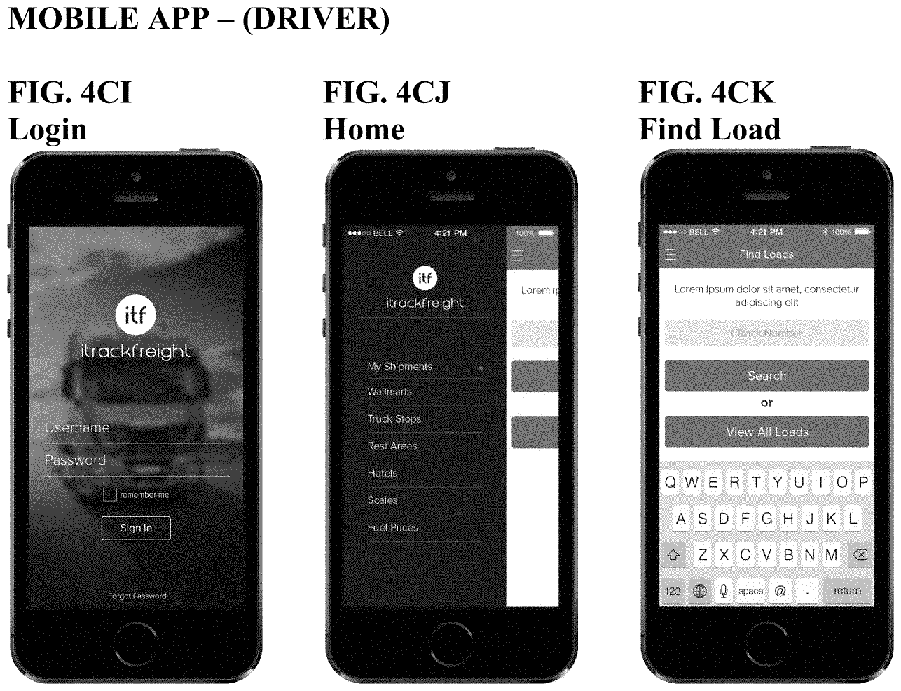

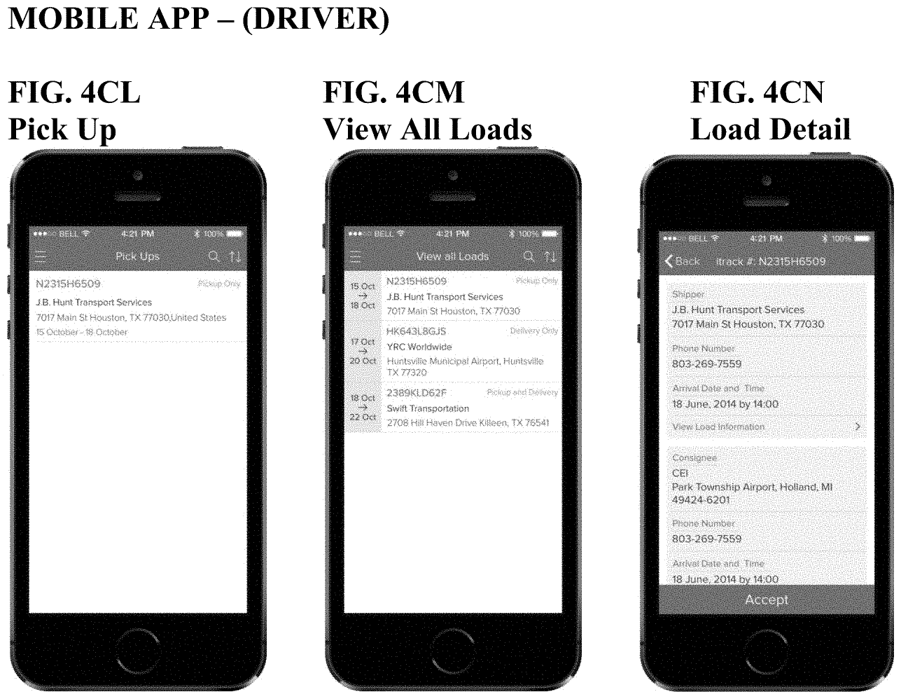

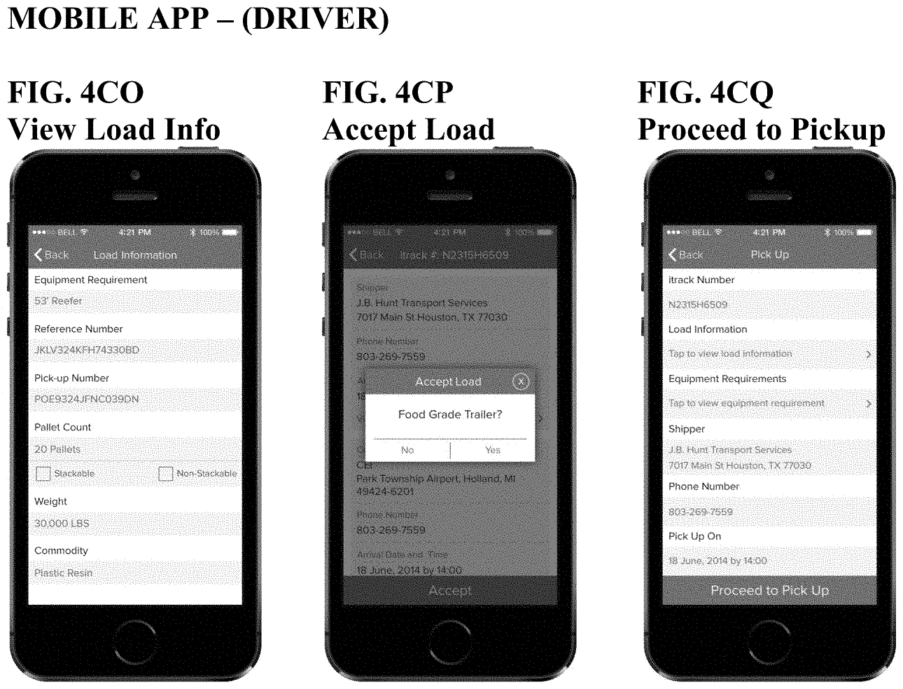

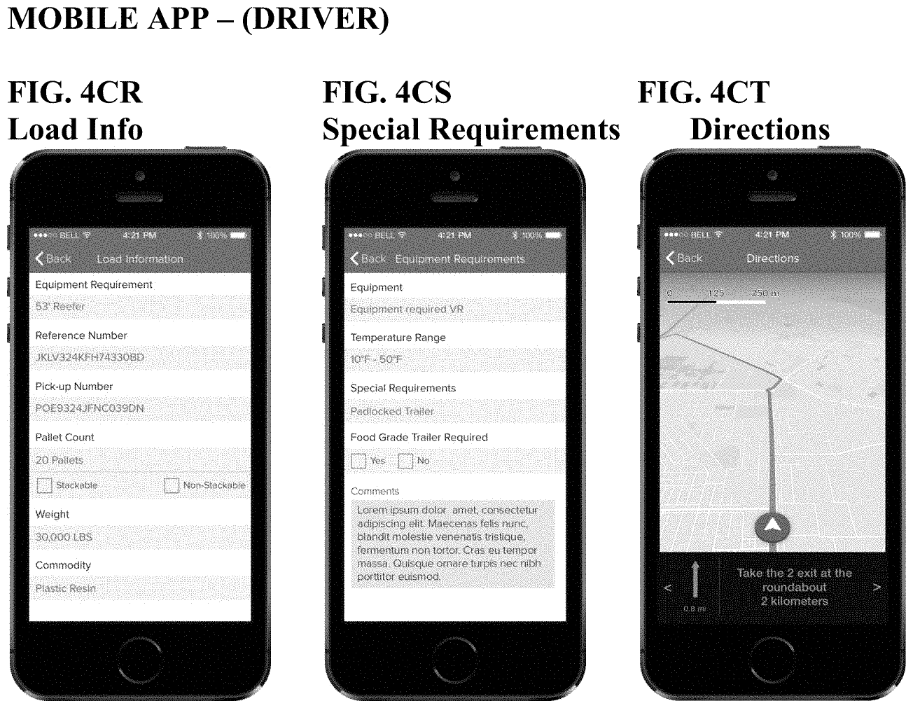

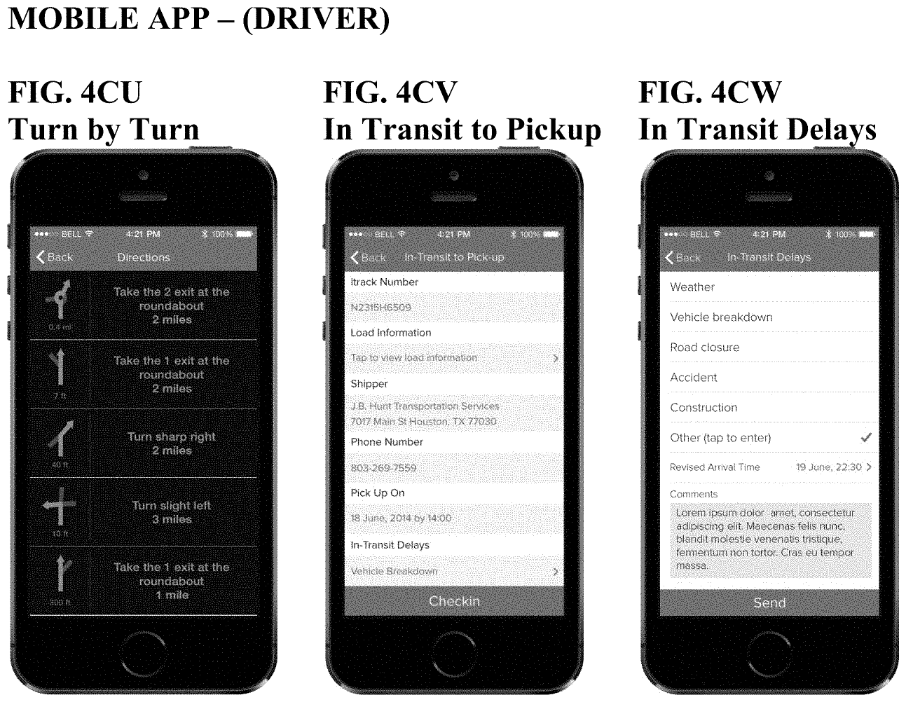

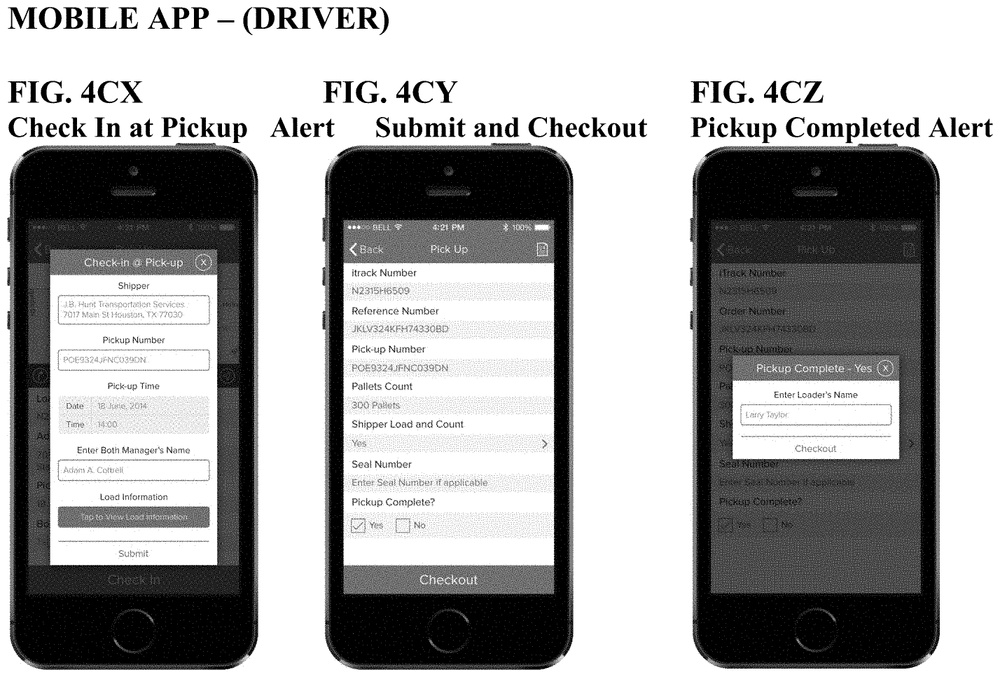

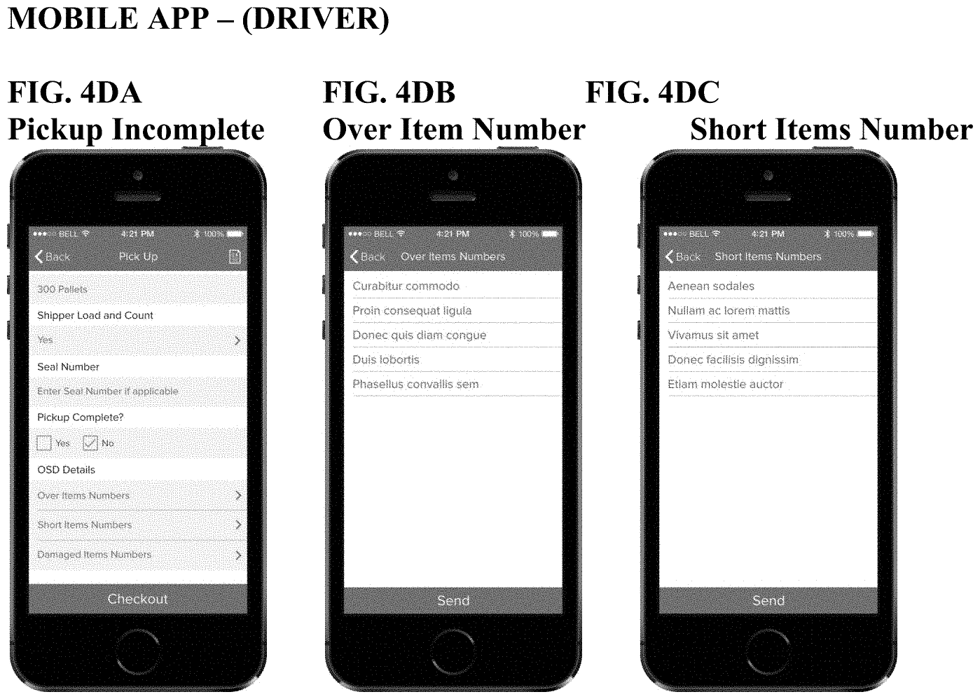

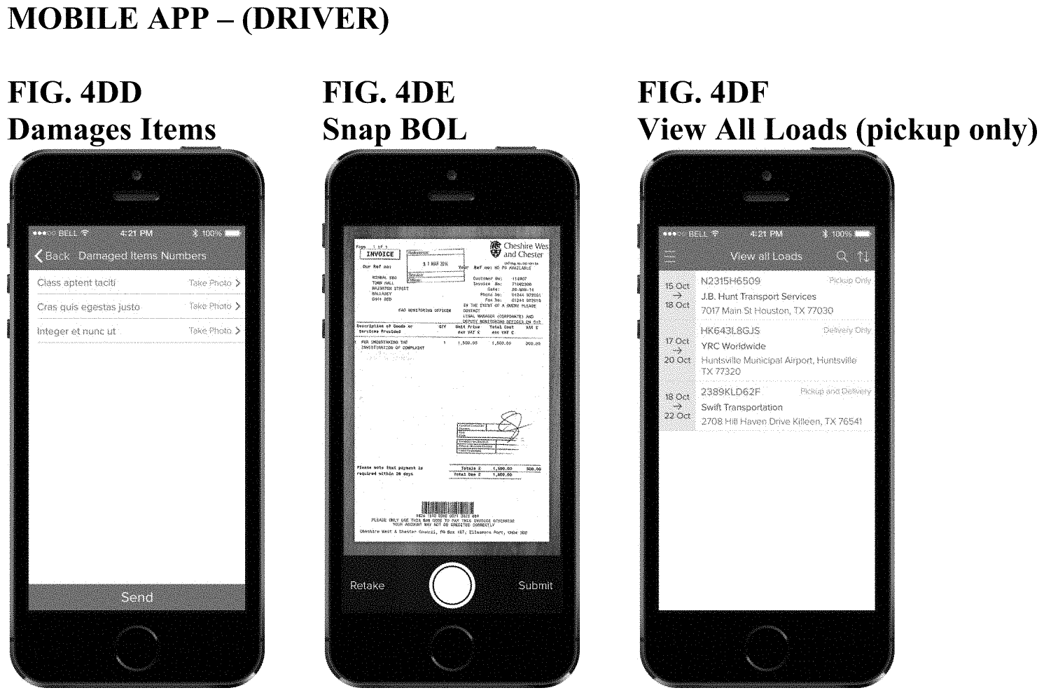

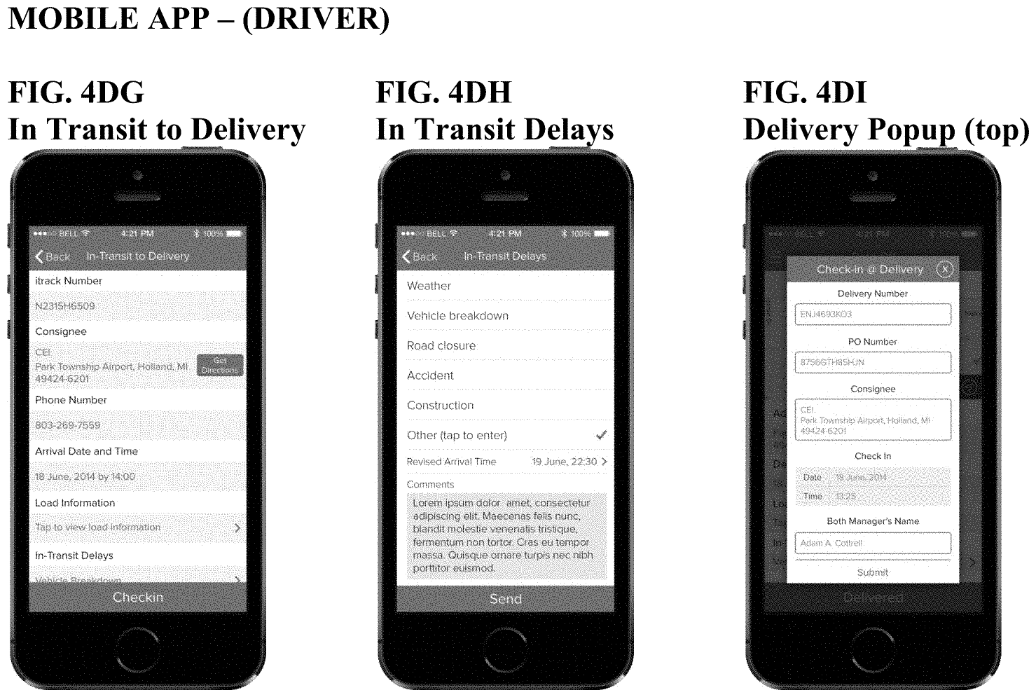

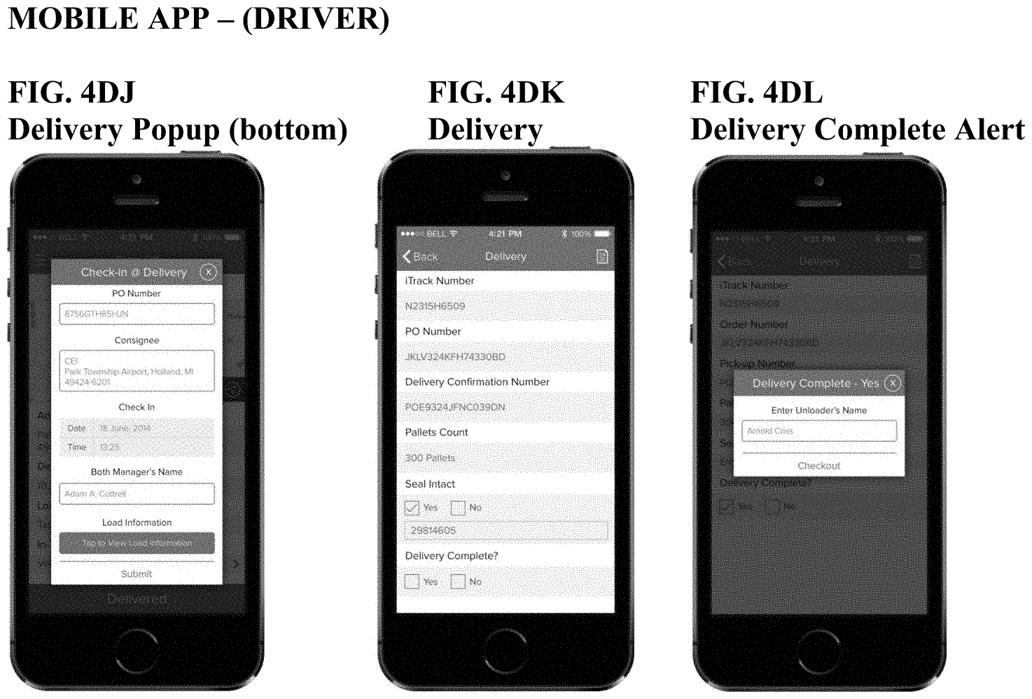

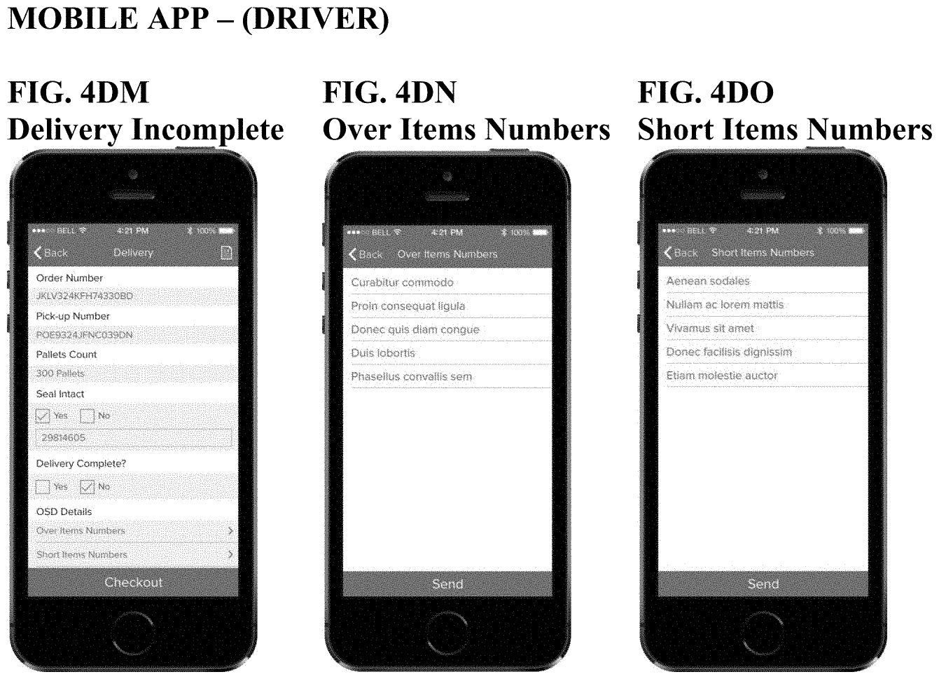

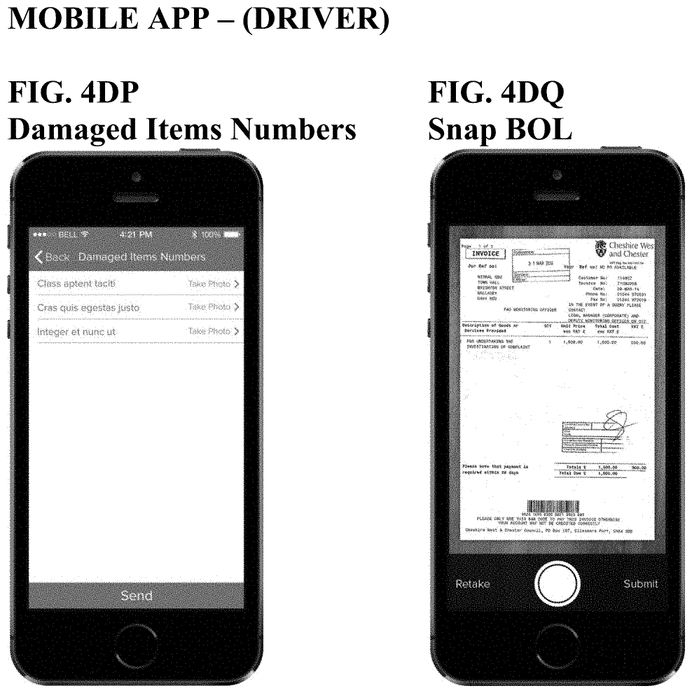

FIGS. 4A-4DQ depicts an exemplary user interface for use with the disclosed embodiments, such as in a web or mobile device based implementation, to enable a user, e.g. a shipper, broker, carrier and/or driver, to interact with the disclosed embodiments as described herein. In particular:

FIGS. 4A and 4B depicts an exemplary user interface for a user to initiate interaction with the disclosed embodiments.

FIGS. 4C-4E depicts an exemplary user interface for a new user to create an account in the system implemented by the disclosed embodiments.

FIG. 4F depicts an exemplary user interface for logging into the system implemented by the disclosed embodiments.

FIGS. 4G and 4H depicts an exemplary user interface for managing loads by a user.

FIG. 4I-4J depicts an exemplary user interface for inputting information by a shipper to initiate a new shipment/transaction and further depicting the modification authorization input/toggle/switch as discussed in detail below.

FIG. 4K depicts a more detailed view of the modification authorization input, showing the enabled and disabled states.

FIG. 4L depicts an exemplary user interface for initiating upload of a Bill of Lading (BOL) to the system implemented by the disclosed embodiments.

FIG. 4M depicts an exemplary user interface for editing details of a load and further depicting the modification authorization input/toggle/switch as discussed in detail below.

FIG. 4N depicts an exemplary user interface for viewing a bill of lading.

FIGS. 4O and 4X depicts an exemplary user interface for a user to assign a load/transaction to a broker or carrier.

FIGS. 4P and 4Q depicts an exemplary user interface for a user (broker or carrier) to accept a load assigned to them.

FIGS. 4R, 4S and 4Y depicts an exemplary user interface for a user (broker or carrier) to view load details and accept/reject a load.

FIGS. 4T and 4U depicts an exemplary user interface for a user (broker or carrier) to enter a load number for a load.

FIGS. 4V and 4W depicts an exemplary user interface for a user (broker or carrier) to view load details and accept/reject a load, and showing the entered load number.

FIG. 4Z depicts an exemplary user interface for selecting a carrier.

FIG. 4AA depicts an exemplary user interface for selecting a carrier for pickup/deliver.

FIG. 4AB depicts an exemplary user interface for assigning a pickup by a user/broker.

FIGS. 4AC and 4AF depicts an exemplary user interface for assigning a driver to a load/.transaction by a carrier.

FIG. 4AD depicts an exemplary user interface for selecting a driver

FIG. 4AE depicts an exemplary user interface for selecting a driver and viewing driver details.

FIGS. 4AG and 4AJ depicts an exemplary user interface for viewing pending loads/transactions.

FIGS. 4AH and 4AK depicts an exemplary user interface for tracking a shipment.

FIG. 4AL 4AL and 4AM depicts an exemplary user interface for viewing loads in transit.

FIG. 4AN depicts an exemplary user interface for reassigning a load/transaction.

FIGS. 4AO and 4AP depicts an exemplary user interface for selecting a replacement carrier.

FIG. 4AQ depicts an exemplary user interface for unassigning a load/transaction.

FIG. 4AR depicts an exemplary user interface for selecting a carrier.

FIG. 4AS depicts an exemplary user interface for reassigning a driver.

FIG. 4AT depicts an exemplary user interface for selecting a replacement driver.

FIG. 4AU depicts an exemplary user interface for unassigning a driver.

FIG. 4AV depicts an exemplary user interface for viewing replacement driver details.

FIGS. 4AW, 4AX and 4AY depicts an exemplary user interface for viewing detailed load tracking information.

FIG. 4AZ depicts an exemplary user interface for viewing completed transactions/delivered loads.

FIG. 4BA depicts an exemplary user interface for adding a notification.

FIGS. 4BB and 4BC depicts an exemplary user interface for viewing in-transit delays.

FIGS. 4BD and 4BE depicts an exemplary user interface for obtaining updates.

FIGS. 4BF, 4BG and 4BH depicts an exemplary user interface for showing an in-transit delay alert notification.

FIGS. 4BI, 4BJ and 4BK depicts an exemplary user interface for showing an OSD alert notification.

FIG. 4BL, 4BM AND 4BN depicts an exemplary user interface for viewing a bill of lading at pickup.

FIGS. 4B0, 4BP and 4BQ depicts an exemplary user interface for viewing a POD at pickup

FIG. 4BR depicts an exemplary user interface for viewing stored locations.

FIG. 4BS depicts an exemplary user interface for viewing stored location detail.

FIGS. 4BT, 4BU and 4BV depicts an exemplary user interface for inviting a shipper/broker/carrier/driver to sign up with the system.

FIG. 4BW, 4BX, 4BZ depicts an exemplary user interface for viewing a list of carriers., brokers or drivers.

FIGS. 4BY and 4CA depicts an exemplary user interface for viewing broker or driver details.

FIG. 4CB depicts an exemplary user interface for viewing warehouse information.

FIG. 4CC depicts an exemplary user interface for warehouse detail information.

FIGS. 4CD. 4CE and 4CF depicts an exemplary user interface for viewing reports.

FIG. 4CG depicts an exemplary user interface for an administrative pop up input.

FIG. 4CH depicts an exemplary user interface for adding details.

FIG. 4CI depicts an exemplary user interface for a mobile device, such as a device used by a driver, for logging in to the disclosed system.

FIG. 4CJ depicts an exemplary user interface for a mobile device, such as a device used by a driver, for a home screen.

FIG. 4CK depicts an exemplary user interface for a mobile device, such as a device used by a driver, for locating a transaction/load.

FIG. 4CL depicts an exemplary user interface for a mobile device, such as a device used by a driver, for viewing a pickup directive.

FIG. 4CM depicts an exemplary user interface for a mobile device, such as a device used by a driver, for viewing all loads/transactions.

FIG. 4CN depicts an exemplary user interface for a mobile device, such as a device used by a driver, for viewing load/transaction details.

FIGS. 4CO and 4CR depicts an exemplary user interface for a mobile device, such as a device used by a driver, for viewing load/transaction information.

FIG. 4CP depicts an exemplary user interface for a mobile device, such as a device used by a driver, for accepting a load/transaction.

FIG. 4CQ depicts an exemplary user interface for a mobile device, such as a device used by a driver, for proceeding to pick up.

FIG. 4CS depicts an exemplary user interface for a mobile device, such as a device used by a driver, for viewing special requirements.

FIG. 4CT depicts an exemplary user interface for a mobile device, such as a device used by a driver, for displaying routing/directions via a map.

FIG. 4CU depicts an exemplary user interface for a mobile device, such as a device used by a driver, for displaying routing/directions in a turn by turn format.

FIG. 4CV depicts an exemplary user interface for a mobile device, such as a device used by a driver, for indicating the driver is in-transit to a pickup.

FIG. 4CW depicts an exemplary user interface for a mobile device, such as a device used by a driver, for indicating in-transit delays.

FIG. 4CX depicts an exemplary user interface for a mobile device, such as a device used by a driver, for a check-in at a pickup alert.

FIG. 4CY depicts an exemplary user interface for a mobile device, such as a device used by a driver, for submitting a load and checking out.

FIG. 4CZ depicts an exemplary user interface for a mobile device, such as a device used by a driver, for indicating a pickup completed alert.

FIG. 4DA depicts an exemplary user interface for a mobile device, such as a device used by a driver, for indicating an incomplete pickup.

FIG. 4DB depicts an exemplary user interface for a mobile device, such as a device used by a driver, for indicating over item number.

FIG. 4DC depicts an exemplary user interface for a mobile device, such as a device used by a driver, for indicating short items/numbers.

FIG. 4DD depicts an exemplary user interface for a mobile device, such as a device used by a driver, for indicated damaged items.

FIG. 4DE depicts an exemplary user interface for a mobile device, such as a device used by a driver, for capturing an image of a bill of lading using the device's camera.

FIG. 4DF depicts an exemplary user interface for a mobile device, such as a device used by a driver, for viewing all loads.

FIG. 4DG depicts an exemplary user interface for a mobile device, such as a device used by a driver, for indicating the driver is in-transit to delivery.

FIG. 4DH depicts an exemplary user interface for a mobile device, such as a device used by a driver, for indicating in-transit delays.

FIGS. 4DI and 4DJ depicts an exemplary user interface for a mobile device, such as a device used by a driver, for indicating delivery via a popup.

FIGS. 4DK and 4DL depicts an exemplary user interface for a mobile device, such as a device used by a driver, for indicating delivery and completion thereof.

FIG. 4DM depicts an exemplary user interface for a mobile device, such as a device used by a driver, for indicating incomplete delivery.

FIG. 4DN depicts an exemplary user interface for a mobile device, such as a device used by a driver, for indicating over items/numbers.

FIG. 4DO depicts an exemplary user interface for a mobile device, such as a device used by a driver, for indicating short items/numbers.

FIG. 4DP depicts an exemplary user interface for a mobile device, such as a device used by a driver, for indicating damaged items.

FIG. 4DQ depicts an exemplary user interface for a mobile device, such as a device used by a driver, for capturing an image of a Bill of Lading, e.g. using the device's camera.

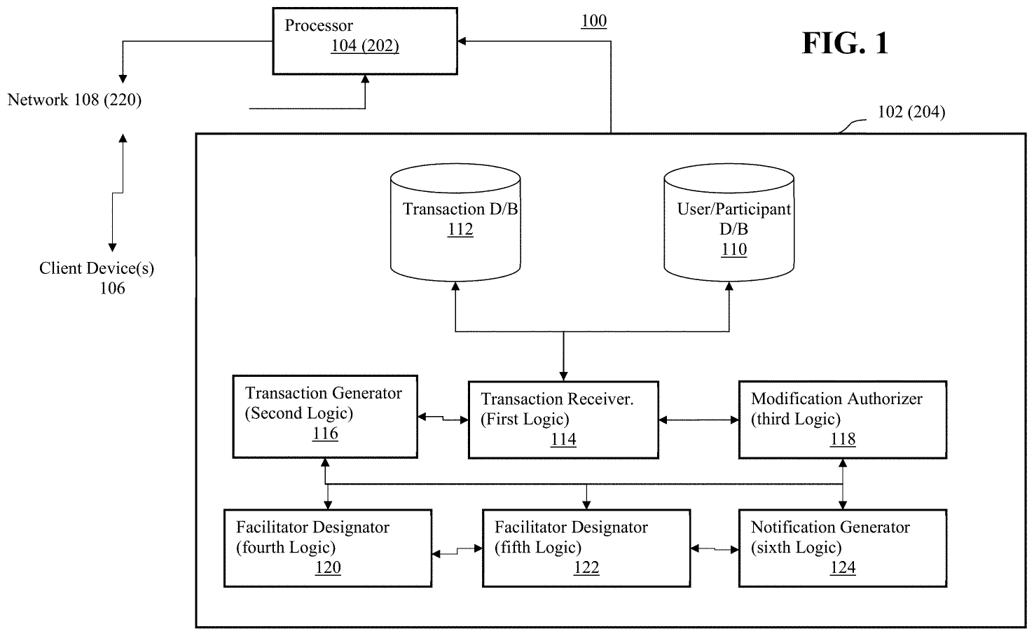

FIG. 1 illustrates a system 100, e.g. a logistics management system, for managing a multi-participant transaction, such as the transportation of freight from an origin to a destination. The system 100 may be implemented as a separate component or as one or more logic components, such as on an FPGA that may include a memory or reconfigurable component to store logic and processing component to execute the stored logic, or as computer program logic, stored in a memory 102, or other non-transitory computer readable medium, and executable by a processor 104, such as the processor 202 and memory 204 described above with respect to FIG. 2. In one embodiment, the system 100 is implemented by a server computer, e.g. a web server, coupled with one or more client devices 106, such as computers, mobile devices, etc. via a wired and/or wireless electronic communications network 108, such as the network 220 described above with respect to FIG. 2. In one embodiment, client devices 106 interact with the system 100 of the server computer to provide inputs thereto and receive outputs therefrom as described herein. In one embodiment these interactions are facilitated via the HTTP protocol.

In one embodiment, the system 100 includes a user database or data structure 110 stored in the memory 102 or separate therefrom and operative to store data records storing data, such as identifying data, indicative of users who have registered to use the system 100, such as one or more shippers, brokers, carriers and/or drivers. In one embodiment, the system 100 further includes a transaction database or data structure 112 stored in the memory 102 or separate therefrom and/or separate from the user database 110, and operative to store data records storing data indicative of transactions initiated, in process and/or completed as described herein. In one embodiment, the user database 110 and transaction database 112 may be implemented in one database, e.g. as tables thereof.

The system 100 further includes a transaction receiver 114 coupled with an electronic communications network 108, such as the network 220 described above, and the second user and transaction databases 110 112. The transaction receiver 114 may be implemented as a separate component or as one or more logic components, e.g. first logic, such as on an FPGA that may include a memory or reconfigurable component to store logic and processing component to execute the stored logic, or as computer program logic, stored in the memory 102, or other non-transitory computer readable medium, and executable by a processor 104, such as the processor 202 and memory 204 described below with respect to FIG. 2, to cause the processor 104 to, or otherwise be operative to receive, from an initiator participant, e.g. a shipper, via a user interface (not shown) coupled with the processor, first transaction data indicative of initiation of a first transaction, e.g. transportation of a freight load from and origin to a destination, to be completed by one or more facilitator, e.g. broker and/or carrier (or shipper-carrier), and execution, e.g. driver, participants selected from a participant database, e.g. the user database 110, coupled with the processor 104 which stores data indicative of a plurality of participants, the first transaction data including a plurality of parameters (e.g. attributes, requirements) which direct how the one or more facilitator and execution participants are to complete the first transaction. These parameters may include type of load, mode of transport, pickup date, delivery date, etc. In one embodiment, the user interface comprises a web based interface as depicted in FIGS. 4A-4DQ.

The system 100 further includes a transaction generator 116 coupled with the transaction receiver 114. The transaction generator 116 may be implemented as a separate component or as one or more logic components, e.g. second logic, such as on an FPGA that may include a memory or reconfigurable component to store logic and processing component to execute the stored logic, or as computer program logic, stored in the memory 102, or other non-transitory computer readable medium, and executable by a processor 104, such as the processor 202 and memory 204 described above with respect to FIG. 2, to cause the processor 102 to, or otherwise be operative to, generate or otherwise create, based on receipt of the first transaction data by the processor 104 in a database, e.g. the transaction database 112 stored in the memory 102 coupled therewith, a first data record comprising data indictive of the first transaction and the plurality of parameters (e.g. attributes, requirements) thereof.

The system 100 further includes a modification authorizer 118 coupled with the transaction receiver 114. The modification authorizer 118 may be implemented as a separate component or as one or more logic components, e.g. third logic, such as on an FPGA that may include a memory or reconfigurable component to store logic and processing component to execute the stored logic, or as computer program logic, stored in the memory 102, or other non-transitory computer readable medium, and executable by a processor 104, such as the processor 202 and memory 204 described above with respect to FIG. 2, to cause the processor 102 to, or otherwise be operative to, receive, by the processor from the initiator participant via the user interface, contemporaneous with initiation of transaction or subsequent thereto, first authorization data specifying whether the one or more facilitator or execution participants are authorized to modify one or more of the plurality of parameters of the first transaction to alter how the one or more facilitator and execution participants are to complete the first transaction, and store the first authorization data in the first data record. In one embodiment, the first authorization data is stored as key data in the first data record, e.g. as a field, or combination of fields, in the database table used to retrieve and sort rows in the table based on certain requirements, which may speed up access to data and create links between different tables.

The system 100 further includes a first facilitator designator 120 coupled with the transaction receiver 114. The first facilitator designator 120 may be implemented as a separate component or as one or more logic components, e.g. fourth logic, such as on an FPGA that may include a memory or reconfigurable component to store logic and processing component to execute the stored logic, or as computer program logic, stored in the memory 102, or other non-transitory computer readable medium, and executable by a processor 104, such as the processor 202 and memory 204 described above with respect to FIG. 2, to cause the processor 102 to, or otherwise be operative to, receive, from the initiator participant via the user interface, first designation data indicative of a first designation of a first facilitator participant, selected from the participant database 110, to facilitate the completion of the first transaction according to the plurality of parameters of the first transaction, and store the first designation data in the first data record. For example, the initiator participant, e.g. the shipper, may designate either a broker or a carrier.

Further, wherein, when, based on the first authorization data, the designated first facilitator participant is authorized to modify one or more of the plurality of parameters of the first transaction, the first facilitator designator is further operative, e.g. the fourth logic 120 is further executable by the processor to cause the processor, to enable modification in the first data record, by the designated first facilitator participant, of the one or more of the plurality of parameters of the first transaction and receive, from the designated first facilitator participant via the user interface, second authorization data specifying whether another of the one or more facilitator or execution participants are authorized to modify one or more of the plurality of parameters of the first transaction to alter how the other one or more facilitator or execution participants are to complete the first transaction, and store the second authorization data in the first data record. For example, as shown in FIGS. 4I-4K, 4M and 4AB, the system 100 may enable editing of the transaction details data by the first facilitator participant, e.g. the edit function is enabled as opposed to being “grayed out” based on the processor's 104 evaluation of the first authorization data stored in the data record, and further, one of the editable attributes may be a modification authorization function/switch, as depicted, which enables modification by downstream participants as described. In one embodiment, the second authorization data is stored as key data in the first data record, e.g. as a field, or combination of fields, in the database table used to retrieve and sort rows in the table based on certain requirements, which may speed up access to data and create links between different tables.

The system 100 further includes a second facilitator designator 122, which may be the same as the first facilitator designator 120, coupled with the transaction receiver 114. The second facilitator designator 122 may be implemented as a separate component or as one or more logic components, e.g. second logic, such as on an FPGA that may include a memory or reconfigurable component to store logic and processing component to execute the stored logic, or as computer program logic, stored in the memory 102, or other non-transitory computer readable medium, and executable by a processor 104, such as the processor 202 and memory 204 described above with respect to FIG. 2, to cause the processor 102 to, or otherwise be operative to, receive, from the designated first facilitator participant, e.g. broker or carrier (or shipper-carrier), via the user interface, e.g. if a broker, second designation data indicative of a second designation of either a second facilitator participant, e.g. a carrier, to further facilitate completion of the first transaction or, if the first facilitator participant is a carrier, an execution participant, e.g. a driver, to complete the first transaction according to the plurality of parameters of the first transaction, selected from the participant database 110, and store the second designation data in the first data record. Generally, the first facilitator participant acts according the plurality of parameters, modified or not, to complete the first transaction.

Further, wherein, when the second facilitator participant, e.g. a carrier, is designated and, based on the second authorization data, the designated second facilitator participant is authorized to modify one or more of the plurality of parameters of the first transaction, the second facilitator designator 122 is operative, e.g. the fifth logic 122 is further executable by the processor 104, to cause the processor 104 to enable modification in the first data record, by the designated second facilitator participant, of the one or more of the plurality of parameters of the first transaction and receive, from the designated second facilitator participant via the user interface, third authorization data specifying whether the execution participant is authorized to modify one or more of the plurality of parameters of the first transaction to alter how the designated execution participant is to complete the first transaction, and store the third authorization data in the first data record. For example, as shown in FIGS. 4I-4K, 4M and 4AB, the system 100 may enable editing of the transaction details data by the second facilitator participant, e.g. the edit function is enabled as opposed to being “grayed out” based on the processor's 104 evaluation of the second authorization data stored in the data record, and further, one of the editable attributes may be a modification authorization function/switch, as depicted, which enables modification by downstream participants as described. In one embodiment, the third authorization data is stored as key data in the first data record, e.g. as a field, or combination of fields, in the database table used to retrieve and sort rows in the table based on certain requirements, which may speed up access to data and create links between different tables.

Further, wherein, when the second facilitator participant, e.g. a carrier, is designated, the second facilitator designator 122 is operative, e.g. the fifth logic 122 is further executable by the processor 104, to cause the processor 104 to receive, from the second facilitator participant via the user interface, third designation data indicative of a third designation of an execution participant, e.g. a driver, selected from the participant database 110, to complete the first transaction, and store the third designation data in the first data record. The second facilitator participant acts according the plurality of parameters, modified or not, to complete the first transaction.

Further, wherein, when, based on the third authorization data, the designated execution participant, e.g. driver, is authorized to modify one or more of the plurality of parameters of the first transaction, the second facilitator designator 122 is operative, e.g. the fifth logic 122 is further executable by the processor to cause the processor, to enable modification in the first data record, by the designated execution participant, of the one or more of the plurality of parameters of the first transaction. The execution participant acts according the plurality of parameters, modified or not, to complete the first transaction. For example, as shown in FIGS. 4I-4K, 4M and 4AB, the system 100 may enable editing of the transaction details data by the execution participant, e.g. the edit function is enabled as opposed to being “grayed out” based on the processor's 104 evaluation of the third authorization data stored in the data record.

The system 100 further includes a notification generator 124 coupled with the transaction receiver 114. The notification generator 124 may be implemented as a separate component or as one or more logic components, e.g. sixth logic, such as on an FPGA that may include a memory or reconfigurable component to store logic and processing component to execute the stored logic, or as computer program logic, stored in the memory 102, or other non-transitory computer readable medium, and executable by a processor 104, such as the processor 202 and memory 204 described above with respect to FIG. 2, to cause the processor 102 to, or otherwise be operative to, upon receipt of a modification to the plurality of parameters of the first transaction by the processor 104 from one of the initiator, designated first facilitator, designated second facilitator or designated execution participants, transmit an electronic notification message to all of the others of the initiator, designated first facilitator, designated second facilitator and designated execution participants. The notification message may be transmitted via the network 108 or by other mean, as a text message, electronic mail message or pop-up notification displayed on the user interface.

In one embodiment, the first transaction comprises a shipment of a freight load from an origin location to a destination location, the shipment being arranged by the initiator participant, facilitated by the first and, if designated, second facilitator participants and completed by the execution participant, according to the plurality of parameters of the first transaction.

In one embodiment, the first facilitator participant comprises one of a broker or carrier, and wherein when the first facilitator participant is a broker, the second facilitator participant comprises a carrier, and the execution participant is a driver. The initiator participant may be one of a shipper, manufacturer, buyer, etc. In an alternative embodiment, the shipper and carrier may be the same entity, e.g. a “shipper-carrier” that operates its own trucks.

In one embodiment the user interface is presented to the initiator participant, designated first facilitator and designated second facilitator participants via an electronic communications network. In particular, as described above, the user interface may comprise one or more web pages, such as those depicted in FIGS. 4A-4DQ, presented to the user via a web site over a network, e.g. the Internet.

In one embodiment, the plurality of parameters include one or more of pickup location, type of load, delivery location, delivery type, special instructions. The plurality of parameters may further include designations of other participants to facilitate and complete the first transaction.

In one embodiment, the shipper/initiator may be authorized to make modifications to the transaction by default and only authorized downstream participants can further authorize a subsequent downstream party (downstream can only be authorized by an authorized immediate upstream). In one embodiment, the authorization to modify includes authorization to further authorize.

In an alternative embodiment, a downstream party can be authorized to modify the transaction but not further authorize subsequent downstream parties to do so.

In another alternative embodiment, an upstream party can selectively authorize any or all downstream parties, e.g. a shipper can authorize a carrier but not a broker, or authorize a broker and driver but not a carrier, etc.

In another alternative embodiment, the authorization to modify a transaction can be a function of each participant, and stored in the user database in association with the data indicative of the user, e.g. a shipper trusts some brokers and not others, such that selecting a particular participant sets the authorization data (which may be overridden). Trust level of a downstream may be stored in the participant database 110 and may be different for each upstream participant. For example, an upstream participant can set participant level trust such that a downstream participant's designation of a particular participant, sets the authorization to modify, therefore. Alternatively, trust may be a global setting for each participant stored in the participant database 110 and used for any transaction in which that participant is designated. It may be global across the system 100 or limited to just transactions of the designating participant.

In one embodiment, the fourth logic 120 is further executable by the processor 104 to cause the processor 104 to check the first data record and present an input to the designated first facilitator participant via the user interface (not shown) to receive the second authorization data when the first authorization data in the first data record indicates that the one or more facilitator or execution participants are authorized to modify one or more of the plurality of parameters of the first transaction to alter how the one or more facilitator and execution participants are to complete the first transaction, and the fifth logic 122 is further executable by the processor 104 to cause the processor 104 to check the first data record and present an input to the designated second facilitator participant via the user interface (not shown) to receive the third authorization data when the second authorization data in the first data record indicates that the designated second facilitator participant is authorized to modify one or more of the plurality of parameters of the first transaction to alter how the execution participants is to complete the first transaction.

In one embodiment, the first logic 114 is further executable by the processor 104 to cause the processor 104 to receive from the initiator participant, via the user interface (not shown) coupled with the processor 104, second transaction data indicative of initiation of a second transaction to be completed by one or more facilitator and execution participants selected from a participant database 110 coupled with the processor 104 which stores data indicative of a plurality of participants, the second transaction data including a plurality of parameters (attributes, requirements) which direct how the one or more facilitator and execution participants are to complete the first transaction; and the second logic 116 is further executable by the processor 104 to cause the processor 104 to create, based on receipt of the second transaction data, in the database stored in the memory 102 coupled therewith, a second data record comprising data indictive of the second transaction and the plurality of parameters (attributes, requirements) thereof; wherein one or more of the plurality of parameters, first, second, or third authorization data, or first, second or third designation data, of the second data record are different from the first data record.

In one embodiment, a modification to the plurality of parameters by the designated execution participant must be approved by the designated second facilitator participant, if designated, or the designated first facilitator participant, e.g. where the upstream participant must approve a downstream modification.

In one embodiment, the user interface operates differently for each of the initiator, designated first facilitator, designated second facilitator and execution participants. See for example the shipper, broker, carrier and driver specific interfaces shown in FIGS. 4A-4DQ.

In one embodiment, subsequent to receipt of the first, second or third authorization data, the processor 104 is caused to receive alternative first, second or third authorization data changing whether the designated first, second or execution participants are authorized to modify one or more of the plurality of parameters of the first transaction.

In one embodiment, the modification to the plurality of parameters of the first transaction further includes adding an additional parameter thereto.

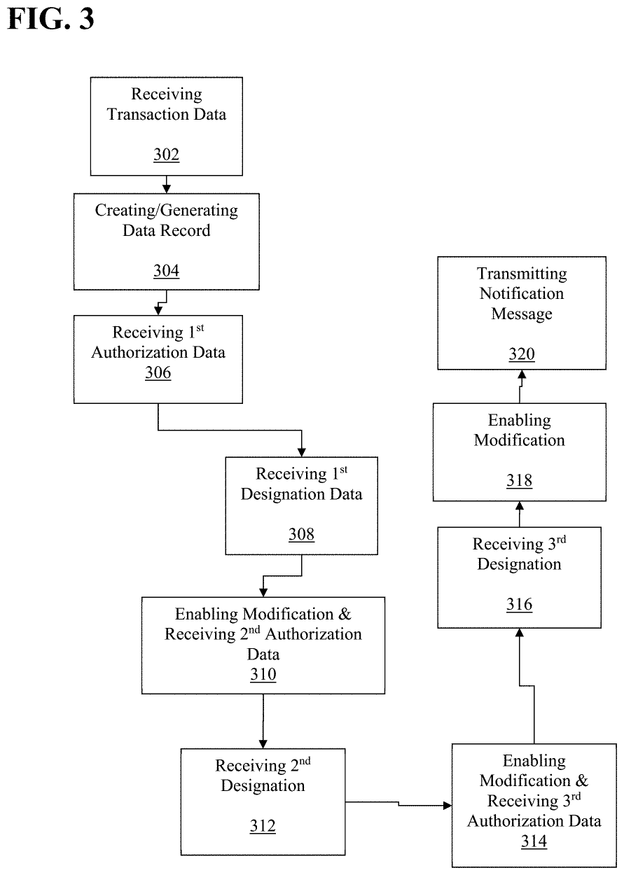

FIG. 3 depicts a flow chart showing operation of the system 100 of FIG. 1. In particular FIG. 3 shows a computer implemented method of managing a multi-participant transaction. The operation of the system 100 includes: receiving, by a processor 104 from an initiator participant, e.g. a shipper, via a user interface coupled with the processor, first transaction data indicative of initiation of a first transaction to be completed by one or more facilitator and execution participants selected from a participant database coupled with the processor which stores data indicative of a plurality of participants, the first transaction data including a plurality of parameters (attributes, requirements) which direct how the one or more facilitator and execution participants are to complete the first transaction (Block 302); Creating or otherwise generating, based on receipt of the first transaction data by the processor 104 in a database 112 stored in a memory 102 coupled therewith, a first data record comprising data indictive of the first transaction and the plurality of parameters (attributes, requirements) thereof (Block 304); receiving, by the processor 104 from the initiator participant via the user interface, contemporaneous with initiation of transaction or subsequent thereto, first authorization data specifying whether the one or more facilitator or execution participants are authorized to modify one or more of the plurality of parameters of the first transaction to alter how the one or more facilitator and execution participants are to complete the first transaction, and storing the first authorization data in the first data record (Block 306); receiving, by the processor 104 from the initiator participant via the user interface (not shown), first designation data indicative of a first designation of a first facilitator participant, e.g. a broker or carrier (or shipper-carrier), selected from the participant database 110, to facilitate the completion of the first transaction according to the plurality of parameters of the first transaction, and storing the first designation data in the first data record (Block 308); wherein, when, based on the first authorization data, the designated first facilitator participant is authorized to modify one or more of the plurality of parameters of the first transaction, enabling, by the processor 104, modification in the first data record, by the designated first facilitator participant, of the one or more of the plurality of parameters of the first transaction and receiving, by the processor 104 from the designated first facilitator participant via the user interface, second authorization data specifying whether another of the one or more facilitator, e.g. carrier, or execution, e.g. driver, participants are authorized to modify one or more of the plurality of parameters of the first transaction to alter how the other one or more facilitator or execution participants are to complete the first transaction, and storing the second authorization data in the first data record (Block 310); receiving, by the processor 104 from the designated first facilitator participant via the user interface (not shown), where the first facilitator participant comprises a broker, second designation data indicative of a second designation of either a second facilitator participant, e.g. a carrier, to further facilitate completion of the first transaction or, where the first facilitator participant comprises a carrier, an execution participant, e.g. a driver, to complete the first transaction according to the plurality of parameters of the first transaction, selected from the participant database 110, and storing the second designation data in the first data record (Block 312); wherein, when the second facilitator participant, e.g. a carrier, is designated and, based on the second authorization data, the designated second facilitator participant is authorized to modify one or more of the plurality of parameters of the first transaction, enabling, by the processor 104, modification in the first data record, by the designated second facilitator participant, of the one or more of the plurality of parameters of the first transaction and receiving, by the processor 104 from the designated second facilitator participant via the user interface, third authorization data specifying whether the execution participant, e.g. driver, is authorized to modify one or more of the plurality of parameters of the first transaction to alter how the designated execution participant is to complete the first transaction, and storing the third authorization data in the first data record (Block 314); wherein, when the second facilitator participant, e.g. carrier, is designated, further receiving, by the processor 104 from the second facilitator participant via the user interface, third designation data indicative of a third designation of an execution participant, e.g. driver, selected from the participant database 110, to complete the first transaction, and storing the third designation data in the first data record (Block 316); wherein, when, based on the third authorization data, the designated execution participant, e.g. driver, is authorized to modify one or more of the plurality of parameters of the first transaction, enabling, by the processor 104, modification in the first data record, by the designated execution participant, of the one or more of the plurality of parameters of the first transaction (Block 318); and upon receipt of a modification to the plurality of parameters of the first transaction by the processor 104 from one of the initiator, designated first facilitator, designated second facilitator or designated execution participants, transmitting, by the processor 104, an electronic notification message, e.g. text message, email, web page pop up, etc., to all of the others of the initiator, designated first facilitator, designated second facilitator and designated execution participants (Block 320).

In one embodiment, the first transaction comprises a shipment of a freight load from an origin location to a destination location, the shipment being arranged by the initiator participant, facilitated by the first and, if designated, second facilitator participants and completed by the execution participant, according to the plurality of parameters of the first transaction.

In one embodiment, the first facilitator participant comprises one of a broker or carrier, and wherein when the first facilitator participant is a broker, the second facilitator participant comprises a carrier, and the execution participant is a driver. The initiator participant may be a shipper, manufacturer, buyer, etc. In an alternative embodiment, the shipper and carrier may be the same entity.

In one embodiment, the operation of the system 100 further includes presenting the user interface to the initiator participant, designated first facilitator and designated second facilitator participants via an electronic communications network, e.g. as a web site comprising multiple interactive web pages as described above and shown, for example, in FIGS. 4A-4DQ.

In one embodiment, the plurality of parameters include one or more of pickup location, type of load, delivery location, delivery type, special instructions. [and may further include designations of other participants to facilitate and complete the first transaction]

In one embodiment, the operation of the system 100 further includes the receiving of second authorization data further including checking the first data record and presenting an input to the designated first facilitator participant via the user interface to receive the second authorization data when the first authorization data in the first data record indicates that the one or more facilitator or execution participants are authorized to modify one or more of the plurality of parameters of the first transaction to alter how the one or more facilitator and execution participants are to complete the first transaction, and the receiving of third authorization data further includes checking the first data record and presenting an input to the designated second facilitator participant via the user interface to receive the third authorization data when the second authorization data in the first data record indicates that the designated second facilitator participant is authorized to modify one or more of the plurality of parameters of the first transaction to alter how the execution participants is to complete the first transaction.

In one embodiment, the operation of the system 100 further includes receiving, by the processor 104 from the initiator participant, via the user interface (not shown) coupled with the processor 104, second transaction data indicative of initiation of a second transaction to be completed by one or more facilitator and execution participants selected from a participant database coupled with the processor which stores data indicative of a plurality of participants, the second transaction data including a plurality of parameters (attributes, requirements) which direct how the one or more facilitator and execution participants are to complete the first transaction; and creating, based on receipt of the second transaction data by the processor 104 in the database 112 stored in the memory 102 coupled therewith, a second data record comprising data indictive of the second transaction and the plurality of parameters (attributes, requirements) thereof; wherein one or more of the plurality of parameters, first, second, or third authorization data, or first, second or third designation data, of the second data record are different from the first data record.

In one embodiment, a modification to the plurality of parameters by the designated execution participant must be approved by the designated second facilitator participant, if designated, or the designated first facilitator participant.

In one embodiment, the user interface operates differently for each of the initiator, designated first facilitator, designated second facilitator and execution participants.

In one embodiment, the operation of the system 100 further includes, subsequent to receipt of the first, second or third authorization data, receiving alternative first, second or third authorization data changing whether the designated first, second or execution participants are authorized to modify one or more of the plurality of parameters of the first transaction.

In one embodiment, the modification to the plurality of parameters of the first transaction further includes adding an additional parameter thereto.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is therefore intended that the foregoing detailed description be regarded as illustrative rather than limiting, and that it be understood that it is the following claims, including all equivalents, that are intended to define the spirit and scope of this invention.

What is claimed is:

1. A computer implemented method of managing a multi-participant transaction, the method comprising:
receiving, by a processor from an initiator participant, via a user interface coupled with the processor, first transaction data indicative of initiation of a first transaction to be completed by one or more facilitator and execution participants selected from a participant database coupled with the processor which stores data indicative of a plurality of participants, the first transaction data including a plurality of parameters which direct how the one or more facilitator and execution participants are to complete the first transaction;
creating, based on receipt of the first transaction data by the processor in a database stored in a memory coupled therewith, a first data record comprising data indictive of the first transaction and the plurality of parameters thereof;
receiving, by the processor from the initiator participant via the user interface, first authorization data specifying whether the one or more facilitator or execution participants are authorized to modify one or more of the plurality of parameters of the first transaction to alter how the one or more facilitator and execution participants are to complete the first transaction, and storing the first authorization data in the first data record;
receiving, by the processor from the initiator participant via the user interface, first designation data indicative of a first designation of a first facilitator participant, selected from the participant database, to facilitate the completion of the first transaction according to the plurality of parameters of the first transaction, and storing the first designation data in the first data record;
wherein, when, based on the first authorization data, the designated first facilitator participant is authorized to modify one or more of the plurality of parameters of the first transaction, enabling, by the processor, modification in the first data record, by the designated first facilitator participant, of the one or more of the plurality of parameters of the first transaction and receiving, by the processor from the designated first facilitator participant via the user interface, second authorization data specifying whether another of the one or more facilitator or execution participants are authorized to modify one or more of the plurality of parameters of the first transaction to alter how the other one or more facilitator or execution participants are to complete the first transaction, and storing the second authorization data in the first data record;
receiving, by the processor from the designated first facilitator participant via the user interface, second designation data indicative of a second designation of either a second facilitator participant to further facilitate completion of the first transaction or an execution participant to complete the first transaction according to the plurality of parameters of the first transaction, selected from the participant database, and storing the second designation data in the first data record;
wherein, when the second facilitator participant is designated and, based on the second authorization data, the designated second facilitator participant is authorized to modify one or more of the plurality of parameters of the first transaction, enabling, by the processor, modification in the first data record, by the designated second facilitator participant, of the one or more of the plurality of parameters of the first transaction and receiving, by the processor from the designated second facilitator participant via the user interface, third authorization data specifying whether the execution participant is authorized to modify one or more of the plurality of parameters of the first transaction to alter how the designated execution participant is to complete the first transaction, and storing the third authorization data in the first data record;
wherein, when the second facilitator participant is designated, further receiving, by the processor from the second facilitator participant via the user interface, third designation data indicative of a third designation of an execution participant, selected from the participant database, to complete the first transaction, and storing the third designation data in the first data record;
wherein, when, based on the third authorization data, the designated execution participant is authorized to modify one or more of the plurality of parameters of the first transaction, enabling, by the processor, modification in the first data record, by the designated execution participant, of the one or more of the plurality of parameters of the first transaction; and
upon receipt of a modification to the plurality of parameters of the first transaction by the processor from one of the initiator, designated first facilitator, designated second facilitator or designated execution participants, transmitting, by the processor, an electronic notification message to all of the others of the initiator, designated first facilitator, designated second facilitator and designated execution participants.

2. The computer implemented method of claim 1 wherein the first transaction comprises a shipment of a freight load from an origin location to a destination location, the shipment being arranged by the initiator participant, facilitated by the first and, if designated, second facilitator participants and completed by the execution participant, according to the plurality of parameters of the first transaction.

3. The computer implemented method of claim 1 wherein the first facilitator participant comprises one of a broker or carrier, and wherein when the first facilitator participant is a broker, the second facilitator participant comprises a carrier, and the execution participant is a driver.

4. The computer implemented method of claim 1 further comprising presenting the user interface to the initiator participant, designated first facilitator and designated second facilitator participants via an electronic communications network.

5. The computer implemented method of claim 1 wherein the plurality of parameters include one or more of pickup location, type of load, delivery location, delivery type, special instructions.

6. The computer implemented method of claim 1 wherein the receiving of second authorization data further includes checking the first data record and presenting an input to the designated first facilitator participant via the user interface to receive the second authorization data when the first authorization data in the first data record indicates that the one or more facilitator or execution participants are authorized to modify one or more of the plurality of parameters of the first transaction to alter how the one or more facilitator and execution participants are to complete the first transaction, and the receiving of third authorization data further includes checking the first data record and presenting an input to the designated second facilitator participant via the user interface to receive the third authorization data when the second authorization data in the first data record indicates that the designated second facilitator participant is authorized to modify one or more of the plurality of parameters of the first transaction to alter how the execution participants is to complete the first transaction.

7. The computer implemented method of claim 1 further comprising:
receiving, by the processor from the initiator participant, via the user interface coupled with the processor, second transaction data indicative of initiation of a second transaction to be completed by one or more facilitator and execution participants selected from a participant database coupled with the processor which stores data indicative of a plurality of participants, the second transaction data including a plurality of parameters which direct how the one or more facilitator and execution participants are to complete the first transaction; and
creating, based on receipt of the second transaction data by the processor in the database stored in the memory coupled therewith, a second data record comprising data indictive of the second transaction and the plurality of parameters thereof;
wherein one or more of the plurality of parameters, first, second, or third authorization data, or first, second or third designation data, of the second data record are different from the first data record.

8. The computer implemented method of claim 1 wherein the user interface operates differently for each of the initiator, designated first facilitator, designated second facilitator and execution participants.

9. The computer implemented method of claim 1 further comprising, subsequent to receipt of the first, second or third authorization data, receiving alternative first, second or third authorization data changing whether the designated first, second or execution participants are authorized to modify one or more of the plurality of parameters of the first transaction.

10. The computer implemented method of claim 1, wherein the modification to the plurality of parameters of the first transaction further includes adding an additional parameter thereto.

11. A system for managing a multi-participant transaction, the system comprising:
a processor and a memory coupled therewith;
first logic stored in the memory and executable by the processor to cause the processor to receive, from an initiator participant via a user interface coupled with the processor, first transaction data indicative of initiation of a first transaction to be completed by one or more facilitator and execution participants selected from a participant database coupled with the processor which stores data indicative of a plurality of participants, the first transaction data including a plurality of parameters which direct how the one or more facilitator and execution participants are to complete the first transaction;
second logic stored in the memory and coupled with the first logic and executable by the processor to cause the processor to create, based on receipt of the first transaction data by the processor in a database stored in a memory coupled therewith, a first data record comprising data indictive of the first transaction and the plurality of parameters thereof;
third logic stored in the memory and coupled with the first and second logic and executable by the processor to cause the processor to receive, by the processor from the initiator participant via the user interface, first authorization data specifying whether the one or more facilitator or execution participants are authorized to modify one or more of the plurality of parameters of the first transaction to alter how the one or more facilitator and execution participants are to complete the first transaction, and store the first authorization data in the first data record;
fourth logic stored in the memory and coupled with the first, second and third logic and executable by the processor to cause the processor to receive, from the initiator participant via the user interface, first designation data indicative of a first designation of a first facilitator participant, selected from the participant database, to facilitate the completion of the first transaction according to the plurality of parameters of the first transaction, and store the first designation data in the first data record;
wherein, when, based on the first authorization data, the designated first facilitator participant is authorized to modify one or more of the plurality of parameters of the first transaction, the fourth logic is further executable by the processor to cause the processor to enable modification in the first data record, by the designated first facilitator participant, of the one or more of the plurality of parameters of the first transaction and receive, from the designated first facilitator participant via the user interface, second authorization data specifying whether another of the one or more facilitator or execution participants are authorized to modify one or more of the plurality of parameters of the first transaction to alter how the other one or more facilitator or execution participants are to complete the first transaction, and store the second authorization data in the first data record;
fifth logic stored in the memory and coupled with the first, second, third and fourth logic and executable by the processor to cause the processor to receive, from the designated first facilitator participant via the user interface, second designation data indicative of a second designation of either a second facilitator participant to further facilitate completion of the first transaction or an execution participant to complete the first transaction according to the plurality of parameters of the first transaction, selected from the participant database, and store the second designation data in the first data record;
wherein, when the second facilitator participant is designated and, based on the second authorization data, the designated second facilitator participant is authorized to modify one or more of the plurality of parameters of the first transaction, the fifth logic being further executable by the processor to cause the processor to enable modification in the first data record, by the designated second facilitator participant, of the one or more of the plurality of parameters of the first transaction and receive, from the designated second facilitator participant via the user interface, third authorization data specifying whether the execution participant is authorized to modify one or more of the plurality of parameters of the first transaction to alter how the designated execution participant is to complete the first transaction, and store the third authorization data in the first data record;
wherein, when the second facilitator participant is designated, the fifth logic being further executable by the processor to cause the processor to receive, from the second facilitator participant via the user interface, third designation data indicative of a third designation of an execution participant, selected from the participant database, to complete the first transaction, and store the third designation data in the first data record;
wherein, when, based on the third authorization data, the designated execution participant is authorized to modify one or more of the plurality of parameters of the first transaction, the fifth logic being further executable by the processor to cause the processor to enable modification in the first data record, by the designated execution participant, of the one or more of the plurality of parameters of the first transaction; and
sixth logic stored in the memory and coupled with the first, second, third, fourth and fifth logic and executable by the processor to cause the processor to, upon receipt of a modification to the plurality of parameters of the first transaction by the processor from one of the initiator, designated first facilitator, designated second facilitator or designated execution participants, transmit an electronic notification message to all of the others of the initiator, designated first facilitator, designated second facilitator and designated execution participants.

12. The system of claim 11 wherein the first transaction comprises a shipment of a freight load from an origin location to a destination location, the shipment being arranged by the initiator participant, facilitated by the first and, if designated, second facilitator participants and completed by the execution participant, according to the plurality of parameters of the first transaction.

13. The system of claim 11 wherein the first facilitator participant comprises one of a broker or carrier, and wherein when the first facilitator participant is a broker, the second facilitator participant comprises a carrier, and the execution participant is a driver.

14. The system of claim 11 wherein the user interface is presented to the initiator participant, designated first facilitator and designated second facilitator participants via an electronic communications network.

15. The system of claim 11 wherein the plurality of parameters include one or more of pickup location, type of load, delivery location, delivery type, special instructions.

16. The system of claim 11 wherein the fourth logic is further executable by the processor to cause the processor to check the first data record and present an input to the designated first facilitator participant via the user interface to receive the second authorization data when the first authorization data in the first data record indicates that the one or more facilitator or execution participants are authorized to modify one or more of the plurality of parameters of the first transaction to alter how the one or more facilitator and execution participants are to complete the first transaction, and the fifth logic is further executable by the processor to cause the processor to check the first data record and present an input to the designated second facilitator participant via the user interface to receive the third authorization data when the second authorization data in the first data record indicates that the designated second facilitator participant is authorized to modify one or more of the plurality of parameters of the first transaction to alter how the execution participants is to complete the first transaction.

17. The system of claim 11 further wherein the first logic is further executable by the processor to cause the processor to receive from the initiator participant, via the user interface coupled with the processor, second transaction data indicative of initiation of a second transaction to be completed by one or more facilitator and execution participants selected from a participant database coupled with the processor which stores data indicative of a plurality of participants, the second transaction data including a plurality of parameters which direct how the one or more facilitator and execution participants are to complete the first transaction; and
the second logic is further executable by the processor to cause the processor to create, based on receipt of the second transaction data, in the database stored in the memory coupled therewith, a second data record comprising data indictive of the second transaction and the plurality of parameters thereof;
wherein one or more of the plurality of parameters, first, second, or third authorization data, or first, second or third designation data, of the second data record are different from the first data record.

18. The system of claim 11 wherein the user interface operates differently for each of the initiator, designated first facilitator, designated second facilitator and execution participants.

19. The system of claim 11 further comprising, subsequent to receipt of the first, second or third authorization data, the processor is caused to receive alternative first, second or third authorization data changing whether the designated first, second or execution participants are authorized to modify one or more of the plurality of parameters of the first transaction.

20. The system of claim 11, wherein the modification to the plurality of parameters of the first transaction further includes adding an additional parameter thereto.

21. A system for managing a multi-participant transaction, the method comprising:
means for receiving, from an initiator participant, via a user interface coupled with the processor, first transaction data indicative of initiation of a first transaction to be completed by one or more facilitator and execution participants selected from a participant database coupled with the processor which stores data indicative of a plurality of participants, the first transaction data including a plurality of parameters which direct how the one or more facilitator and execution participants are to complete the first transaction;
means for creating, based on receipt of the first transaction data by the processor in a database stored in a memory coupled therewith, a first data record comprising data indictive of the first transaction and the plurality of parameters thereof;
means for receiving, from the initiator participant via the user interface, first authorization data specifying whether the one or more facilitator or execution participants are authorized to modify one or more of the plurality of parameters of the first transaction to alter how the one or more facilitator and execution participants are to complete the first transaction, and storing the first authorization data in the first data record;
means for receiving, from the initiator participant via the user interface, first designation data indicative of a first designation of a first facilitator participant, selected from the participant database, to facilitate the completion of the first transaction according to the plurality of parameters of the first transaction, and storing the first designation data in the first data record;
wherein, when, based on the first authorization data, the designated first facilitator participant is authorized to modify one or more of the plurality of parameters of the first transaction, means for enabling modification in the first data record, by the designated first facilitator participant, of the one or more of the plurality of parameters of the first transaction and receiving, by the processor from the designated first facilitator participant via the user interface, second authorization data specifying whether another of the one or more facilitator or execution participants are authorized to modify one or more of the plurality of parameters of the first transaction to alter how the other one or more facilitator or execution participants are to complete the first transaction, and storing the second authorization data in the first data record;
receiving, by the processor from the designated first facilitator participant via the user interface, second designation data indicative of a second designation of either a second facilitator participant to further facilitate completion of the first transaction or an execution participant to complete the first transaction according to the plurality of parameters of the first transaction, selected from the participant database, and storing the second designation data in the first data record;
wherein, when the second facilitator participant is designated and, based on the second authorization data, the designated second facilitator participant is authorized to modify one or more of the plurality of parameters of the first transaction, means for enabling modification in the first data record, by the designated second facilitator participant, of the one or more of the plurality of parameters of the first transaction and receiving, by the processor from the designated second facilitator participant via the user interface, third authorization data specifying whether the execution participant is authorized to modify one or more of the plurality of parameters of the first transaction to alter how the designated execution participant is to complete the first transaction, and storing the third authorization data in the first data record;
wherein, when the second facilitator participant is designated, further means for receiving, from the second facilitator participant via the user interface, third designation data indicative of a third designation of an execution participant, selected from the participant database, to complete the first transaction, and storing the third designation data in the first data record;
wherein, when, based on the third authorization data, the designated execution participant is authorized to modify one or more of the plurality of parameters of the first transaction, means for enabling modification in the first data record, by the designated execution participant, of the one or more of the plurality of parameters of the first transaction; and
upon receipt of a modification to the plurality of parameters of the first transaction by the processor from one of the initiator, designated first facilitator, designated second facilitator or designated execution participants, means for transmitting an electronic notification message to all of the others of the initiator, designated first facilitator, designated second facilitator and designated execution participants.
